(19) United States
(12) Patent Application Publication
(10) Pub. No.: US 2016/0048408 A1
(43) Pub. Date: Feb. 18, 2016

(54) REPLICATION OF VIRTUALIZED INFRASTRUCTURE WITHIN DISTRIBUTED COMPUTING ENVIRONMENTS

(71) Applicant: OneCloud Labs, Inc., Boston, MA (US)

(72) Inventors: Suresh Madhu, Boston, MA (US); Sean Gilhooly, Ashland, MA (US); Nathanael M. Van Vorst, Quincy, MA (US); Thomas Keiser, Boston, MA (US); David Stair, Watertown, MA (US); Kevin Chen, Reading, MA (US)

(21) Appl. No.: 14/820,873

(22) Filed: Aug. 7, 2015

Related U.S. Application Data
(60) Provisional application No. 62/036,978, filed on Aug. 13, 2014.
(60) Provisional application No. 62/169,708, filed on Jun. 2, 2015.

(51) Int. Cl. G06F 9/455; H04L 12/911

(52) U.S. Cl. CPC G06F 9/45558; H04L 47/783; G06F 2009/45595

(57) ABSTRACT

A management platform, which includes a plurality of virtual machines, wherein one virtual machine utilizes a first hypervisor and is linked to resources in a first virtual environment of an enterprise data center, and one virtual machine uses a second heterogeneous hypervisor and is linked to resources in a second virtual environment of a cloud. A user interface allows a user to set a policy with respect to disaster recovery of the computing resources of the enterprise data center. A control component replicates some of the infrastructure of the enterprise data center to the second virtual environment of the cloud computing infrastructure, controls the plurality of virtual machines to provide failover to the cloud computing infrastructure when triggered based at least in part on the user-set policy, and controls the plurality of virtual machines to provide recovery back to the enterprise data center after failover to the cloud computing infrastructure.

### CROSS-REFERENCE TO RELATED APPLICATIONS

This application claims the benefit of the following provisional applications: U.S. Provisional Application 62/036,978, filed Aug. 13, 2014, and U.S. Provisional Application 62/169,708, filed Jun. 2, 2015. Each application is hereby incorporated by reference in its entirety.

### BACKGROUND

This disclosure relates to the field of computing resource management, and more specifically, the management of a virtualized computing environment such as an enterprise data center with virtualized components and the integration and utilization of cloud computing resources that are related to enterprise data center resources, such as for disaster recovery situations.

For enterprise data centers, the ability to adapt to different workload demands is important, as computing resources including CPU (central processing unit) capability, networking capability, and storage resources are finite at a given point in time. In comparison, computing resources in the cloud may be considered essentially infinite and can be provided on demand. Additionally, disaster recovery and business continuity are significant concerns for many enterprises. Disaster recovery refers to a strategy to recover from a partial or total failure of a primary data center, while business continuity refers to the act of continuing near normal business functions after a partial or total loss of a primary data center. For critical functions, disaster recovery times on the order of minutes to a couple hours, rather than up to several hours or days, may be desired. These faster recovery times simply cannot be achieved via traditional backup technologies, such as disk-to-disk (D2D) or tape backup, which generally take days to weeks to achieve recovery. Other backup and replication techniques for disaster recovery are typically expensive, complex to provision and manage, and difficult to scale up or down as data and application requirements change. Often, enterprises are forced to exclude desired applications due to cost and complexity of currently available disaster recovery schemes. A need exists for improved disaster recovery solutions that can take advantage of the flexibility of cloud computing infrastructure, can replicate various types of virtualized infrastructure, while maintaining consistency with use of conventional enterprise data centers.

### SUMMARY

This disclosure relates to methods, systems, and platforms for managing an enterprise data center and enabling an elastic hybrid (transformed) data center by linking the enterprise data center (which may include cloud-computing infrastructure and virtualization) to other cloud-computing infrastructure using federated virtual machines. Such a resultant hybrid data center is scalable, adaptable to various workloads, and economically advantageous due to utilization of on-demand cloud computing resources and their associated economies of scale. Additionally, various services of interest to an enterprise can be provided by such a platform, including Disaster Recovery as a service (DRaaS), Storage Tiering as a service (STaas), Cloud Acceleration as a Service (CAaaS), along with others.

Such an elastic hybrid data center may achieve near high availability or high availability recovery (with associated recovery times on the order of minutes) by taking advantage of the economics of cloud computing and the simplicity of cloud recovery. A hybrid cloud management platform as described herein may optimize a hypervisor to cloud replication scheme and take advantage of a hyperscale public cloud computing environment, such as provided by Amazon [e.g. Amazon Web Services™ (AWS)], which has tiered storage and corresponding tiered cost structure, allows for resizable compute capacity, and is secure and compliant, leading to scalability, flexibility, simplicity, and cost savings from an enterprise standpoint. The hybrid cloud management platform provides for management, orchestration, and integration of applications, compute and network requirements, and storage requirements to bridge between an enterprise data center and a cloud-computing environment while providing a user interface for an enterprise which is simple and easy to use, and allows a user to input desired policies.

Among other things, provided herein is a management platform for handling disaster recovery relating to computing resources of an enterprise. The management platform may include a plurality of virtual machines, where at least one virtual machine utilizes a first hypervisor and is linked to resources in a first virtual environment of a data center of the enterprise, and at least one virtual machine uses a second hypervisor and is linked to resources in a second virtual environment of a cloud computing infrastructure, wherein the first and the second virtual environments are heterogeneous and do not share a common programming language. The management platform may also include a control component that abstracts infrastructure of the enterprise data center using a virtual file system abstraction layer, monitors the resources of the enterprise data center, and replicates at least some of the infrastructure of the enterprise data center to the second virtual environment of the cloud computing infrastructure based at least in part on the abstraction. The management platform may include a user interface for allowing a user to set policy with respect to disaster recovering of the computing resources of the enterprise data center.

In embodiments, the management platform may include a control component that abstracts infrastructure of the enterprise data center using a virtual file system abstraction layer, monitors the resources of the enterprise data center, replicates at least some of the infrastructure of the enterprise data center to the second virtual environment of the cloud computing infrastructure based at least in part on the abstraction, controls the plurality of virtual machines to provide failover to the cloud computing infrastructure when triggered based at least in part on the user-set policy. The control component may control the plurality of virtual machines to provide recovery back to the enterprise data center based at least in part on the user-set policy after failover to the cloud computing infrastructure.

In embodiments, at least one of the replicated resources of the enterprise data center may have an associated user-set policy and may be stored in a storage tier of a plurality of different available storage tiers in the cloud computing infrastructure based at least in part on the associated user-set policy. The user-set policy may based on at least one of a recovery time objective and a recovery point objective of the enterprise for disaster recovery. The replicated resources may include CPU resources, networking resources, and data storage resources. Additional virtual machines may be automatically created based at least in part on monitoring a data volume of the enterprise data center. The control component may monitor data sources, storage, and file systems of the enterprise data center and determines bi-directional data replication needs based on the user-set policy and the results of monitoring. Failover may occur when triggered automatically by detection of a disaster event or when triggered on demand by a user.

In embodiments, a management platform for managing computing resources of an enterprise may comprise a plurality of federated virtual machines, wherein at least one virtual machine is linked to a resource of a data center of the enterprise, and at least one virtual machine is linked to a resource of a cloud computing infrastructure of a cloud services provider; a user interface for allowing a user to set policy with respect to management of at least one of the enterprise data center resources and the resources of the cloud computing infrastructure; and a control component that monitors data storage availability of the enterprise data center resources, and controls the plurality of federated virtual machines to utilize data storage resources of the enterprise data center and the cloud computing infrastructure based at least in part on the user-set policy, wherein at least one utilized resource of the cloud computing infrastructure includes a plurality of different storage tiers.

Each of the plurality of federated virtual machines may perform a corresponding role and the federated virtual machines are grouped according to corresponding roles.

The user-set policy may be based on at least one of: a recovery time objective and a recovery point objective of the enterprise for disaster recovery; a data tiering policy for storage tiering; and a load based policy for bursting into the cloud. The control component may comprise at least one of a policy engine, a REST API, a set of control services and data services, and a file system. Federated virtual machines may be automatically created based at least in part on monitoring data volume of the enterprise data center. The federated virtual machines may be automatically created based at least in part on monitoring velocity of data of the enterprise data center. The control component may monitor at least one of data sources, storage, and file systems of the enterprise data center, and determine data replication needs based on user set policy and results of monitoring. The platform may include a hash component for generating hash identifiers to specify the service capabilities associated with each of the plurality of federated virtual machines, wherein the hash identifiers are globally unique.

The control component may be enabled to detect and associate services of the plurality of federated virtual machines based on associated hash identifiers. The control component may be enabled to monitor the performance of each virtual machine and generate a location map of each virtual machine of the plurality of federated virtual machines based on the monitored performance. The control component may comprise an enterprise data center control component and a cloud computing infrastructure control component, wherein each system component comprises a gateway virtual machine, a plurality of data movers, a deployment node for deployment of concurrent, distributed applications, and a database node; wherein the database nodes form a database cluster, and wherein each gateway virtual machine has a persistent mailbox that contains a queue with a plurality of queued tasks for the plurality of data movers, and each deployment node includes a scheduler that monitors enterprise policies and manages the queue by scheduling tasks relating to movement of data between the enterprise data center database node and the cloud computing infrastructure database node. The deployment nodes may be Akka nodes, the database nodes may be Cassandra nodes, and the database cluster may be a Cassandra cluster.

A management platform for managing computing resources of an enterprise may comprise a plurality of federated virtual machines, wherein at least one virtual machine is linked to a resource of a data center of the enterprise, and at least one virtual machine is linked to a resource of a cloud computing infrastructure of a cloud services provider; a user interface for allowing a user to set policy with respect to management of the enterprise data center resources; and a control component that monitors data volume of the enterprise data center resources and controls the plurality of federated virtual machines and automatically adjusts the number of federated virtual machines of the enterprise data center and the cloud computing infrastructure based at least in part on the user-set policy and the monitored data volume of the enterprise data center.

### BRIEF DESCRIPTION OF THE FIGURES

FIGS. 1 and 2 are simplified illustrations showing various features of an exemplary hybrid data center with a scalable hybrid cloud management platform that facilitates the linking of an enterprise data center with cloud computing infrastructure;

FIG. 3 illustrates vNodes (virtual nodes or virtual appliances) in an enterprise data center environment and in a cloud-computing environment;

FIG. 4 illustrates an exemplary hybrid cloud management platform;

FIG. 5 illustrates exemplary vNode architecture;

FIG. 6 illustrates an exemplary process for a disaster recovery service;

FIG. 7 illustrates components for the exemplary process of FIG. 6;

FIGS. 8-9 are exemplary simplified workflows of discovery, protection, and recovery features of an exemplary hybrid cloud management platform.

FIG. 10 illustrates an exemplary transformed/hybrid virtual enterprise data center for DR/BC (disaster recovery/business continuity);

FIGS. 11-14 are illustrations of an exemplary user interface; and

FIG. 15 is an illustration of an exemplary vNode clustering architecture.

FIG. 16 depicts an embodiment of a management platform, such as in the form of one or more software virtual appliances.

FIGS. 17-20 are schematic illustrations of a disaster recovery lifecycle using the management platform.

FIG. 21-22 illustrate bootstrap processes.

FIG. 23 illustrates an exemplary discovery process with inventory collection.

FIG. 24 illustrates an exemplary protection process.

FIGS. 25-29 depict failover modes and processes.

FIG. 30 depicts failback and failback states and operations.

FIGS. 31-36 are schematics of data movement.

FIG. 37 illustrates actors, cells, references and paths.

FIG. 38 illustrates a job management actor model.

FIG. 39 is a diagram relating to job creation.

FIG. 40 is a diagram relating to job monitoring.

FIGS. 41A-B depict job execution.

FIGS. 42A-D are diagrams outlining an exemplary structure for policy, provider, and job classes.

FIG. 43 is a high level diagram of an exemplary scheduling framework for jobs.

FIG. 44 in an embodiment of a class diagram for a planner and scheduler.

FIG. 45 is a diagram showing an exemplary job cancellation workflow.

FIG. 46 is a diagram showing an exemplary job execution cancel workflow.

FIGS. 47A-C illustrate exemplary job execution.

FIG. 48 illustrates features of an exemplary hybrid cloud management platform.

FIG. 49 illustrates features of an exemplary Akka cluster.

FIGS. 50-52 are exemplary sequence diagrams relating to job initiation, job cancellation, and job scheduling.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting, but rather to provide an understandable description of the invention.

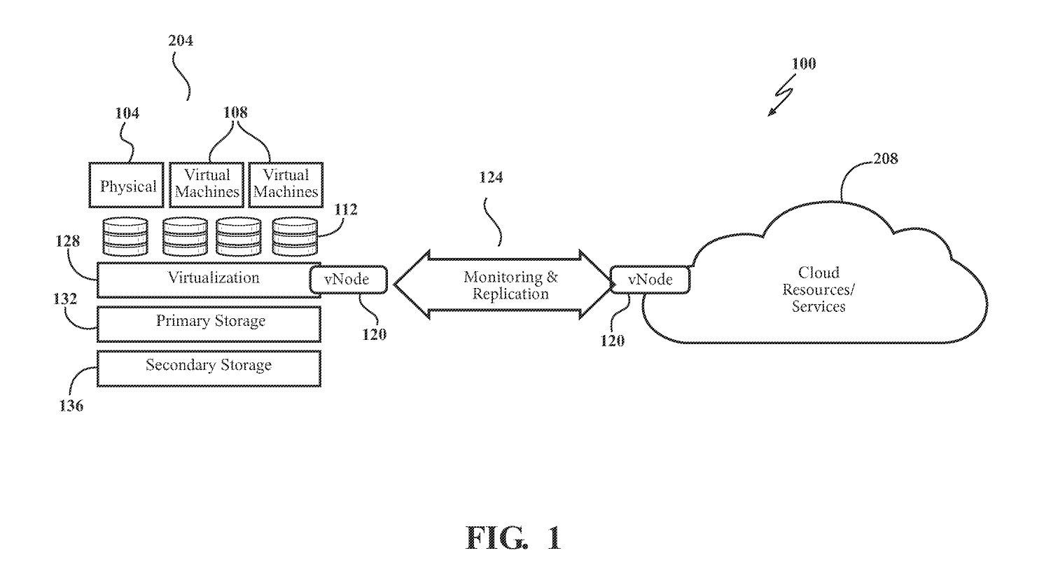

FIG. 1 illustrates an exemplary hybrid data center 100 enabled by a hybrid cloud management platform 124 that links together different computing environments and takes advantage of on-demand cloud computing resources/infrastructure 208 (e.g., Infrastructure as a Service—IaaS), such as available from various cloud computing service providers. The platform 124 may comprise vNodes 120 (virtual nodes, also referred to as virtual appliances, which are sets of virtual machines) to perform monitoring and replication functions, and may offer various other services of interest to an enterprise having an enterprise data center 204 (also referred to as an on-premise or primary data center). Enterprise data center 204 may comprise physical machines 104, virtual machines 108, various storage components 112, primary storage 132, secondary storage 136, and a virtualization control component 128, such as a VMware hypervisor. In embodiments, the hybrid cloud management platform and vNodes 120 may be Linux-based, and the vNodes 120 may comprise enterprise data center vNodes, as well as cloud-based vNodes. As described further herein, a vNode 120 is a specialized form of a virtual machine that has the ability, via a software layer, to federate, for example by communicating and cooperating with other vNodes deployed in other virtual environments, such as VMware enabled in the enterprise data center 204 and the heterogeneous virtual environment of AWS in the cloud, which may include a Xen hypervisor for example. The federated vNodes 120 may be managed, at least in part, according to user-selected policy. Additionally, vNodes 120 of the platform 124 may be sub-grouped by a shared cooperative function, task, or role, such as a function to pull data from storage, a function to replicate data, a gateway function to control network traffic, or the like. In other words, the hybrid cloud management platform 124 with its vNodes 120 span both on-premise and cloud infrastructure to create a bridge to seamlessly share and use resources from the two different environments.

Services provided by the platform 124 may include Disaster Recovery as a service (DRaaS), Storage Tiering as a service (STaaS), Cloud Acceleration as a Service (CAaaS), and Backup, along with others. With respect to these services, disaster recovery services allow resources of the enterprise data center to be migrated to and/or replicated in the cloud infrastructure to mitigate disasters and data loss. Storage tiering may relate to moving data into different tiers of cloud storage depending on various factors, such as cost, extent of protection, availability, and the like. Cloud acceleration may relate to the elastic use of cloud resources to rapidly deliver content to end users or consumers. Backup services are desirable where multiple copies of data need to be maintained for compliance or other purposes.

The platform 124 may comprise a user interface to allow for the expression of policy (such as by a user associated with an enterprise), and a data plane for translating expressed policy to appropriate data storage, network, and compute resources, including cloud resources and other resources, such as on-premise resources in an enterprise data center. In embodiments, the hybrid cloud management platform 124 may comprise functionality for automated hybrid data center creation based on various configured policies, such as policies relating to desired accessibility times, disaster recovery parameters such as RTO (recovery time objective, or the targeted maximum duration within which a business process is to be restored after a disaster event), RPO (recovery point objective, or the targeted maximum period in which data may be lost in the case of a disaster event), cost minimization, service level agreements (SLAs), data modification time, desired data access time, age of data, size of data, or type of data, or various other factors. For example, for disaster recovery and business continuity purposes, an enterprise may desire that an email exchange server have an RPO/RTO of ten minutes/one hour, i.e., a data protection guarantee that only files having an age of ten minutes or less might not be recovered, with recovery guaranteed within one hour of loss. In contrast, the enterprise may desire that an archived file system have a desired RPO/RTO of 24 hours/24-48 hours.

In embodiments, the hybrid cloud management platform provides automated provisioning, management, and monitoring of computing resources, seamlessly integrates enterprise data center resources and cloud computing resources from different virtual environments, allows for granular service level agreements (SLAs) to closely match priority and cost, resulting in significant cost savings over traditional disaster recovery and business continuity technologies.

The platform 124 may automatically scale up or down as application and/or data requirements change, and may allow for critical applications that were previously excluded due to cost/complexity to be covered in a disaster recovery and business continuity strategy. An exemplary DRaaS implementation may provide for the automatic discovery of assets of an enterprise data center, automated monitoring and management, cost information and analytics, a simple policy engine, protection groups, bandwidth throttling, cost engineered provisioning of cloud resources, and management including change block tracking and data reduction of virtual machines.

With respect to protection groups, these may relate to a group of resources (virtual machines or file systems) that should be protected in a consistent way. For example, different groups for an enterprise may be defined, such as applications running on multiple virtual machines, such as an application server and a database server, or file data in multiple file systems such as, for example, Google File System and Microsoft Sharepoint. Items in a group may be items that need protection at near simultaneous points in time. A protection group may embody the abstraction used to represent such a set of resources.

Change block tracking (CBT) may refer to the ability to distinguish blocks of data that have changed on disk storage at various points in time. For example, if a disk is 100 GB in size and only 1 GB of information has changed on the disk due to some updates to a file system, then CBT may allow efficient and fast discovery of the changes on the disk.

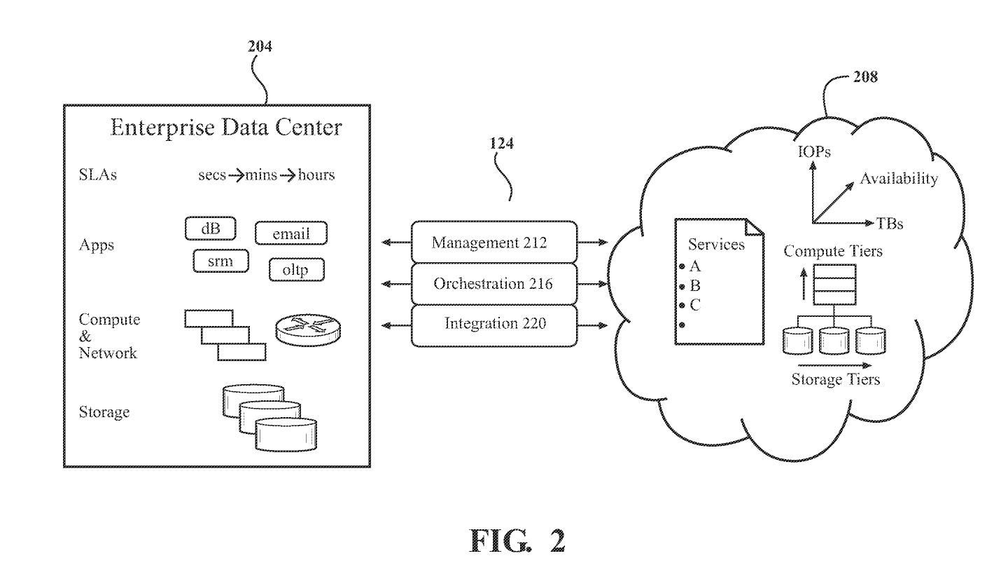

More specifically, and referring to FIG. 2, in embodiments, the scalable hybrid cloud management platform facilitates the bridging or linking of different virtualized computing environments including enterprise data center 204 and cloud resources 208 via the use of federated virtual machines in the form of vNodes 120. Enterprise data center 204 may include various applications, computer and network components, databases, and storage facilities, in a virtualized environment, such as provided by VMware, and the hybrid cloud management platform 124 includes components 212, 216, and 220 for the management, orchestration, and integration of the enterprise data center with respect to a cloud-computing environment. The cloud computing resources 208 available may include various types or levels of servers, computer components, storage components, and networking capabilities. For example, AWS includes web services such as Elastic Compute Cloud (EC2), which is a web service that provides elastic, resizable compute capacity in the cloud. AWS also includes different types or tiers of cloud storage services such as S3 (simple storage services), Glacier, and EBS (Elastic Block Storage). The different tiers of storage may have different pricing, access times, operating characteristics, and other different features, and may be located in various geographic areas. For example, S3 allows for storage in different geographic zones with different levels of availability/reliability for different costs. Glacier allows for storage that is advantageous for inactive or seldom accessed data, as it moves more slowly but is capable of supporting large amounts of data.

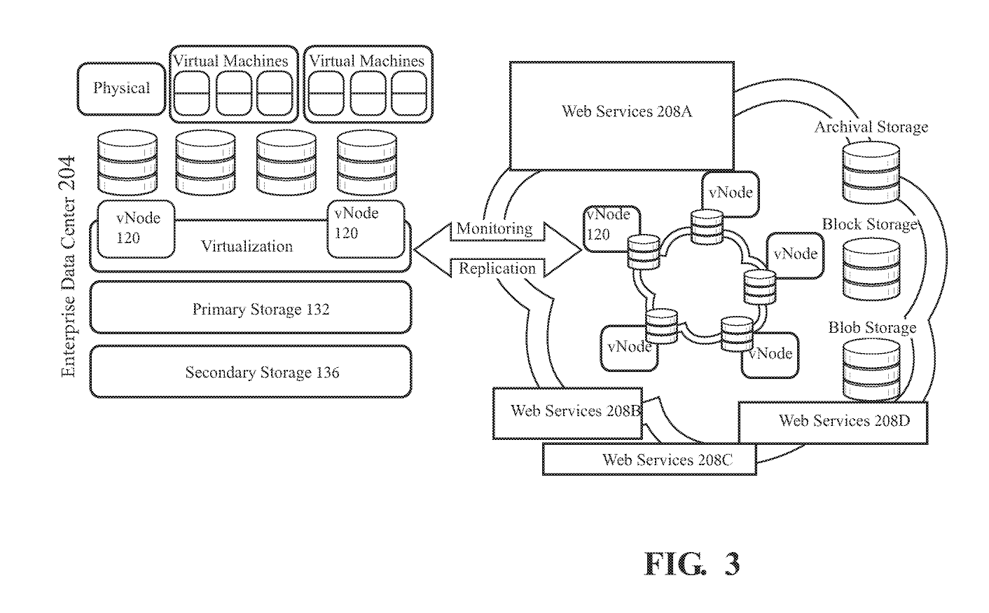

Referring to FIG. 3, in embodiments, the vNodes 120 may be seamlessly installed on-premise in a virtualized enterprise data center environment (such as installing directly into an existing VMware environment) and may also be also installed in a cloud-computing environment having web services 208A, 208B, 208C, 208D (such as AWS). The hybrid cloud management platform 124 may act to auto discover and blueprint the virtual and physical servers, storage, and networking capabilities of the enterprise data center 204 to create virtual data center blueprints, with no disruption to existing data center operations. A user may configure protection and recovery policies for the virtual machines and data of an enterprise, such as by setting desired objectives, e.g., RPO (recovery point objective) and RTO (recovery time objective). RPO refers to data loss/recovery tolerance, such as measured in seconds, minutes, hours or days, and RTO refers to data recovery criteria, also measured in seconds, minutes, hours, or days.

The hybrid cloud management platform may act to automatically provision the most cost-effective replicas in a cloud-computing environment to meet the desired policies, and may thinly provision compute requirements to further reduce costs. The hybrid cloud management platform may perform scheduled snapshots and replication to keep data up to date in the cloud computing environment, and may monitor the enterprise data center environment to failover to the cloud computing environment on-demand or automatically. The platform also supports non-disruptive testing of an implemented disaster recovery/business continuity (DR/BC) strategy.

A simplified and intuitive user interface may be provided, such as shown in FIGS. 11-14 and described more fully below, which essentially makes the cloud-computing environment invisible or nearly so to a user associated with an enterprise. Load driven scaling, based on predicted and/or actual load, wherein vNodes are automatically scaled up and down/or out, allows for peak loads to be easily accommodated, as more fully described below. In this manner, capital expenditures of an enterprise that had previously gone towards the acquisition of enterprise infrastructure can be replaced with operational expenditures by taking advantage of infrastructure as a service.

In embodiments, the platform may comprise scalable vNodes (sets of federated virtual machines) that may be cloned according to a policy. Scalability is important when a heavy workload is to be processed, for example, if protection and recovery of many VMs or file systems of an enterprise are required. Furthermore, the platform may detect a changing workload and automatically adjust the vNodes in the federated set to efficiently and cost-effectively use resources both on-premise and in the cloud. Policies may be based on, but are not limited to, an expressed recovery point objective (RPO) or recovery time objective (RTO). The policy may be translated into rates of data replication, such as the frequency of monitoring or the utilization of network resources and cloud layers, among others.

In embodiments, the hybrid cloud management platform 124 may comprise groupings of federated virtual machines that are scaled in a coordinated fashion. Such groupings may be identified as a federated layer. A user may download a single virtual machine and the platform may dynamically create a cluster of virtual machines (vNodes) that are federated across servers or across other cloud platforms. The hybrid cloud management platform may comprise a computer cluster such as a vNode cluster. The cluster may be based in part on a data discovery step to determine what data needs to be protected. Federation of the vNodes may occur on-premise or federation may occur dynamically in the cloud. The federation layer may cause automatic scaling depending on the resources available to the network. Federation of vNodes may be implemented dynamically and asymmetrically with respect to machines on-premise or in the cloud. Dynamic federation may be based on discovery of data that needs protection. A federated file system may be constructed, which scales automatically and dynamically changes during peak workloads.

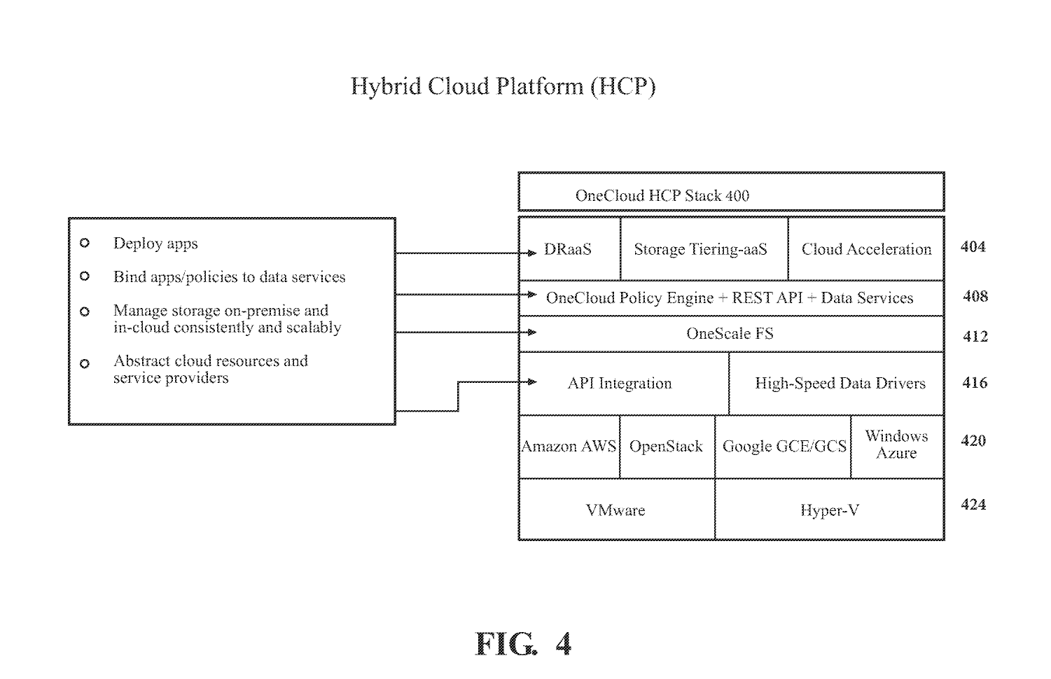

As shown in FIG. 4, in embodiments, a hybrid cloud management platform stack 400 may include a plurality of layers, including an application deployment layer 404, a policy layer 408 to bind policies and applications to data services, a storage management layer 412 to manage storage on-premise in a scalable manner, and an abstraction layer 416 to abstract various cloud resources and service providers, incorporating API (application programming interface) integration and high speed data drivers. Layer 424 includes on-premise physical and virtual infrastructure and source data and other assets or resources that need protecting, such as in conjunction with virtualized machines of VMware or Hyper-V. Layer 420 may represent cloud infrastructure resources from various cloud service providers (such as AWS, OpenStack, Google GCE/GCS, and/or Windows Azure). The abstraction layer 416 (with APIs and data drivers) may act to translate between and bind the layers 420 and 424. The storage management layer 412 may act to federate the vNodes and provide scalability for management and data movement according to policy. The policy layer 408 may include a user interface and may allow for setting or selecting of one or more policies. Applications such as DRaaS (disaster recovery as a service) and STaaS (storage tiering as a service) may be launched in the application deployment layer 404.

The storage management layer 412 may comprise a virtual file system (FS) that abstracts the view of on-premise versus cloud storage elements from the viewpoint of the user. In other words, a user may interact with the virtual file system for read/writes of files in a manner analogous to interaction and control of a single data center, and the storage management layer determines where to put the data via the associated policy across distributed data centers: either on-premise, in the cloud, or a combination of both. The virtual file system is embedded within each vNode, and a federation of vNodes thus provides scale, via combining vNodes and their respective storage and performance capabilities and determining where to put data: either locally (which may be fast, near-line) or in various different cloud tiers (which may be slower, more remote).

The vNodes, along with their underlying databases, are federated, since each vNode carries its own database/state, and when working in concert with other vNodes that are part of the federated set, share state via a data synchronization layer. Because vNodes can be on-premise (inside a virtualized environment) and off-premise (inside a cloud computing environment), the database layer is federated as well. Computer resources may be linked via a custom data distribution layer, network resources are linked via a VPN (virtual private network), and storage resources are linked via the virtual file system between on-premise and cloud environments.

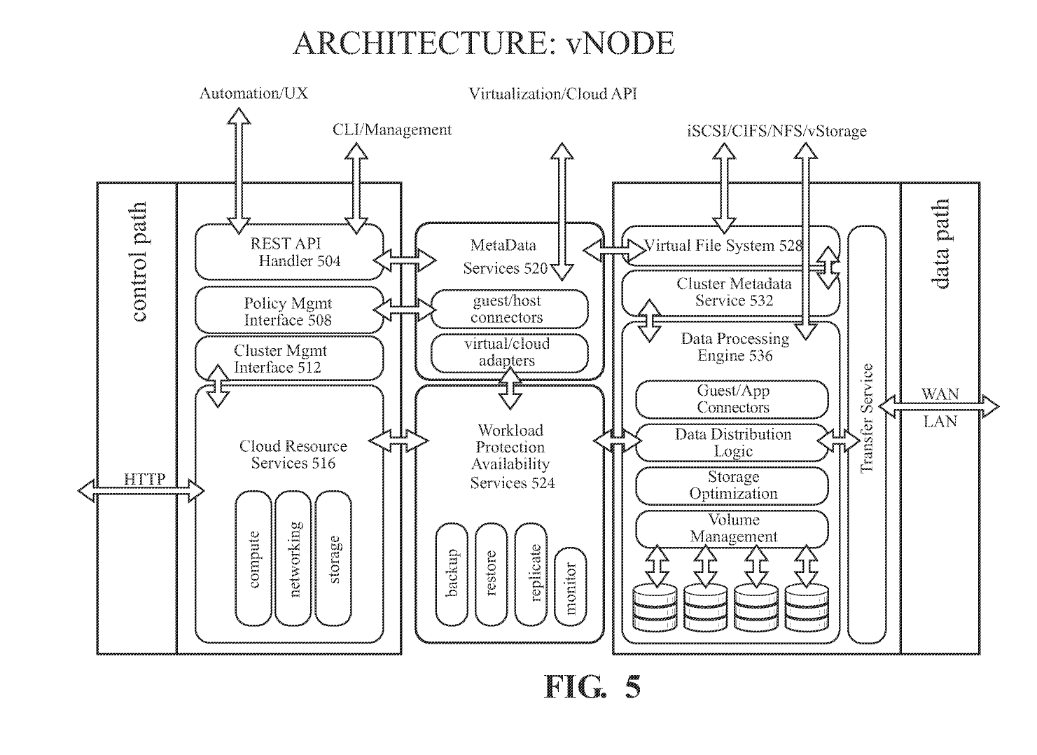

With reference to FIG. 5, in embodiments, vNode architecture may comprise a REST (Representational State Transfer) API handler 504, interacting with a user interface, and a CLI/management interface. CLI (Common Language Infrastructure) is an open specification that describes executable code and a runtime environment and defines an environment that allows multiple high-level languages to be used on different computer platforms without being rewritten for specific architectures. REST architecture is a layered system that is resource based, provides a uniform interface between client and server, is stateless, provides for caching, is layered, and provides code on demand. Additionally, a vNode may comprise a policy management interface 508. As described more fully below, vNode architecture may comprise a cluster management interface 512 and cloud resource services 516, which may manage computing, networking and storage resources. In embodiments, vNode architecture may comprise metadata services 520, such as guest/host connector and virtual/cloud adapter services. Additionally, vNode architecture may comprise workload protection availability services 524, such as backup, restoration, replication, and monitoring services, as more fully described below. In embodiments, a vNode may further comprise a virtual file system 528, cluster metadata services 532, and data processing engine 536 responsible for guest/app connectors, data distribution logic, storage optimization, and volume management. A control path may be via HTTP (hypertext transfer protocol) and a data path may be via WAN (wide area network) or LAN (local area network).

In embodiments, the hybrid cloud management platform 124 may include the dynamic creation of federated virtual machines based at least in part on the monitoring of data volume and data velocity to meet policy objectives. In embodiments, the platform 124 may comprise a set of virtual machines or vNodes 120. The vNodes may monitor data sources, storage, and file systems within the enterprise data center 204. The vNodes may monitor external resources as well using a workflow engine based on a policy to determine scaling and disaster recovery data replication needs. In embodiments, the platform may comprise using hash identifiers or similar data mapping or fragment identifying techniques in order to specify the service capabilities of an appliance within a federation. In embodiments, the platform 124 may comprise detecting and associating services of vNodes within a federation based on hash identifiers associated with each vNode. In embodiments, the platform may also provide the ability to infer a location map of vNodes within a federation based on the performances of the vNode, such as by determining proximity based on a performance measure such as transmission speed. In embodiments, an end user may interact with a single user interface while the platform manages a dynamic infrastructure of federated vNodes via a policy.

In embodiments, the platform may comprise appliance services and hashing methods for identifying objects within a federated system. Hashing may be employed to avoid conflict within the hybrid (transformed) data center. In embodiments, a unique hash may identify services associated with an appliance within a federation. Appliances within a federation may detect the services and capabilities of the other appliances within the federation based on the hashes. Hashes may also identify a tuple, which may be globally unique across a federation of appliances. In a non-limiting example, a hashing tuple may be (Object ID, Authority) wherein the Authority is the origin of the data. The federated sources and corresponding tuples may then be stored in a single common server in order to avoid redundancies. Hashes may also be disassociated. In embodiments, publish/subscribe protocol may be used to describe the objects and the relationships between them, such as AtomPubSub, and the like. In embodiments, entry elements in a feed may describe the objects in a feed, and a global feed may be used to discover all elements to which a policy applies.

In embodiments, vNode clusters may utilize a service-oriented architecture to deploy individual services, including across multiple locations. Additionally, each virtual appliance may be assigned services such as data protection, data recovery, monitoring, metadata collection, and directory services. Such a system may be useful in various cases. In a non-limiting example, a user may run protection engines on-premise and recovery engines in the cloud. Additionally, a user may run protection engines and recovery engines in the cloud, or, the user may choose to run protection engines in a first cloud and recovery engines in a separate cloud. Monitoring may be used to detect problems and may be used for initial data protection, recovery, and reallocation of virtual appliance assignments. Metadata collection may be used to discover and map topology of a local environment or infrastructure, identifying other virtual appliances, network connectivity, and data storage capacity, among others. Data collected through the metadata service may be used as a guide or blueprint of the topology of the local environment, which may be used to replicate an environment in the cloud. In embodiments, the data collected may serve as a heat map, assisting with determining how to distribute a load among a federation of virtual appliances. The data collected may determine the proximity of appliances within a federation and may be defined and visualized along with performance.

In embodiments, the hybrid cloud management platform 124 may be integrated with web storage and cloud backup infrastructure such as Amazon Web Services (AWS). The platform may use virtual machines and/or physical machine node information and resources. The platform may identify all physical and virtual resources available within the network for which the user wishes to integrate the platform. The platform may take agentless snapshots of data. Additionally, the platform may optimize the identified data, such as deduplicating stored virtual machine disks and changed blocks. The platform may take a snapshot of these deduplicated resources. The platform may take a file system snapshot and set the snapshot as a recovery point objective. The full snapshots and deduplicated snapshots may be sent to block storage, such as Amazon™ EBS™, as check-summed and verified blocks for replication. Cloud storage may then be tiered based on a recovery time objective or other policy. If a failover occurs within the platform, the blocks may be retrieved based on the on-demand or disaster recovery event and may be retrieved according to the platform retrieval time objective. The new virtual machines may then be rehydrated with the information stored in a cluster's block storage.

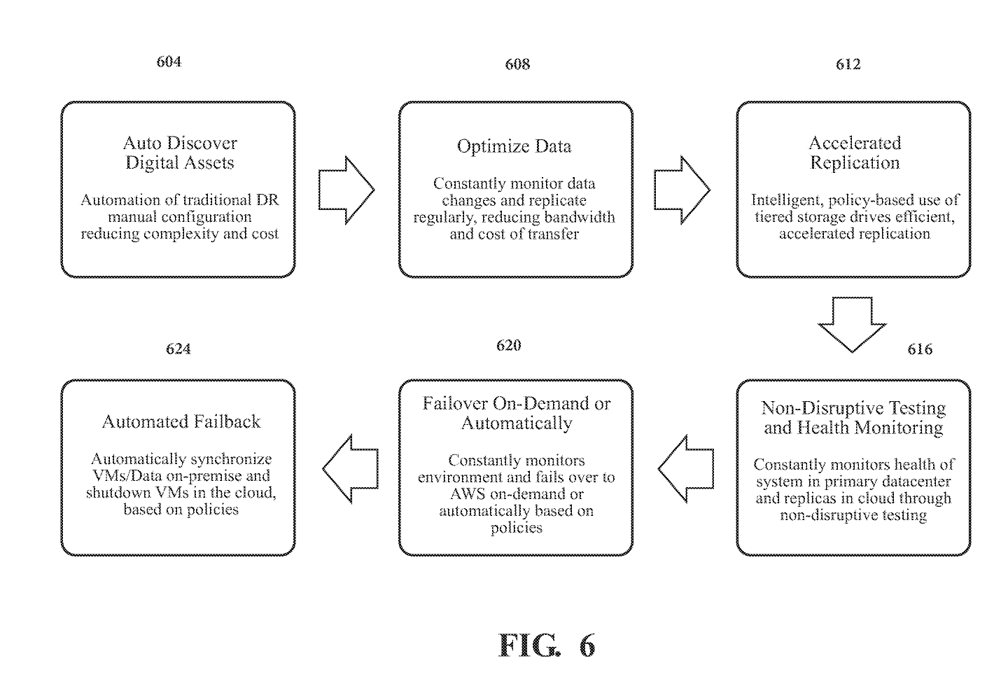

FIG. 6 provides an overall view of an exemplary method for disaster recovery and business continuity for an enterprise data center, which is facilitated by the hybrid cloud management platform. At a step 604, the platform automatically discovers assets of the enterprise data center. Such automation of this step reduces complexity and cost. At a step 608, the data is optimized, such as by constant monitoring of data changes and regular data replication. This step reduces bandwidth and transfer associated costs. At a step 612, accelerated replication is performed, preferably taking advantage of tiered storage in the cloud, which drives efficient accelerated replication. Next, non-disruptive testing and health monitoring is performed at a step 616. The platform continuously monitors the health of the enterprise data center and replicas in the cloud through such non-disruptive testing. Next, at a step 620, the platform continuously monitors the data center and failover is enabled when conditions are met, such as on-demand and/or automatically according to policy. Next, at step 624, the platform enables automated failback when conditions are met and the platform automatically synchronizes VMs and data on-premise, and shuts down VMs in the cloud, based on policy.

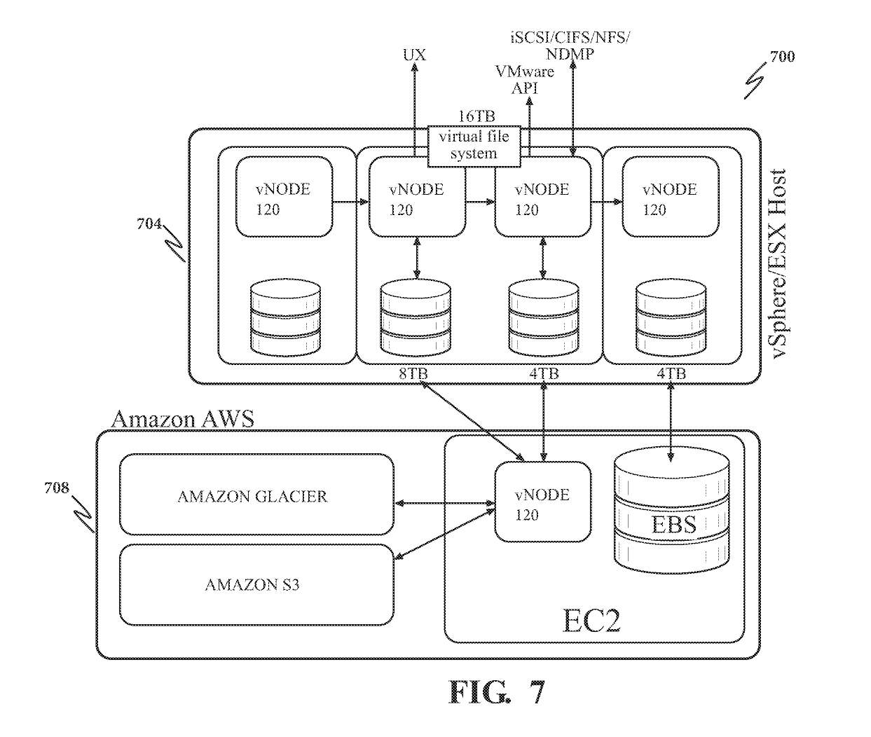

FIG. 7 illustrates components involved in a disaster recovery and business continuity protection scheme, which provides redundant facilities, primary storage, software, and networking capabilities for an enterprise. In particular, this figure illustrates an enterprise data center 704 that is integrated with cloud resources 708 using vNodes 120, wherein the cloud resources 708 include AWS with various storage tiers (EBS, S3, Glacier) and elastic cloud compute (EC2) resources. The enterprise data center 704 is virtualized using VMware, includes a user interface (UX), and interfaces with a VMware API. The resultant hybrid data center 700 employs protocols such as iSCSI (internet small computer system interface), NDMP (network data management protocol); and file systems such as CIFS (common internet file system) and NFS (Network file system). Processes performed by the hybrid data center may include a step wherein the vNodes of the platform act to discover the physical and virtual resources of the enterprise data center, including network dependencies and compute and storage elements in the environment to create a blueprint that is stored in a database. At a next step, the platform acts to protect data by taking agentless snapshots of data. At a next step, optimization occurs, wherein data on VMDKs (virtual machine disks) is stored and change blocks are de-duped (duplicate entries are removed). Further optimization may be performed, wherein snapshots are taken of disks from a virtual or physical file system. At a replications step, full/incremental de-duped snapshots are sent to Amazon EBS as blocks, check-summed and verified. The ability may exist to distinguish between a “full” or complete backup of a disk or set of disks associated with a VM and an “incremental” backup of just the changes in data since the last protection or backup job completed—this may allow for efficient storage and movement of data. At a next step, an appropriate storage tier is determined, such as storage in EBS, S3, or Glacier, based on policy such as desired RTO, and data is transferred, such as by bringing up a cluster of EC2 nodes to transfer data in parallel to the determined endpoint. At a next step, upon detection of a failover event (which may occur automatically and/or on-demand), data may be retrieved from the appropriate storage tier, such as based on user-set policy, and data may be transferred, such as by bringing up a cluster of EC2 nodes to transfer data in parallel to the determined endpoint. At a next step, a rehydration step may occur wherein new VMs are rehydrated with disks in Amazon EC2, IP addresses may be assigned from information during the blue-print/discovery step, applications may be converted into Amazon EBS (elastic block storage), file servers may be rehydrated by attaching EBS to a new VM, etc. In embodiments, the VMs are brought up in order based on policy and group associations. At a next step, network failover to Amazon EC2 may occur, with Amazon VPC (virtual private cloud) utilized to bridge local IP addresses to new Amazon IP addresses.

The elastic nature of the hybrid cloud management platform means that new sites may be spawned, existing sites may be decommissioned, and new nodes may be added to existing sites (e.g., nodes with data movers). To support elasticity, all components involved in this architecture (e.g., persistence, job scheduling) may be designed for fault-tolerance, to survive network partitioning, and to be decentralized. In this architecture, the gateway nodes should be accessible.

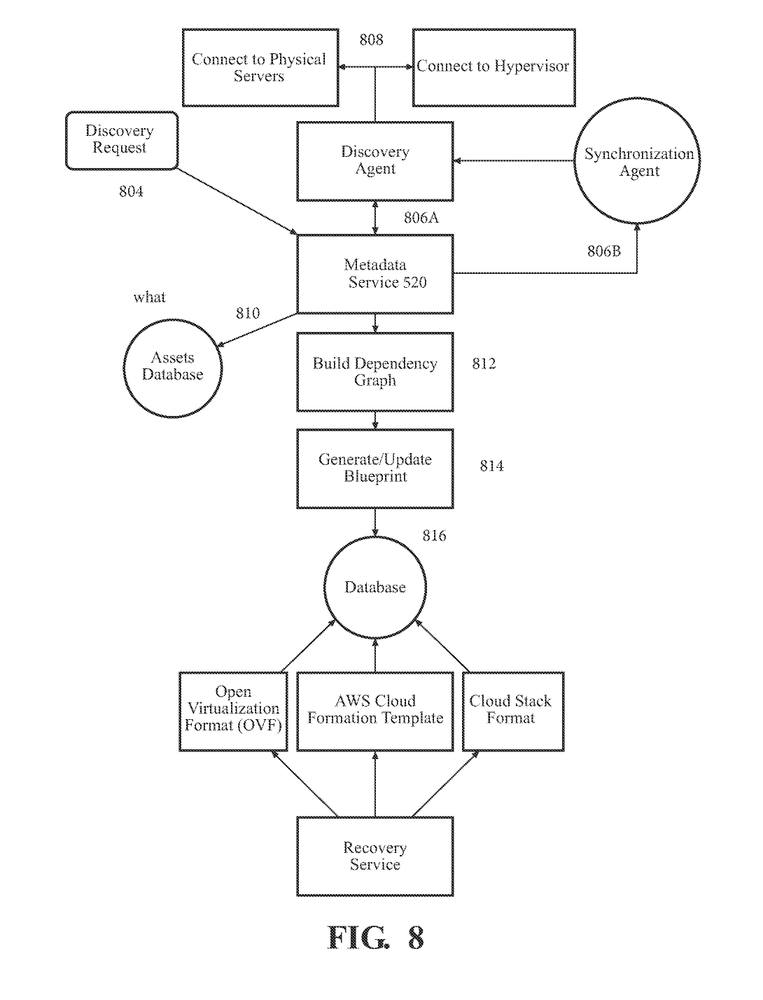

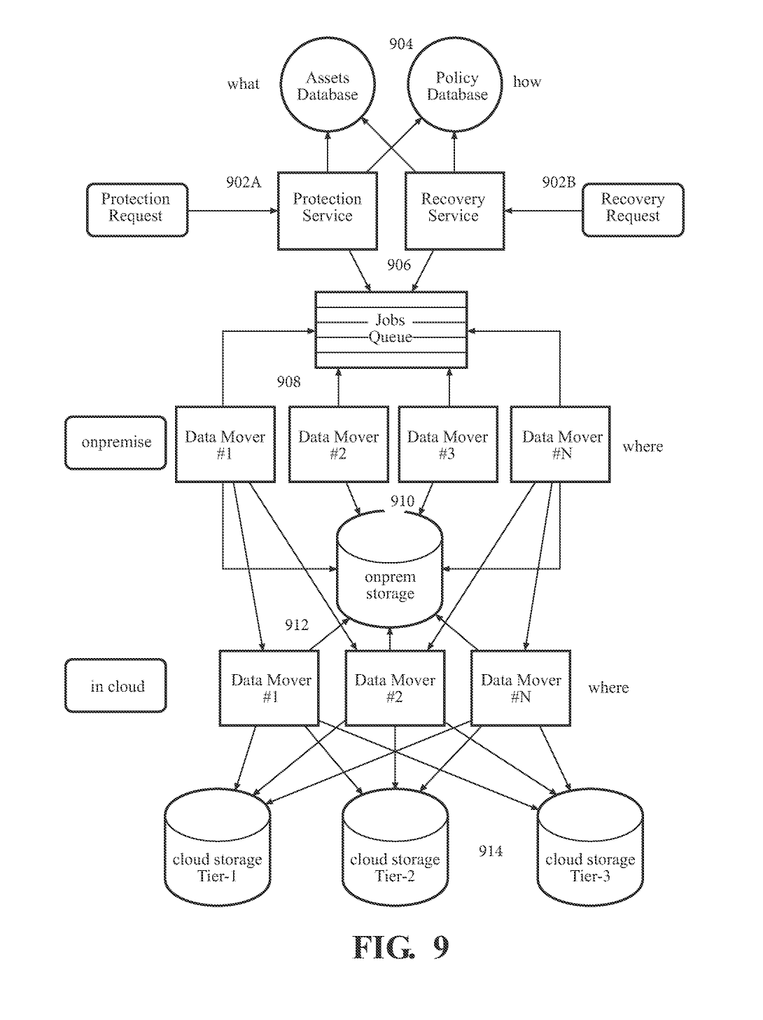

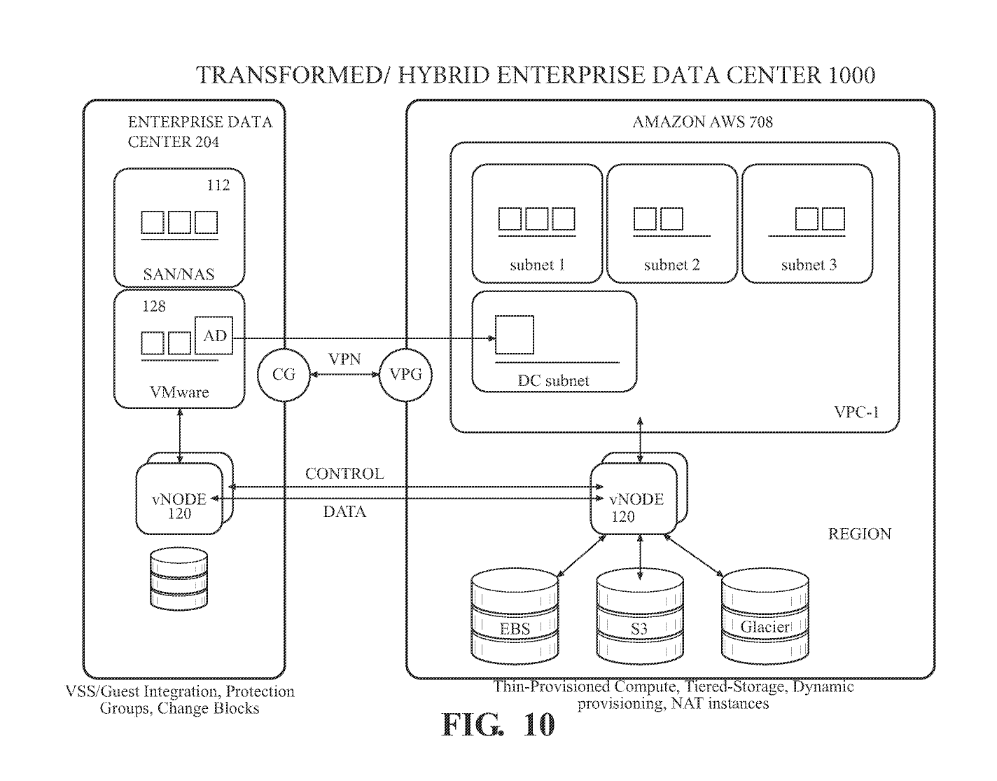

FIGS. 8 and 9 provide additional detail regarding key workflows that are enabled by the hybrid cloud management platform. FIG. 8 illustrates a discovery workflow, wherein at step 804, a REST API sends a discovery request to discover assets (such as virtual machine hosts/hypervisors or physical servers) to a metadata service 520. Credentials to access these assets are encrypted and sent via the request to the metadata service. At step 806A, the metadata service informs a discovery agent to collect inventory of the appropriate system. At step 806B, the metadata service also informs a synchronization agent to keep the inventory collection in sync periodically. At step 808, the discovery agent connects to physical servers and hypervisors and routinely and repeatedly collects inventory from the enterprise data center and resolves any conflicts in the inventory. At step 810, the metadata service persists any updates from the discovery agent to the assets database. The metadata service processes the inventory and collects all required information about the assets, such as networking requirements, compute requirements, and storage requirements. For example, networking information may include number of networking interfaces, IP addresses, virtual switches that are part of the network, and the like. Compute information may include processors, and memory, and the like. Storage information may include number and size of disks connected to the virtual or physical machines, etc. At step 812, a dependency graph is generated which links together the discovered assets. At step 814, a blueprint is generated or updated by a blueprint generator that processes the graph and transforms it to a generic format. At step 816, the generated output of the graph is stored in a database. This database is accessible by a recovery service.

FIG. 9 illustrates a protection workflow and a recovery workflow. With respect to a protection workflow, at step 902A, the REST API sends a request to protect one or more assets, which is sent to a protection service. At step 904, the protection service consults the assets database for the assets to be protected and looks to the policy database for the parameters for protections. For example, the policy database may include RPO (recovery point objective), RTO (recovery time objective), or SLA (service level agreement), which may relate to how often the asset needs to be protected, and how recovery of an asset from the cloud is to occur. The recovery service does the same. At step 906, a job is created based on the policy attributes, and this job is published (queued) to a persistent jobs queue. A job is a description of a unit of work to be performed by so-called data movers, a type of worker, as described below. This description contains information about the asset, e.g., which VM or file system needs to be protected, and what part of the asset, e.g., which blocks of the virtual disk or which folder or sub-directory should be protected, etc. At step 908, one or more data movers that participate in jobs processing consumes the request. Which data mover processes the job depends on a number of parameters including the workload currently being executed by the data mover, the amount of data in its pipeline to process, and various other factors. At step 910, each data mover (running on-premise) has the ability to push data to on-premise or cloud storage or to other data movers to assist in the data movement.

With respect to a recovery workflow, at a step 902B, the REST API sends a request to recover one or more assets that were protected, which is sent to the recovery or restore service. At step 904, the recovery service consults the assets database and policy database and processes the information to create jobs. At step 906, a job is created and published (queued) to a work or jobs queue. At step 908, one or more data movers that participate in jobs processing consumes the request. At steps 910, 912 and 914, the job is processed. Jobs processing may entail triangulating where the data for the job is stored, downloading data and rehydrating the asset based on the requirements of the job. For example, if a virtual machine is stored as a series of files in cloud storage, the data mover downloads all the fragments that make up the virtual machine, creates a virtual disk and imports the virtual disk into the cloud computing environment based on the desired policy, such as SLA, or RTO.

The platform may include a number of modules that exist as long running ‘jobs’. The jobs can take on multiple forms and include tasks such as backing up virtual machines or transferring large amounts of data to the cloud computing environment. The platform may include a feedback component that allows users to view the end jobs running on the system and ascertain the activity that each one represents. To provide this information, the underlying jobs may supply runtime information to the control plane of the platform, which may supply this information to end-users.

In embodiments, communication of status and progress may be handled by a publish-subscribe (pub-sub) module, using a pub-sub engine such as Redis Pub-Sub or Java Message Service like RabbitMQ/ApacheMQ etc. The job may publish very fine-grained detail about its efforts to a particular topic. A control plane may subscribe to this topic to learn of the details about the job state, and interpret this detail and publish a periodic summary that is consumed by clients, namely, the user interface which can display this progress to the end-users.

In embodiments, for each protection workflow or plan, the control plane may create three pub-sub topics, including two for communication with the jobs, and one for communication with the client. Note that a plan may be comprised of multiple jobs, including for example: snapshot VM, copy changed blocks, and transfer to cloud infrastructure. Thus three different jobs could be included in a single “protect this VM” plan. For example, these topics may have the following names: [planid].raw, [planid].control, and [planid].stats. The job may publish all the raw data about the work it is performing to the raw topic. The control plane may publish to the control topic when it has a message to send to the job. Additionally, the control plane may publish to a stats (statistics) topic when it has meaningful information about an in-progress plan. Launched jobs may be provided with the name of the topics they should publish and subscribe to. Clients may be able to subscribe to the appropriate topic by name knowing the plan-id they want updates for—i.e., the plan-id used in the topic name that matches the plan-id known to the client APIs. The message format used by the raw and control topics may be a binary format composed of protobuf-serialized message objects. Since the stats topic is consumed by the clients, it may use a Json (javascript object notation) serialized format more suitable for consumption by web-based clients.

As mentioned above, the hybrid cloud management platform 124 includes so-called data movers or workers, and a protection service to facilitate the steps described above. The protection service is responsible for orchestrating the workers and ensuring that jobs are successfully completed within an enterprise expected time window. The workers focus on a task and work to completion. Various types of workers may exist for different types of data center resources to be protected, and preferably have an implementation best suited for communicating with the particular data resource. A common API is created for the workers, so the protection service may wrap each worker type in a Java object that implements a general worker API. This wrapper object allows the service to fetch the information it needs from the worker regardless of how the worker is implemented. The worker provides this information and its presentation depends on the worker and its wrapper.

The workers may provide information including status of the work it is performing and progress, if possible. Often work is split into logical stages and one stage generates work for another, so it may not be possible to calculate progress for a stage that requires earlier stages to complete before progress is known. Otherwise, progress may be reported in XML code.

Generally, workers may not have insight into high-level concerns of the platform as a whole. They may be set off on a task or job and are expected to finish that task as quickly possible. In some scenarios, workers may not run at full capacity. For example, consider a worker A having a RPO of 24 hours for a job that takes 20 minutes to execute, along with a worker B having a RPO of 1 hour for a job that takes 59 minutes to execute. It may not be desirable for worker A to run at full capacity and risk getting worker B into a failed compliance state. Instead, it may be better for worker A to run with reduced resources and finish a little slower, while still allowing both workers to meet their associated RPO. This may entail allowing communication between workers such that certain parameters may be varied based on instruction from the protection service. A high level exchange between workers and the protection service may facilitate an intelligent allocation of system resources between workers. For example, workers may maintain some nominal run level which corresponds to the amount of resources they are allowed to consume—such as on a scale from 0 to 10; or allowed ranges such as 0-3, 4-6, and 7-10. An associated run level would affect the quality of resources it is allowed to consume and could be varied according to conditions.

Job management may utilize a number of features and patterns provided by Akka™ (an open source toolkit and runtime that simplifies the construction of concurrent and distributed applications to the Java Virtual Machine (JVM)), including balancing workload across various nodes Akka is an event-driven middleware framework, for building high performance and reliable distributed applications, such as in Java and Scala Akka decouples business logic from low-level mechanisms such as threads, locks and non-blocking IO. Scala or Java program logic lives in lightweight actor objects, which send and receive messages. With Akka, actors may be created, destroyed, scheduled, and restarted upon failure in an easily configurable manner Akka is Open Source and available under the Apache 2 License (see “akka.io”). In particular, Akka is summarized in the Let it Crash article of Balancing Workloads Across Nodes (see “http://letitcrash.com/post/290669086/balancing-workload-across-nodes-with-akka-2”.)

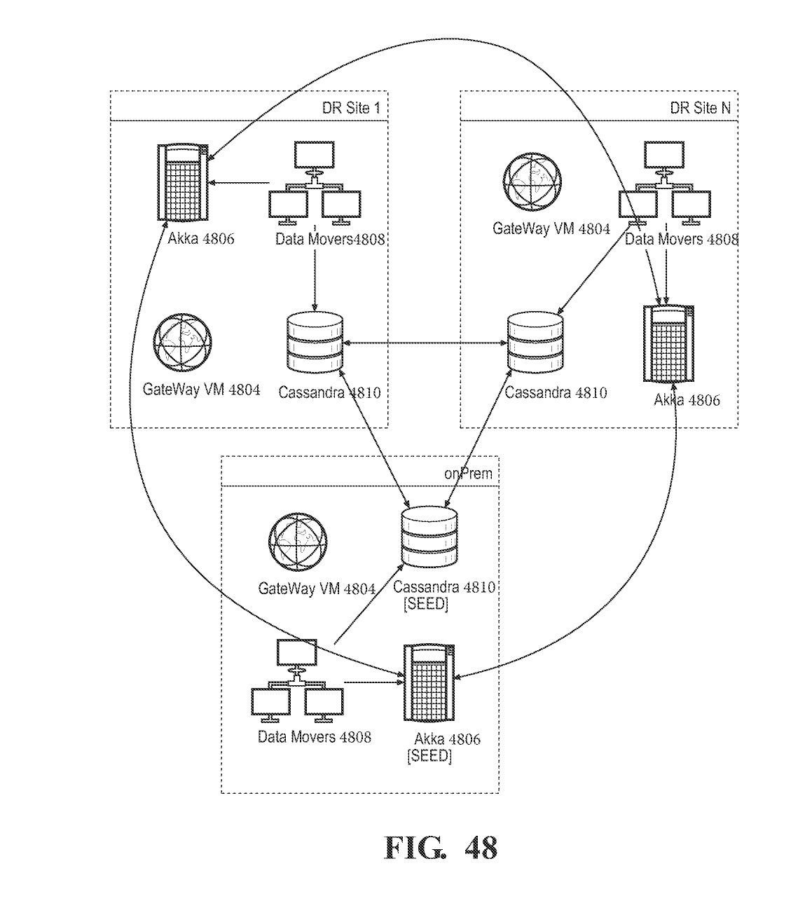

With respect to FIG. 48, the hybrid cloud management platform may include, for each site, a gateway virtual machine 4804 that may act as a master node. Each gateway 4804 may comprise an Akka node 4806 with a persistent mailbox that contains a queue of corresponding jobs/tasks, a JVM (Java virtual machine), and run an Akka scheduler that monitors existing policies and manages the queue by scheduling or canceling jobs. Data mover (worker) nodes 4808 may register with the gateway when they are available to process work, which facilitates an elastic pool of worker nodes, and by leveraging a gateway's persistent mailbox, data movers can crash or reboot without work being lost. For each site, the gateway 4804 may control one database cluster, such as a Cassandra™ cluster 4810 and one Akka JVM.

A gateway 4804 may provide tasks to the data movers 4808 as appropriate, that is, it may decide what tasks are to be handled by which data movers. In a workflow, the queue may draw a (technically slight) distinction between “jobs” and “tasks”. Jobs may be top-level work items that represent a large effort. For example, protection or restore workflows would be represented by a job. A task may be a smaller unit of work that belongs to a particular job. Using a priority queue, tasks can jump to the front of the queue to assume a priority relative to the job that spawned them.

Jobs and tasks may also specify an optional affinity value. Workers may register with the gateway using a particular affinity ID. Any jobs that specify an affinity may have to match their requested affinity with the affinity ID of a worker before the job is assigned. Note that affinity may circumvent the priority settings of certain tasks. The gateway may try to optimize worker productivity by keeping as many workers busy as possible.

The hybrid cloud management platform may have two stores of persistence, including a durable Cassandra cluster, and a durable Akka task store, which may be a local, on-disk file store.

Cassandra, such as Apache Cassandra, is a massively scalable open source NoSQL (not only structured query language) database management system with distributed databases, which allows for management of large amounts of structured, semi-structured, and unstructured data across multiple data center and cloud sites. Cassandra provides continuous availability, linear scalability, and operational simplicity across many commodity servers with no single point of failure, along with a powerful dynamic data model designed for maximum flexibility and fast response times. Apache Cassandra is an Apache Software Foundation project, and has an Apache License (version 2.0).

Cassandra utilizes a “master-less” architecture, meaning all nodes are the same. Cassandra may provide symmetric replication, with every node sharing equal responsibilities. Cassandra may provide automatic data distribution across all nodes that participate in a “ring” or database cluster. Data is transparently partitioned across all nodes in a Cassandra cluster. Cassandra may also provide built-in and customizable replication, and store redundant copies of data across nodes that participate in a Cassandra cluster. This means that if any node in a cluster goes down, one or more copies of that node's data is available on other machines/servers in the cluster. Replication can be configured to work across one data center, many data centers, and multiple cloud availability zones. Thus, Cassandra is able to handle large amounts of data across many commodity servers, providing high availability with no single point of failure. Cassandra offers robust support for clusters spanning multiple datacenters, with asynchronous master-less replication allowing low latency operations for all clients.

A Cassandra database may contain all the long-term storage and cross-site replication needed for a hybrid data center. Despite the eventually consistent nature of Cassandra, it may be the acting authority on the state of the system, and contain data about the resources that require protection, the schedules at which they are protected, and any metadata needed to access them.

In embodiments, the on-premise site may act as the seed for both the Cassandra and Akka clusters. Once a remote site connects to these seeds, it can become aware of other nodes in the cluster and, barring any firewall/network restrictions, may be able to communicate with them.

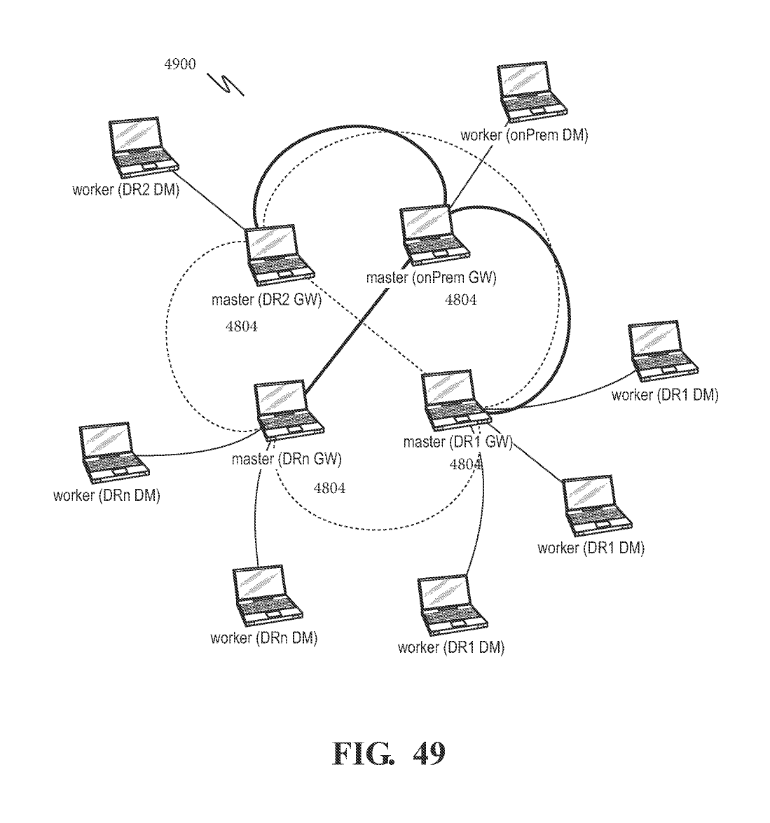

Referring to FIG. 49, an Akka cluster 4900 is inherently decentralized. However, to support distributed, durable queues with local affinity, Akka nodes may be logically hierarchical, such as illustrated in FIG. 49.

Each gateway 4804 may manage an Akka node designated as the site-local master. This node is equivalent to the master node of the Master-Worker pattern at “http://letitcrash.com/post/29044669086/balancing-workload-across-nodes-with-akka-2”. Each site may horizontally scale its data movers independent of other sites, and each data mover may be part of the cluster, but data movers may only request work from their site-local master. Given the known work these movers may accomplish (e.g., backup, restore), keeping their work queues local naturally mirrors job affinity.

With respect to initial start-up, when a gateway 4804 is allocated/installed it may create a brand new installation/cluster or join an existing cluster. Note that a “cluster” in this sense is a collection of gateways, one each in a DR site. In embodiments, the cluster may have only two nodes: one on-premise and another in the cloud (AWS). Starting a new cluster, the queue may start out empty and wait for requests to create jobs/tasks or for data movers to register themselves. Joining a new cluster may occur when a gateway is catastrophically lost and must be re-built from scratch.

The gateway 4804 may hold the work queue that the data movers pull work from. If the gateway is lost or powered down, data movers may not be able to acquire new work. Therefore, when the gateway comes back online, a gateway reboot or rebuild may occur.

In embodiments, a gateway may be simply restarted. Its semi-durable queue may still be intact and it may resume handing work out to the data movers. It may first re-announce its presence to all known data movers, which may effectively notify them that a restart has occurred. This may allow the data movers to re-register with the gateway if they are (or once they are) idle.

In embodiments, a gateway rebuild may occur and the gateway may be brought back online anew. In this case, it has to re-seed its job queue with work that needs to be performed. Many of the jobs may be re-submitted by the scheduler when it detects policies in the Cassandra database that do not have pending jobs in the queue. Also, workers may report the jobs they are currently working on (if any) to allow the queue to re-populate with an in-progress list. In embodiments, any in-progress work may be cancelled, since all tasks (as opposed to jobs) that were in the queue may be irretrievably lost. No efforts are made to re-create the tasks.

When a data mover is lost, any in-progress job it had running will be orphaned. A death-watch service running on the gateway may recognize the lost worker and re-submit the job. It may first cancel all tasks that are still queued for the lost job before re-queuing the job.

To fulfill RPO/RTO policies, backups may be performed with an appropriate cadence. At any time, a user may also be able to stop/cancel or reschedule a job. The responsibility of scheduling jobs may reside in Akka.

For each given site (e.g., onPrem, AWS), the gateway node hosts a master Akka node. Besides distributing work to its local data movers, this master node is responsible for scheduling jobs that have a local affinity. For example, restoring a VM from a particular AWS site (such as us-east-1) should be processed at that site (in us-east-1), and would therefore be defined as having an affinity for that site (us-east-1).

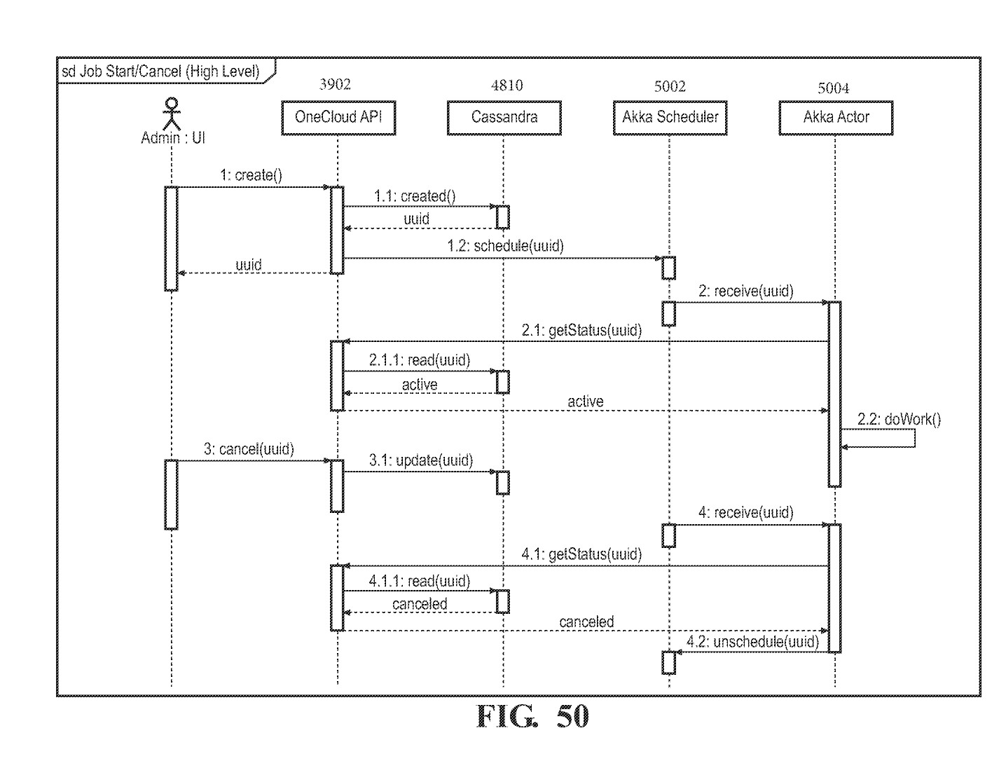

The sequence diagram in FIG. 50 provides a high-level glance of the scheduling framework, and the initiation and cancellation of jobs. In particular, at step 1, a user may cause a new job to be scheduled by interacting with the user interface or API 3902. This may include a few intermediary steps 1.1 and 1.2, like a REST call, but the ultimate endpoint is for the platform API to create the job via Cassandra 4810 and schedule the job using the Akka Scheduler 5002. After the job details have been persisted and the job scheduled, step 2 is asynchronously triggered, such as according to a desired RPO/RTO cadence. Before executing the work, the involved Akka actor 5004 at step 2.1 performs a due diligence check to validate the job is still active, and performing the work at step 2.2. Step 3 correlates with a user canceling a job. For example, this could be another user-driven action from the user interface. The job details are updated in Cassandra 4810, abstracted via the API, to reflect the change in status. Just like in step 2, at step 4 the Akka actor 5004 is again triggered to perform the job. This time, when the actor performs its due diligence check at step 4.1, it learns that the job has been cancelled. The actor then attempts to unschedule the job at 4.2.

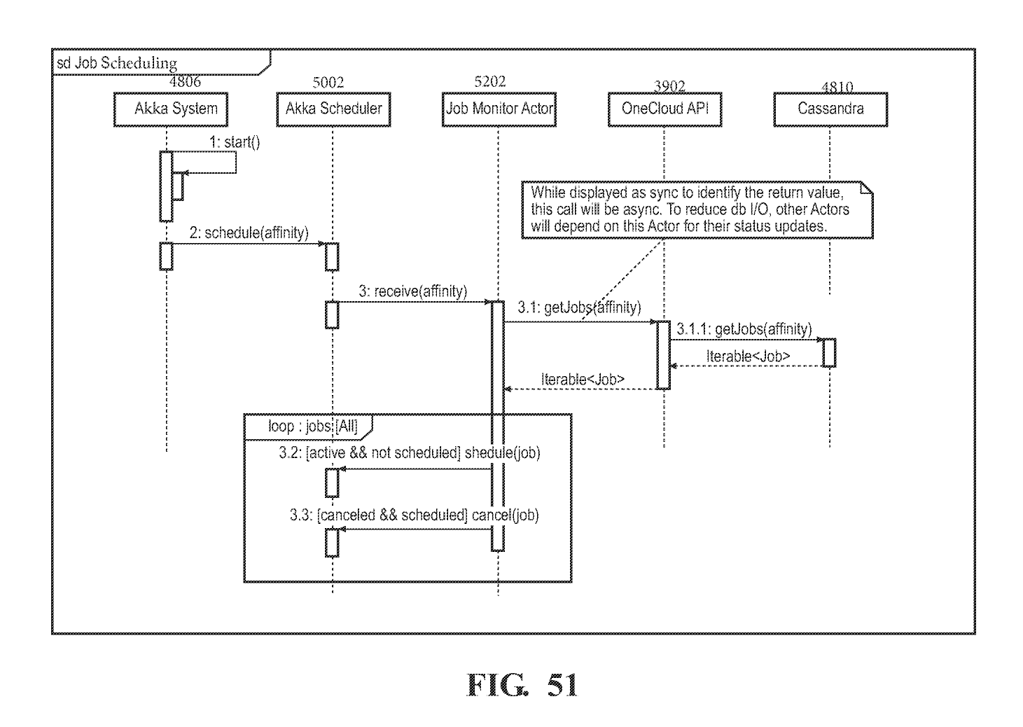

A more detailed explanation of the Akka scheduler may be provided with respect to FIG. 51. While the platform API 3902 may provide a means to schedule a job, nodes must be able to bootstrap themselves to recover from reboots, which may kill the Akka JVM and in-memory scheduler, and also new nodes that are rebuilding a site (e.g., VM loss).

With respect to FIG. 51, this sequence corresponds to a site-local master Akka node 4806. These nodes should have awareness of their affinity (e.g., us-east-1), which can be provided by an OCVA (OneCloud virtual appliance) configuration. After the actor system starts up, in step 2 it creates and schedules (via akka scheduler 5002) a job monitor actor 5202 given the affinity classifier. This actor's responsibility is to track the status of all jobs for which it has affinity. As part of step 3, when the job monitor actor 5202 is triggered, it may update its local state and conditionally schedule or cancel jobs. The importance of this actor may be downgraded with an appropriate pub-sub module, but might not be entirely eliminated given the potential transitivity of nodes and the eventual consistency nature of Cassandra.

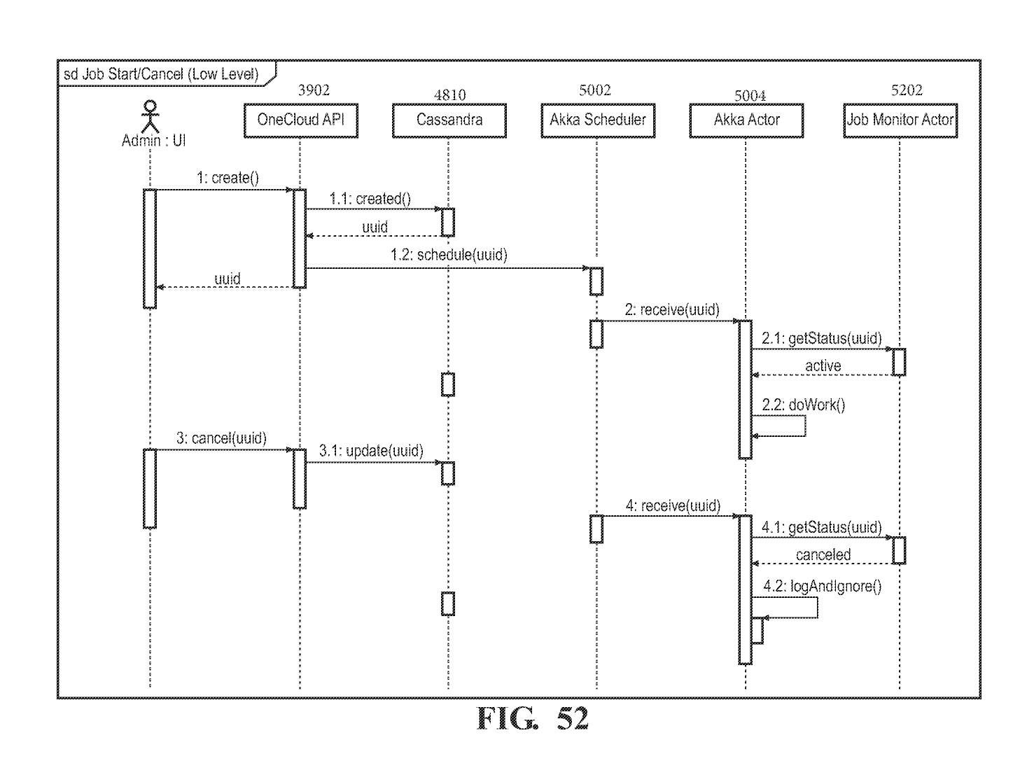

FIG. 52 is a sequence diagram that illustrates additional detail regarding job initiation and cancellation. In embodiments, the inclusion of a job monitor actor 5202 may mean that other actors no longer ping the API. By recording the job state local to itself, the job monitor actor 5202 eliminates numerous calls against Cassandra 4810 and may improve actor 5004 throughput. While there is inherent latency in this system, from eventual consistency of the database to the detection of changes in the job monitor actor, this latency is not a critical concern and can be mitigated by a more aggressive triggering of the job monitor actor or the introduction of a pub-sub module, such as one that provides durable subscriptions.

A task store may be used to back the persistent queue used by the Akka mailbox. The task store may be local to the gateway server and immediately consistent. If the gateway is lost, so too is the task store.

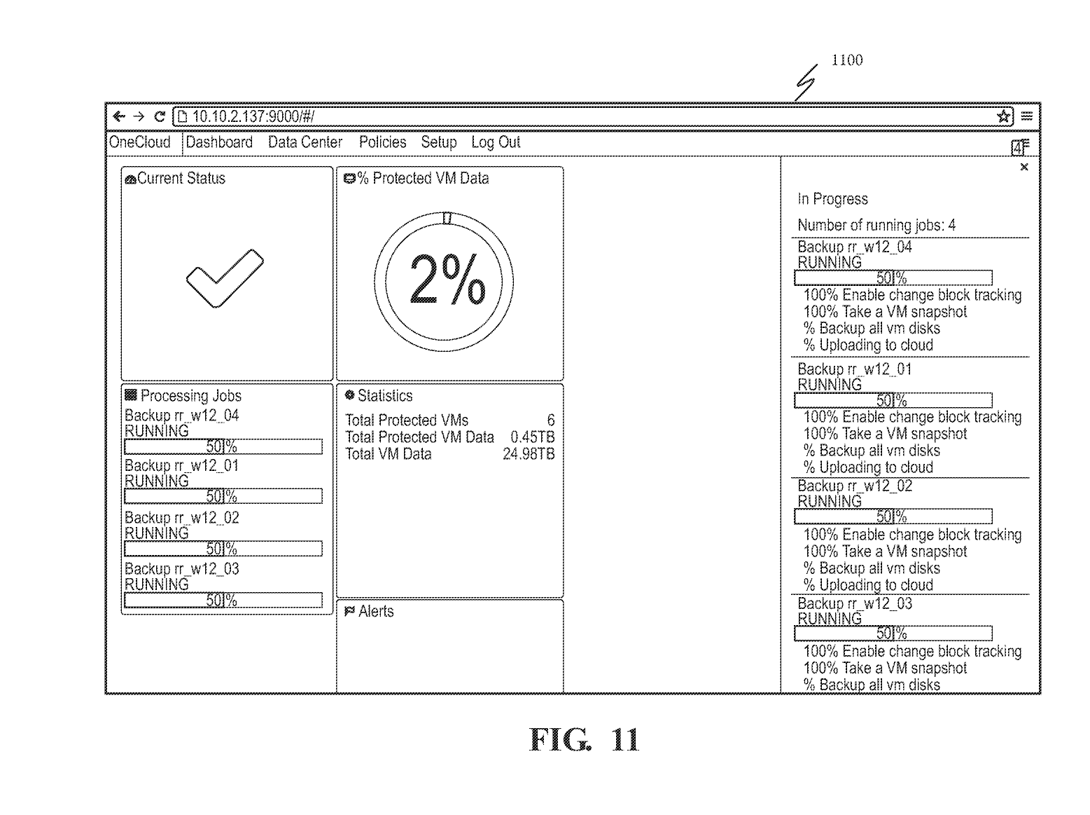

FIG. 10 illustrates in more detain a hybrid virtual enterprise data center 1000 for providing disaster recovery and business continuity services, wherein an on-premise or enterprise data center 204 is bridged with a cloud computing resources 208, specifically AWS 708 running a virtual machine such as EC2 with a VPC (virtual private cloud) including a plurality of subnets, and controlled and managed via Vnodes 120. Data can be stored in AWS 708 in various tiers, such as EBS, S3, or Glacier storage tiers. VSS/Guest integration, protection groups, and change blocks capabilities may be implemented on the hybrid virtual enterprise data center 1000. A Volume Shadow Copy Service (VSS) is a set of COM APIs that may implement a framework to allow volume backups to be performed while applications on a system continue to write to the volume. A VPN (virtual private network) connection may link the enterprise data center 208 with the cloud resources 208.

FIGS. 11-14 illustrate respective exemplary screens 1100, 1200, 1300, and 1400 of a seamless and intuitive user interface that may provide a simple user experience wherein a user is allowed to set policy with respect to management of an enterprise data center, obtain on-demand provisioning of cloud compute and storage resources, and obtain policy based cost appropriate use of cloud storage tiers. Further, the user interface may enable automated disaster recovery testing, alerting and reporting of disaster recovery events, and provide cost and projected cost reporting. Also, the user interface may provide status information regarding amount of protected data (such as a percentage of total data, absolute amount, number of protected virtual machines, etc.), jobs that are being processed and their status, such as waiting, running, paused, failed, or complete; specific information regarding which physical or virtual resource is being protected, such as a filename, server name, or the like; how far along the various jobs are, such as the number of bytes, files, lines, or the like which have been processed; the number of items the job has yet to complete; warning or error messages; and statistics regarding the protected data, such as shown in FIG. 11. The user interface may illustrate an inventory of a local data center as well as cloud components and these components can be visually presented via the user interface.

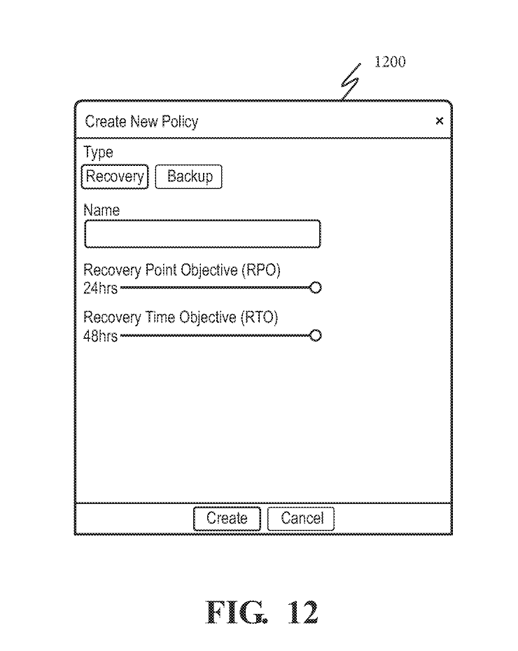

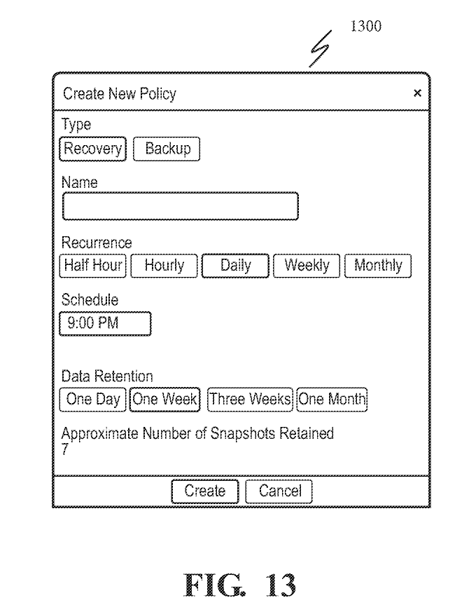

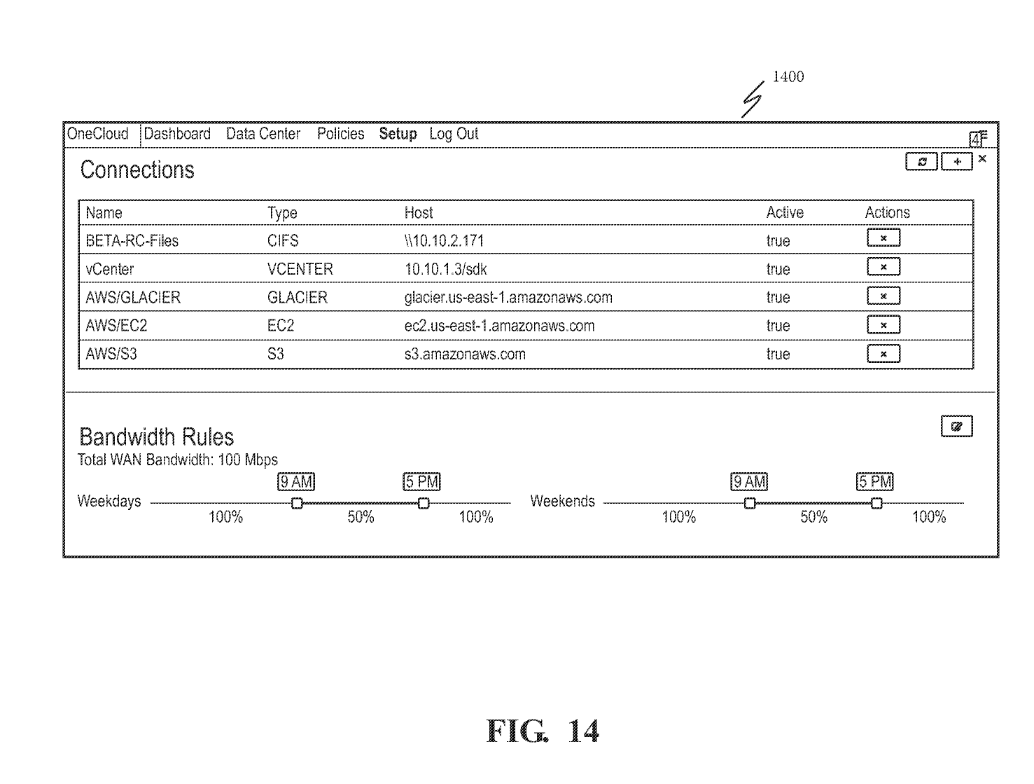

The user interface may provide the ability for specific RTOs and RPOs to be set for recovery and backup for various enterprise data center components, such as shown in FIG. 12, and to set times and recurrences for recovery and back up, and to set data retention policies, as shown in FIG. 13. The user interface may provide the ability to set and show connections with various cloud-computing resources and the ability to set bandwidth rules for these connections for various times, such as illustrated in FIG. 14. Bandwidth rules allow for the ability to variably control the amount of bandwidth used on a Local Area Network (LAN) or Wide Area Network (WAN) for data transfer at different times of the day. For example, during typical business hours of 9 AM-5 PM, an applied bandwidth throttle may set the rate to a lower percentage, such as 50% of the available rate, while a higher rate, such as a rate of 100% of the available rate can be set for non-business hours, such as 5 PM-9 AM. In this manner, data transfer may have less effect on the business use of the network during business hours.

Additionally, external or manual operations may be performed by the user of the management platform via the user interface. These operations typically include customer or site-specific operations relating to the specific network, authentication protocol, and/or firewall settings. Additionally, these operations may include manual customer activities for network setup for testing failover operations.

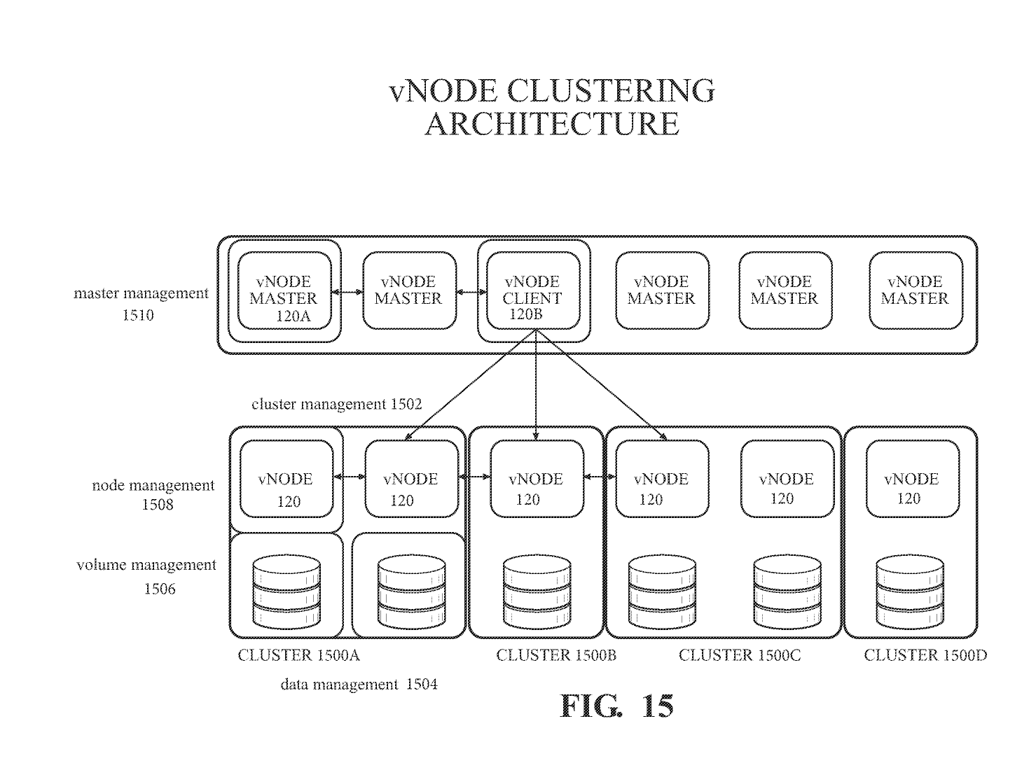

FIG. 15 is an illustration of a clustering feature of an exemplary vNode architecture. In embodiments, vNode clusters 1500A, 1500B, 1500C, and 1500D may be arranged in an architecture with master management, cluster management, node management, volume management, and data management layers.

A master management layer 1510 may comprise a vNode master 120A and a vNode client 120B. The vNode master 120A may maintain metadata about nodes. The vNode client 120B may consult the master about which nodes to shard files to and which nodes need to be rebalanced. The vNode client 120B may comprise an infrastructure management API to build a large-scale (peta-byte plus) storage subsystem in the cloud. The vNode client 120B may present a virtual mountable file system and may provide for file system operations including streaming protocol for fast transfers. In embodiments, a cluster management layer 1502 and node management layer 1508 may dynamically add or remove Vnodes 120, dynamically add or remove storage, create arbitrary clusters from nodes, replicate data with file level granularity, allow file level sharding, inter-node replication, inter-node rebalancing, and implement a high-speed transfer protocol, among others.

A data management layer 1504 may be responsible for POSIX (portable operating system interface) file system management, mounting file systems and network protocols, such as CIFS (common internet file system) or NFS (network file system), managing plugins for block level applications or streaming API integration, as well as block-level deduplication, compression, and encryption. A volume management layer 1506 may be responsible for RAID (redundant array of independent disks) level protection at all RAID levels and data cloning, among others.

In embodiments, a platform policy may comprise a method to identify a use or case-driven workload. In turn, the platform may federate the appliances within the platform network based on the workload that is required. Workload may comprise the amount of computing power needed to process large amounts of data in order to send the data to storage tiers. In a non-limiting example, disaster recovery policy may comprise the indication of recovery point objectives and recovery time objectives for recovery of data. The policy may be expressed in the form of XML, or any other language known to the art, and programmed into the platform workflow engine. A user may affect policy by indicating objectives of higher importance or priority. Alternatively, a user may choose to identify high level goals, which the platform translates to policy objectives, such as identifying the rate of replication, how often snapshots are taken of data, how to store the data across layers of the cloud, or how the platform should replicate the data over a wide area network, among others. Additionally, virtual node clusters 1500 may be created based on the number of virtual CPUs required to process or stream the data present.

In embodiments, the scalable virtual appliances (vNodes 120) may be scaled up or scaled down with respect to multiple attributes, such as, but not limited to, capacity, memory, or speed. Virtual CPUs or a memory footprint within a vNode may provide information for scaling. Likewise, the scaling of a cluster may be based on the number of virtual CPUs needed to process data, such as by detecting synchronous replication or asynchronous replication within the system. The scalable virtual appliance may comprise a CPU, storage, and memory within a single appliance. A virtual CPU may be based on virtualized hardware, such as, but not limited to, virtualized hardware hypervisor produced by VMWare, where blocks of CPU capacity are assigned to virtual machines. Triggers for dynamic scaling may include, but are not limited to, data processing volume, load, memory requirements, and storage needs, among others. In embodiments, the platform may comprise dynamic thresholds for triggering virtual appliance scaling. A metadata collector may collect information about the amount of storage needed. The platform may then create thresholds to determine when to dynamically provision additional storage in the cloud. In a non-limiting example, if usage is increased from 10 to 20 Terabytes in a year and only 50% is protected, the platform may resize the pool to allow the syncing of more data as needed.

In embodiments, the platform may perform data discovery. Virtual appliances may examine different data sources within the platform virtual machine infrastructure or outside in order to identify data. Based on the data, changes to the data, status of the data, etc., the platform work engine may be influenced in order to conform with platform policy, such as for disaster recovery.

In embodiments, the platform may comprise hierarchical storage. Hierarchical storage may comprise policy based monitoring of data sources. Hierarchical storage may comprise the detection of data alterations as compared to archived or static data. Hierarchical storage may additionally comprise the allocation of data across on-premise as well as cloud storage resources based on a policy. Policy parameters may comprise data type (e.g. the format of files), the times for retrieval, data size or volume, or frequency of data modification, among others. Hierarchical storage may be influenced by platform policy. Hierarchical storage may relate to modification of the data source. The platform may monitor virtual machines within the platform network to see if data is changing or if data is static or archived. Data may then be hierarchically moved between on-premise storage or different tiers of cloud storage. The data may also be stored across premises and the cloud according to a platform policy, with inputs such as, but not limited to, access times, modification times, and geography.

In embodiments, each platform virtual appliance may comprise a role. Each role may comprise multiple collaborative services such as data protection services, recovery services, monitoring services, metadata collection services, directory services, and the like. Each virtual machine may run any service and multiple virtual machines within the platform may take on the same service. If a virtual appliance is lost, others within the platform network, either on-premise or in the cloud, may pick up the lost role. In embodiments, a virtual machine may comprise a protection and disaster recovery service. The protection service may comprise taking snapshots of data in hypervisor and used to replicate in a virtual appliance. The snapshots may be streamed to a cloud or may be used to detect data change. Adapters for SCSI driver and hypervisor kernel layers may also be used for the protection service. The platform protection service may comprise an indexing engine that may be used to speed transmissions. In embodiments, a feedback loop may be employed as file system movers and scanners to transmit to the cloud. In the embodiments, the recovery service may reconstitute data from multiple tiers of cloud services. Additionally, the recovery service may use APIs from various web service product providers, such as Amazon. The platform may monitor the health of a specific virtual machine and alert actions based on services available to the network. Additionally, platform policy may be used to assign roles and services.

In embodiments, the platform may comprise a federated distributed database. The database may comprise engines within the architecture that have their own key value store. Additionally, the engine may comprise algorithms that may enable high-speed lookups across a federation of databases. Databases within the federation may communicate with each other to manage state, eliminating the need for a central database or authority. In embodiments. Nodes may be replicated into other slaves within a multi-master architecture. In embodiments, a loss of a machine on-premise may transition the master to the cloud or vice versa. In embodiments, each virtual appliance may serve as a database within the federation. Virtual appliances may serve as a gateway, allowing other virtual appliances to create tunnels or VPNs across on-premise or cloud environments. In a non-limiting example, virtual appliances may allow traffic movement from a physical on-premise data center with a presence in two different cloud networks as if all of the data centers were on the same network. Additionally, the virtual appliances may serve as a data mover, allowing other virtual appliances to replicate large amounts of data in different environments based on a policy at either the block or file level. In embodiments, the database may utilize file system and logical volume manager resources such as ZFS (type of file system by Oracle) in order to pause and resume or start and stop data movements. This functionality may allow picking up where the system left off prior to a loss of connectivity. Such functionality may also facilitate movement of data to the cloud. In embodiments, the database may take a plurality of snapshots of the current environment at different timing intervals. In embodiments, the platform may utilize a distributed implementation of ZFS, comprising multiple virtual appliances each with a single ZFS pool. Lookups may be accomplished in a cache by creating a distributed ZFS, where a whole cluster may be taken, either on or off premise, and made to look as if there is a storage structure than may grow infinitely. The storage may then be pooled in a federated system. The distributed view facilitates management of the increasing storage structure. Additionally, a logical volume manager may assist visualization and management of the entirety of the storage.

In embodiments, the platform may comprise the encryption of cloud credentials. Data may be sent using private or public XML to define document encoding. Elements may be encrypted automatically or manually and may be encrypted as these elements or pieces of data are sent across the network.

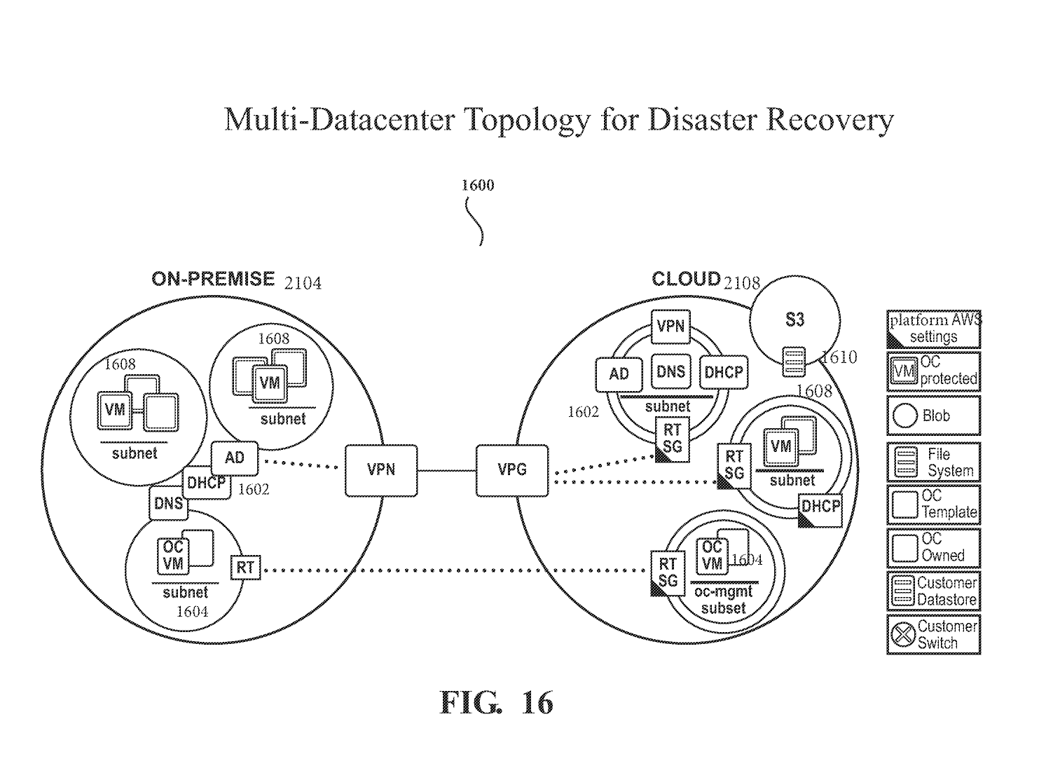

FIG. 16 illustrates another embodiment of a hybrid data center 1600 that includes a hybrid cloud management platform, such as embodied as a software virtual appliance or set of virtual machines, designated as OCVMs 1604 (One Cloud virtual machines). The platform acts to seamlessly bridge various enterprise data center components 2104 (such as physical, virtual, and cloud data center components) to cloud computing infrastructure 2108, to address the business use case of disaster recovery/business continuity for the enterprise. Enterprise managed resources/assets 1602 may exist on-premise or in a cloud. The “cloud” in FIG. 16 thus represents infrastructure resources and services offered from various service providers such as AWS, Microsoft Azure, or some other distribute computing environment, as described herein, including file system 1610. With such cloud infrastructure resources and services, some virtual machine implementations, including but not limited to VMWare Hypervisor access, may be unavailable, and compute, storage, and networking resources may be accessed via REST APIs or RESTful-like APIs. Various virtual machines 1608 may be protected by the platform. In embodiments, the management platform may be hosted for download to an enterprise data center either on-premise or inside the cloud, such as AWS EC2. The management platform software may be bundled as an OVA (open virtualization archive), which is a container technology for distributing VMs.

Thus, the management platform as described herein may link together a plurality of virtualized computing environments and take advantage of the resources provided by on-demand cloud computing infrastructure, such as available from various cloud computing service providers. The management platform may offer a workflow execution engine, may perform monitoring and replication functions, and may offer various other services of interest to an enterprise having an enterprise data center (also referred to herein as an on-premise or primary data center). In embodiments, this management platform may be Linux-based, and the OCVMs 1604 may span on-premise and cloud infrastructure to create a bridge to seamlessly share and use resources from the two different environments.

As mentioned, disaster recovery (DR) describes a strategy and process where businesses operating a primary data center replicate some or all of their critical applications for the purposes of business continuity after a full or partial failure. As used herein, disaster recovery encompasses more than just backup because it also entails meeting the service level agreements with respect to recovery of applications. Many times, businesses, for compliance purposes or operational agility, have one or more DR sites that are managed by them or by an IT (information technology) department or a third-party managed service provider (MSP). Such organizations that perform DR functions typically have associated business SLAs to meet for application availability. For example, an organization may classify applications in various tiers, such as tier 1, tier 2, or tier 3; where tier 1 applications are those that are the most critical applications and typically have aggressive SLAs for recovery in the event of a disaster event, with typical RPOs of minutes to hours and RTOs near zero. Tier 2 applications are critical applications that usually have a higher tolerance for data loss, with typical RPOs and RTOs s on the order of hours, while tier 3 applications are not as critical in terms of data loss and data availability, with typical RPOs and RTOs in days. Each application tier thus has a corresponding RPO and/or RTO requirement, generally defined via an SLA. Commonly, tier 1 applications may include email services, directory services, and network services.

In embodiments, a disaster recovery plan may be expressed as a specification or SLA, which is a set of expectations and actions that allow the management platform to identify one or more groups of resources that need to be protected and how they should be recovered in the event of a declared failure. For example, a disaster recovery plan may specify particular sets of applications that should be protected with associated RPOs and RTOs. Once scheduled, the management platform may automatically determine when to protect the groups to meet this SLA. Given that there are always limited resources that affect the SLA, such as bandwidth available to replicate data, change rates of data within the source applications, disk I/O performance within the local infrastructure, memory/CPU constraints that limit distributed processing, etc., the platform may perform at so-called ‘best effort’ to meet the SLA, and alert the user if the SLA cannot be met due to limits in the environment that cannot be overcome over a period of time. For recovery, the RTO specifies the maximum time to recover the applications, and the management platform may again provide a best effort performance given various constraints, and determine an appropriate order of recovery taking into account the size of applications, application dependency, and other criterion.

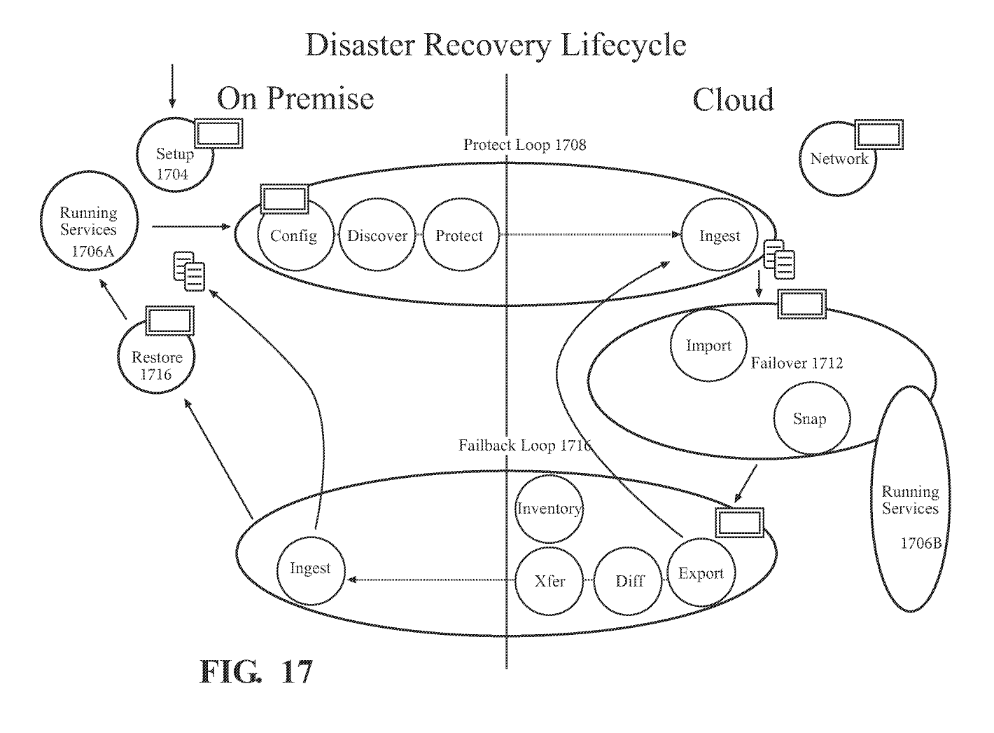

FIGS. 17-20 provide high-level schematic illustrations of a disaster recovery lifecycle. In particular, FIG. 17 illustrates set-up 1704 of the disaster recovery services, a protect loop 1708 for running services 1706A, a failover loop 1712, a failback loop 1716 to provide running services 1706B, and restore 1718 to re-obtain running services 1706A. Protect loop 1708 includes configuration, discovery, and protection of resources and services 1706A, with ingestion of data in the cloud. When failover is necessary, an ordered recovery of applications and services is provided, with import and snap processes of failback loop 1716. The failback loop 1716 includes inventory, transfer, diff, and export steps, with an ingest step back to the on-premise site.

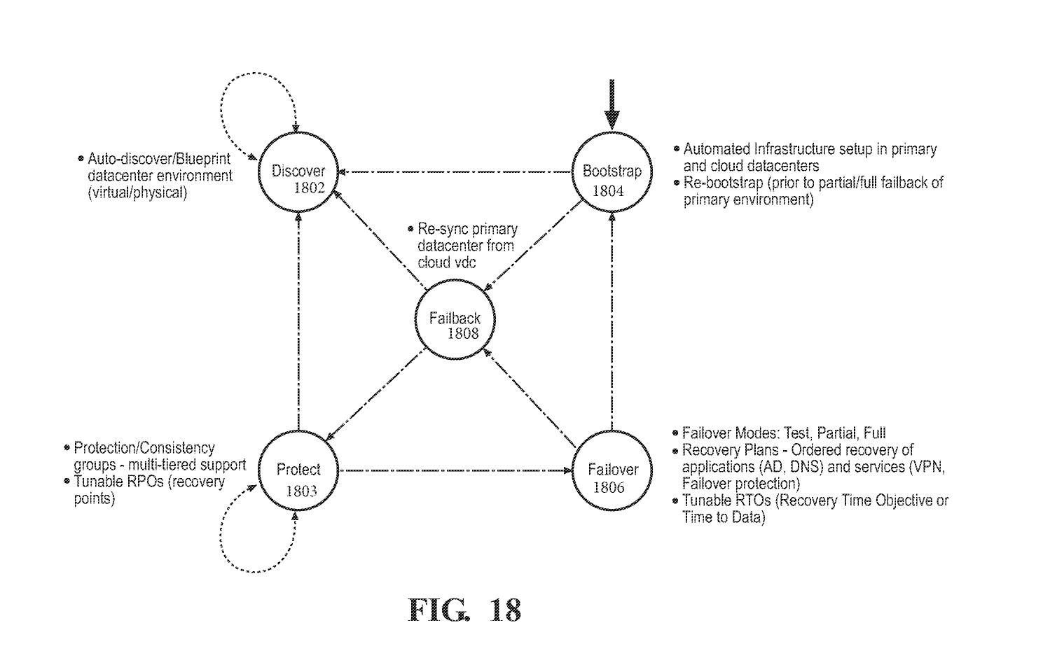

FIG. 18 illustrates various elements/states associated with a disaster recovery lifecycle. In particular, a discover element 1802 may act to auto-discover and blueprint a virtual and/or physical enterprise data center environment, such as one corresponding to an enterprise data center, and which includes virtual and physical components. A bootstrap element 1804 may act to automatically set up the infrastructure in a primary data center (the main service point for delivering IT services to end-users in an enterprise) and cloud data centers. The bootstrap element 1804 may be operable to perform a re-bootstrap to do the same prior to a partial or full failback of the primary data center. A protect element 1803 may provide protection and consistency groups, with multi-tiered support, according to tunable RPOs. A failover element 1806 may provide various modes including test, partial, and full failover. The failover element 1806 may also provide appropriate recovery plans for an ordered recovery of applications [e.g., AD (active directory) or DNS (domain name service)] and services (e.g, VPN, or failover protection), according to tunable RTOs. A failback element 1808 may be triggered to re-synch the primary data center from the cloud virtual data center.

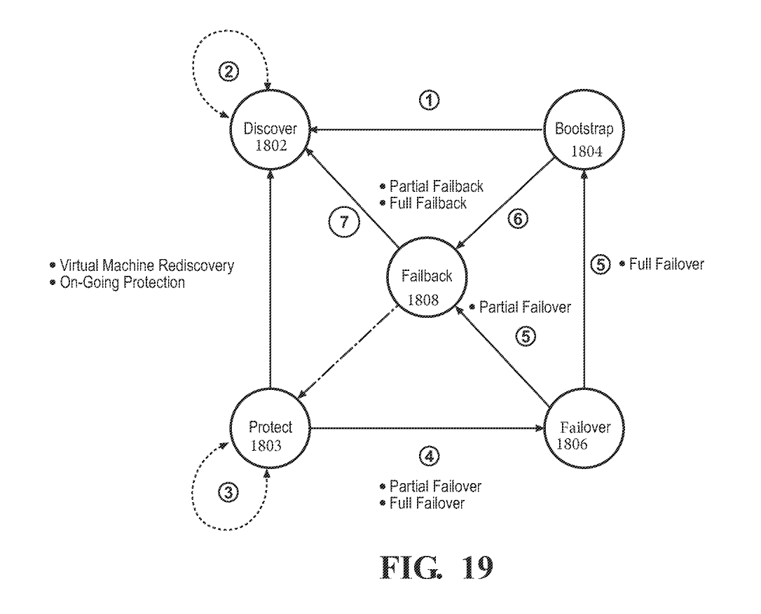

FIG. 19 illustrates exemplary state transitions in a disaster recovery lifecycle for full and partial failover situations. At 1, bootstrap element 1804 acts to install and configure the management platform for disaster recovery, and then perform various bootstrap operations, as described more fully below. Bootstrap processes may include a bootstrap process and an undo bootstrap process. Essentially, bootstrap is a phase in setup that may occur immediately after deployment of the management platform where the setup of the virtual machines on-premise and in the cloud is orchestrated in an automatic fashion.

At 2 of FIG. 19, an on-going discover inventory process is initiated by discover element 1802 to discover VMs, data stores, and switches of an enterprise data center. At 3, an on-going protection process is initiated by protect element 1803, where the disaster recovery plan is formulated, groups are created, VMs are associated, RPOs and RTOs are selected, and other settings may be configured. At 4, the disaster recovery plan is executed by failover element 1806, with a switch into a partial or a full failover mode to continue operations when necessary (and where the primary site for failover operation is the cloud). At 5, after failover, a switch is made to failback mode. In a partial failback situation, a begin failback process by failback element 1808 may include a re-seed/sync phase to final-sync to switch back to the primary on-premise environment. In a full failback operation, a re-bootstrap operation by bootstrap element 1804 on-premise may be required and if so, is performed at 6 before a transition into a failback mode. A partial or a full failover may trigger a re-bootstrap prior to failback, though a re-bootstrap may not be necessary if a partial data center loss does not involve the OCVMs or their dependent infrastructure. At 7, a failback operation is performed, with operations that include re-discover and continue.

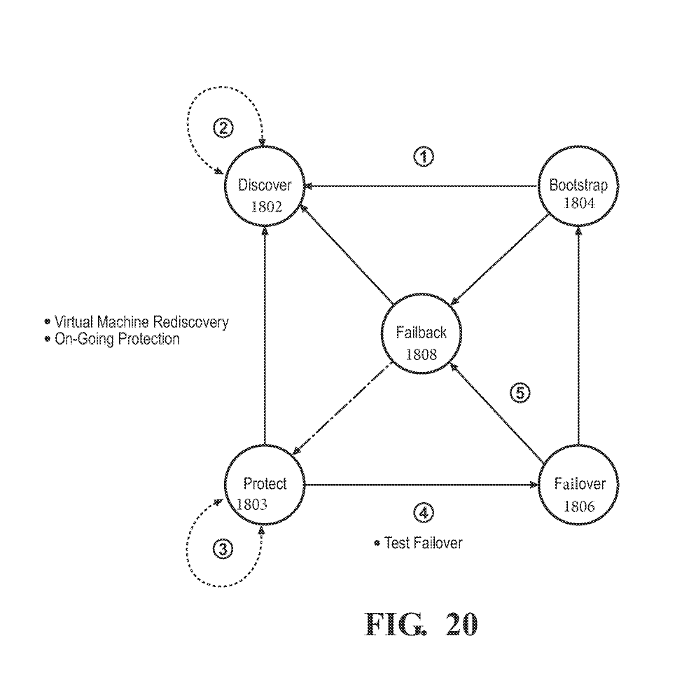

FIG. 20 illustrates exemplary state transitions in a disaster recovery lifecycle for a test failover situation. At 1, the management platform is installed, bootstrapped, and configured. At 2, an on-going discover inventory process is initiated to discover VMs, data stores, and switches. At 3, an on-going protection process is initiated, where the disaster recovery plan is formulated, groups are created, VMs are associated, RPOs and RTOs are selected, and other settings may be configured. At 4, the disaster recovery plan is executed, with a switch into a test failover mode. At 5, after failover, a switch is made to a test failback mode, which includes purge and continue operations.

In embodiments, install phases may include an installation process, a re-installation process, and an uninstall process.

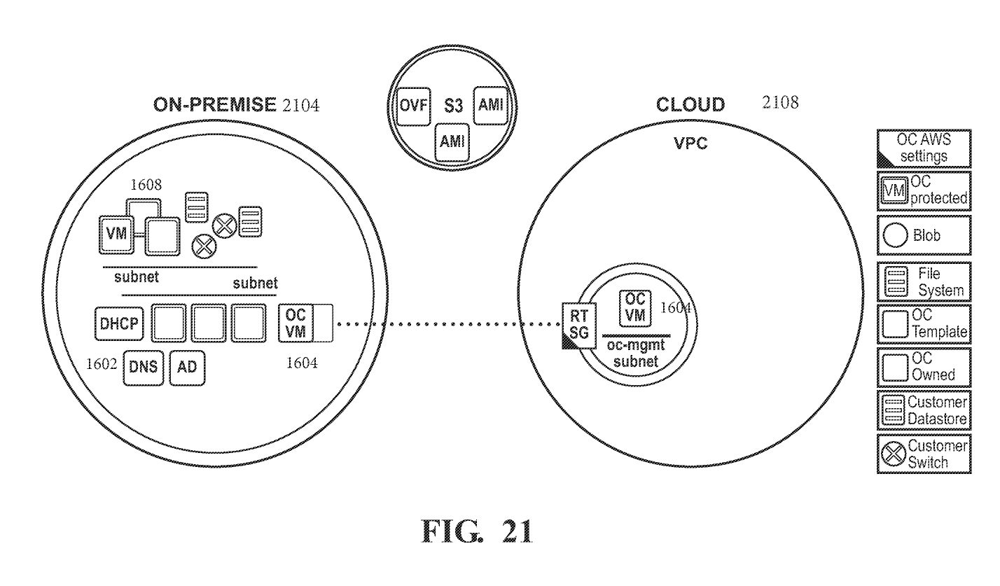

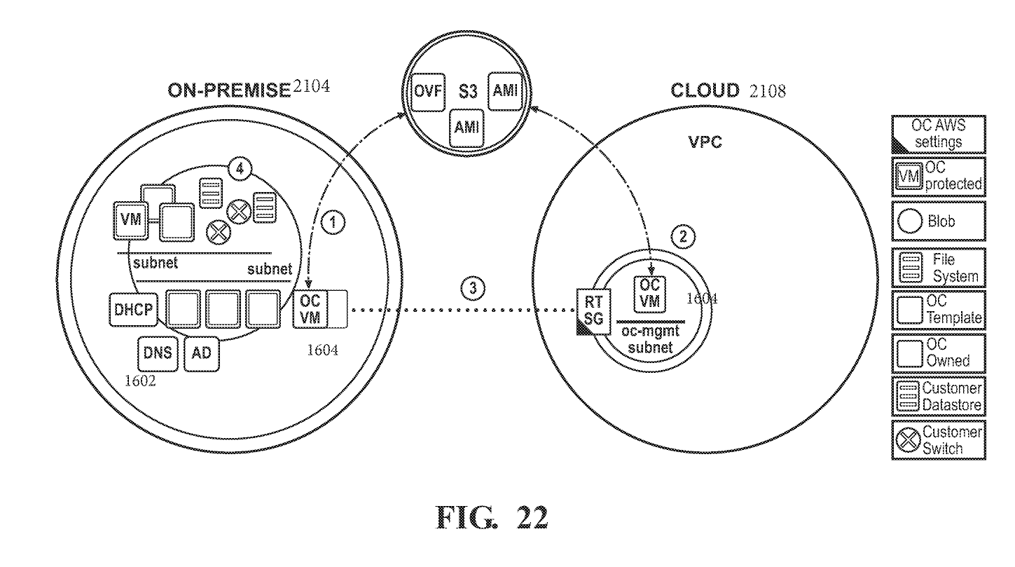

FIG. 21 illustrates a general bootstrap processes, and FIG. 22 illustrates an initial bootstrap process. With respect to these figures, in general, a bootstrap process involves the automatic deployment, creation, and use of on-premise data center 2104 virtual infrastructure. During an initial bootstrap (as shown at 1 in FIG. 22), OCVM 1604 is created, as is a data template VM. On-premise data stores and virtual switches are identified. Cloud infrastructure 2108 is deployed, created and utilized, and OCVM 1604 is installed in the cloud (as shown at 2 in FIG. 22). A secure line is created between the on-premise and cloud gateways (as shown at 3 in FIG. 22). Services performed for an initial bootstrap include initiation of a master-master database replication, protecting the on-premise base gateway OCVM 1604 into the cloud after installation and configuration is complete, and kicking off a first discovery job to collect all inventory including VMs, data stores, and virtual switches. Other services performed include setting up a management user interface between on-premise and cloud infrastructure.

Other bootstrap operations may include: creating a private network in the on premise data center; creating a local prototype data mover attached to the private network; setting up the private network; creating a private network in the cloud; bridging the on premise and cloud private networks; configuring local and remote repositories; creating EBS volumes; grouping EBS volumes to create a repository; for each group, attach the EBS volumes to the gateway and initialize the group.

Thus, in an initial bootstrap process, a virtual machine 1604 is downloaded to an on-premise data center 2104 to set-up the management platform. A re-bootstrap process occurs when a virtual machine is re-downloaded to an on-premise data center after a full or a partial failover or other infrastructure loss to re-synchronize the system for continued operation. A bootstrap undo process as used herein refers to a process wherein on-premise and cloud resources that were created as part of the setup and runtime processes are released.

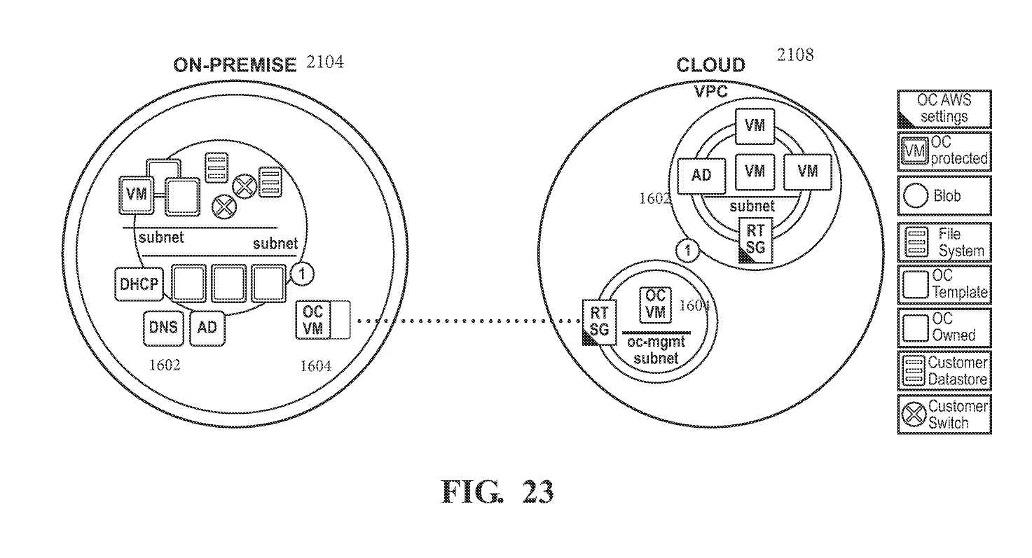

FIG. 23 illustrates in more detail a discovery process with inventory collection. Discovery as used herein refers to the automated process of finding and synchronizing data for all physical and virtual assets 1602, virtual infrastructure, and virtual machines in a customer's environment. This environment can be on-premise 2104 (such as virtualization infrastructure, including but not limited to VMware) and in the cloud 2108 (such as with a customer owned AWS account). Discovery of virtual machines means synchronizing all the metadata around the virtual machines, such as disks, NICs, memory, CPU information, so that the virtual machines may be reconstituted based on this information. Discovery of the virtual infrastructure means synchronizing all the metadata around the infrastructure in the virtual environment, which includes storage, networking, resource pools, etc. Discovery service include connecting to multiple vSphere or AWS accounts and synchronizing the inventory of assets, virtual machines, templates, and virtual infrastructure, such as data stores, virtual switches, virtual networks, disks, etc. Detection of missing instances of assets under platform protection and/or management may also occur, with alerts provided for such missing instances.

The platform may synchronize the discovery of assets within the virtual infrastructure (on-premise and in the cloud), and may automatically identify if assets required to execute the workflows are unavailable, and provide appropriate alerts to the user, or remediate the actions that are inflight. Such “validate” operations may occur at intelligent times, such as: a) when a customer is reconfiguring their VM groups, and b) when protection operations are begun. In the background, the platform infrastructure itself may also be monitored.

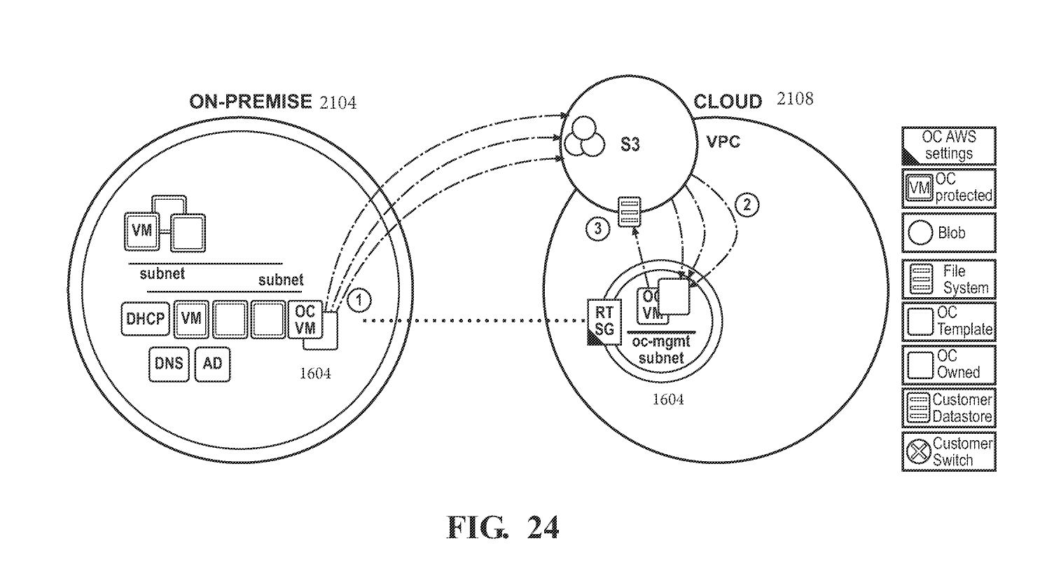

FIG. 24 illustrates a protection process for protecting resources of an enterprise, and the protection process may include user-scheduled protection functions. In general, resources such as VMs may be protected by transporting data to the cloud while being bound by rules such as RPO and bandwidth limits. VM groups may be configured to provide a consistency guarantee between VMs in a group. VM order within a group may be changed for ordered recovery on failover. The platform may permit user-intervention, or conditions relating to infrastructure (e.g., lack of repository space, temporary network outages) to cancel, interrupt, or resume protection jobs. Protection processes are change aware, i.e., all data being protected with be tracked for changes and only changes may be sent to the cloud. Regular status updates may be provided for on-going and scheduled protection processes. Users may author VM groups, and add VMs to a group. In embodiments, VMs cannot be shared between groups, and groups are not recursive. Groups are the unit of protection (and a unit of management failover and failback). Protection is complete when all the VMs in a VM group are persisted into durable cloud storage.

In an example, as shown in FIG. 24, the following processes may occur as part of the management methods and systems described herein: 1. For on-going protection, VMs are protected based on an RPO schedule. Data is sent to cloud storage, such as S3, where S3 is used to buffer data in this phase of protection. 2. At an ingest-phase, on a calculated schedule (such as based on cost optimization in AWS), an EC2 instance is powered-on to read the data from S3 and hydrate a repository, such as an EBS volume. The EBS volume may hold multiple restore points of data. 3. At a snapshot phase after the data is hydrated into a repository, an EBS snapshot is taken to persist the data in durable storage, such as S3.

Protection services provided by the platform may include an ability to tune RPO/RTO pairs based on application protection tiers. A set of VMs (multi-tiered applications) may be protected with the same RPO to provide near consistent data guarantees on application recovery. Data may be protected with compression and encryption in-flight and at-rest during protection workflow executions.

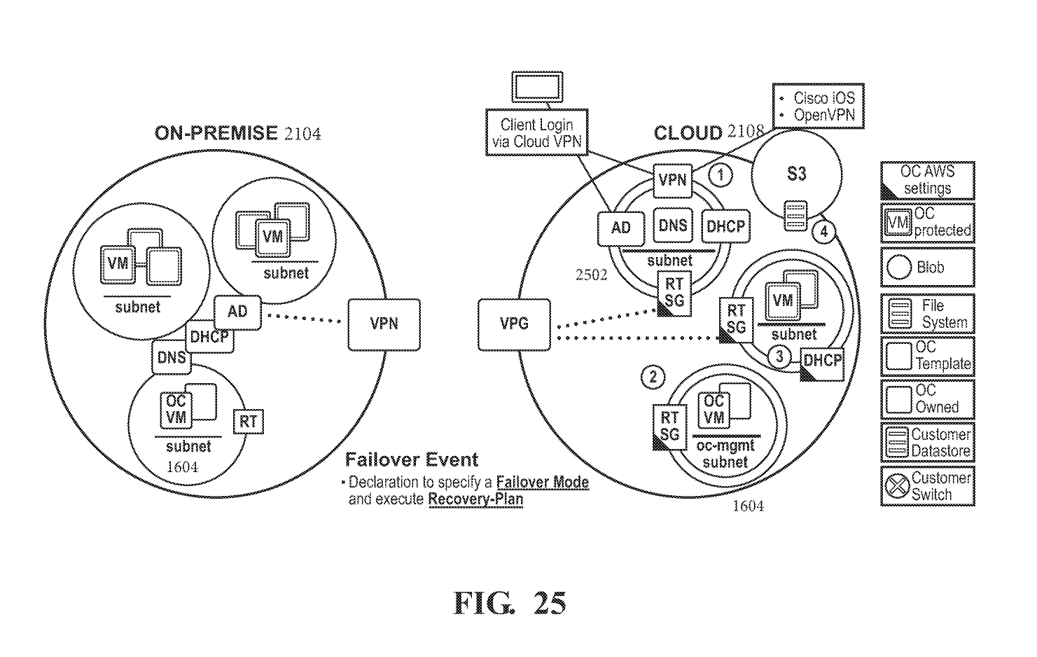

FIGS. 25-29 depict aspects of the management platform that are related to failover. Failover modes supported may include full, partial, and test modes. A failover event is one that is either planned or a failure that otherwise occurs in the on-premise data center 2104 resulting in the need to execute a disaster recovery plan. A partial failure or a prolonged degradation of any elements of the Compute/Storage/Networking (CSN) infrastructure in the data center may constitute a trigger for a failover event. For example, if a customer detects a failure on-premise in an application that is protected by the platform, they may try to recover it locally first (perhaps from a local backup). Assume for this example that this application has an SLA to the customer of 4-6 hours. If the ability to recover the application locally in accordance with the SLA does not appear possible, the customer may declare a failover event for this application, and trigger a failover process to recover the application in the cloud. The customer may specify the failover mode they are in (partial in this example) which executes a corresponding recovery plan for this application.

An example recovery plan for the application in such a case may include the following steps: 1. Configure the infrastructure in the cloud 2108 to house the application to be recovered, which may include VPC, subnets (based on re-ip settings for this application), and appropriate security groups; 2. Execute recovery of the latest recovery point of this application from cloud storage (EC2-Slave+EBS snapshot to EBS+EC2-import) while meeting the desired RTO for this application; and 3. Turn-on failover protection for the application.

More generally, a recovery plan may be considered a set of manual and/or automated infrastructure and service requirements inside the cloud during a failover event. A full or partial set of functions in the recovery plan may be executed based on the failure mode. For full failover, access to all protected VMs may be via cloud infrastructure. For partial failover, access to the protected VMs may be via on-premise infrastructure and/or via cloud infrastructure. In both cases, a full recovery plan may be executed. For test failover, access to some protected VMs may be via on-premise and/or cloud infrastructure, and a partial recovery plan may be executed.

More generally, a failover workflow may include the following, as shown in FIG. 25: At 1, a VPN (virtual private network) is provided to the disaster recovery site 2502 in the cloud 2108, and a connection to the OCVA gateway is made to initiate a failover workflow. Note that site access may be restricted through a pre-configured VPN, which may be manually setup by the user. The VPN to disaster site may also have access to the OCVA gateway restricted through a customer inbound firewall rule, which may be manually turned on during failover. At 2, the failover is executed, which may include specifying a failover mode (a full or a partial non-test mode, or a test mode), and selecting the appropriate VM groups to include in the failover workflow. In a non-test mode, once the failover is complete, an automatic protection of the failed-over VMs is initiated. At 3, a connection is made to the failed-over VMs, to calculate and send deltas to the on-premise environment. The expectation of this re-sync phase is that after successful completion, the on-premise dataset is ready to be rehydrated into the on-premise environment, and no new changes in the cloud will be saved/persisted, i.e., EBS snapshots on the failed-over VMs will end, and the user is free to terminate these VMs in the cloud. (Note that in a test failback mode, the data is re-synced to a clone of the on-premises dataset since the test failback dataset is ephemeral. Adequate on-premise storage resources need to be present for successful test failback.) At 4, VMs are protected by taking scheduled EBS snapshots of failed-over VMs running in the cloud 2108.

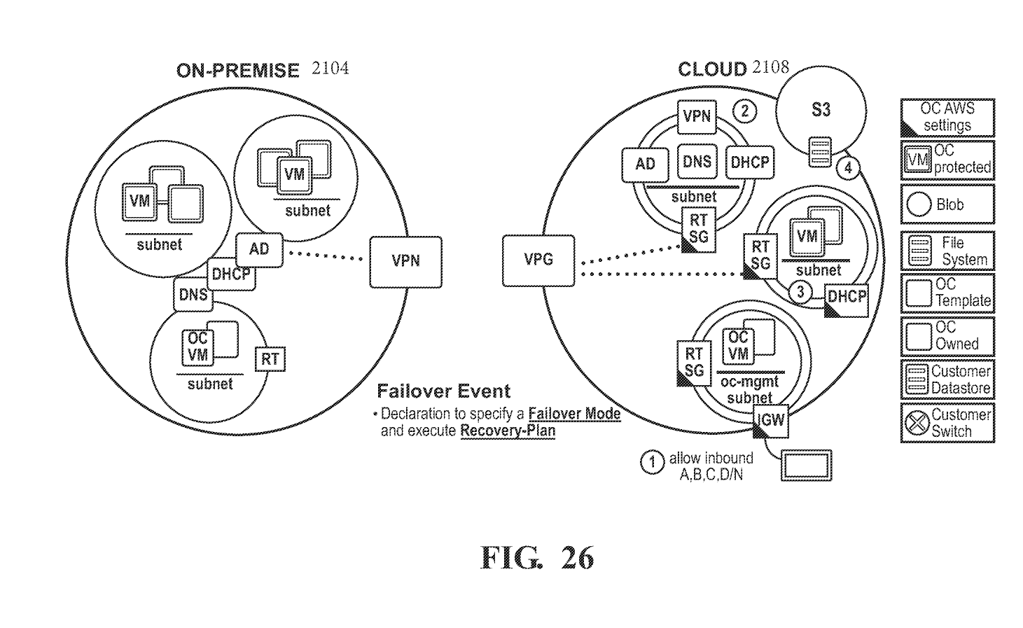

FIG. 26, like FIG. 25, depicts full failover to the cloud. However, in this case, at 1 a custom route may be manually set up in the OC-mgmt-subnet to allow for specific source IP inbound traffic. An elastic IP may be manually assigned to the gateway OCVM. A browser from client to management UI at the elastic IP may be launched, and pre-configured service VMs (VPN, AD, etc.) may be powered on. A user may then login and switch to full failover mode to execute a full recovery plan, such as the same steps 2, 3, and 4 described above with respect to FIG. 25.

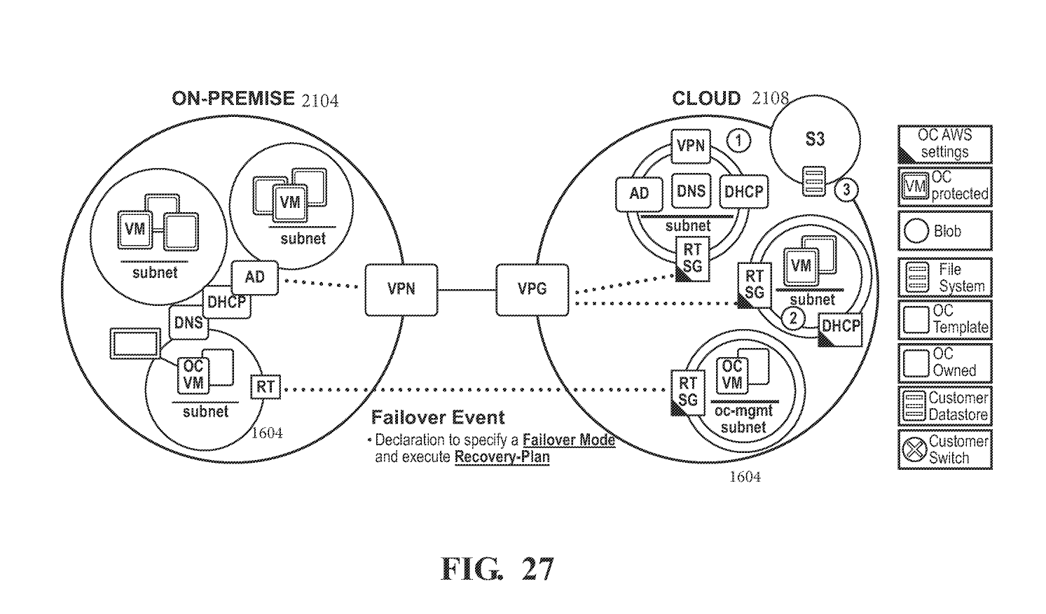

FIG. 27 depicts a partial failover, where access to some protected VMs via on-premise and/or cloud infrastructure needs to be recovered, and a full recovery workflow is provide for those protected VMs. A user may login and switch to partial failover mode to execute a full recovery plan on selected groups. At 1, protection groups to be recovered are selected. An attempt may be made to try to synchronize more local data for recovery, otherwise all recovery points on-premise may be abandoned. At 2, a connection is made to the failed-over VMs, to calculate and send deltas to the on-premises environment. At 3, VMs are protected by taking scheduled EBS snapshots of failed-over VMs running in the cloud 2108.

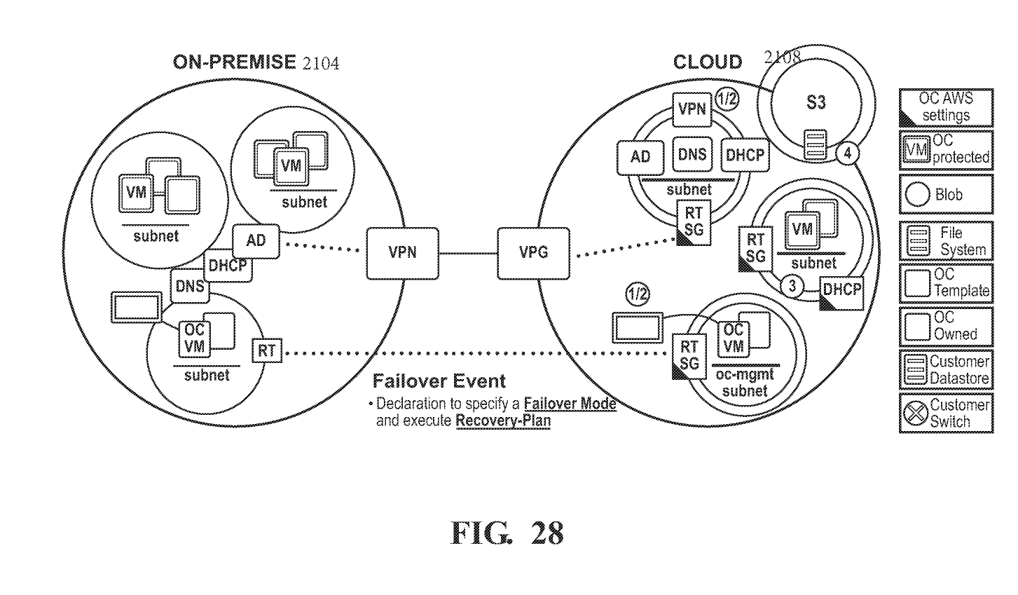

FIG. 28 depicts a test failover. Here, at 1 and 2, protection groups to be recovered are selected. Static IP addresses are setup for recovered VMs in test mode. A user logs in and switches to test failover mode to execute a partial recovery plan on selected groups. At 3, a connection is made to the failed-over VMs, to calculate and send deltas to the on-premises environment. At 4, VMs are protected by taking scheduled EBS snapshots of failed-over VMs running in the cloud 2108.

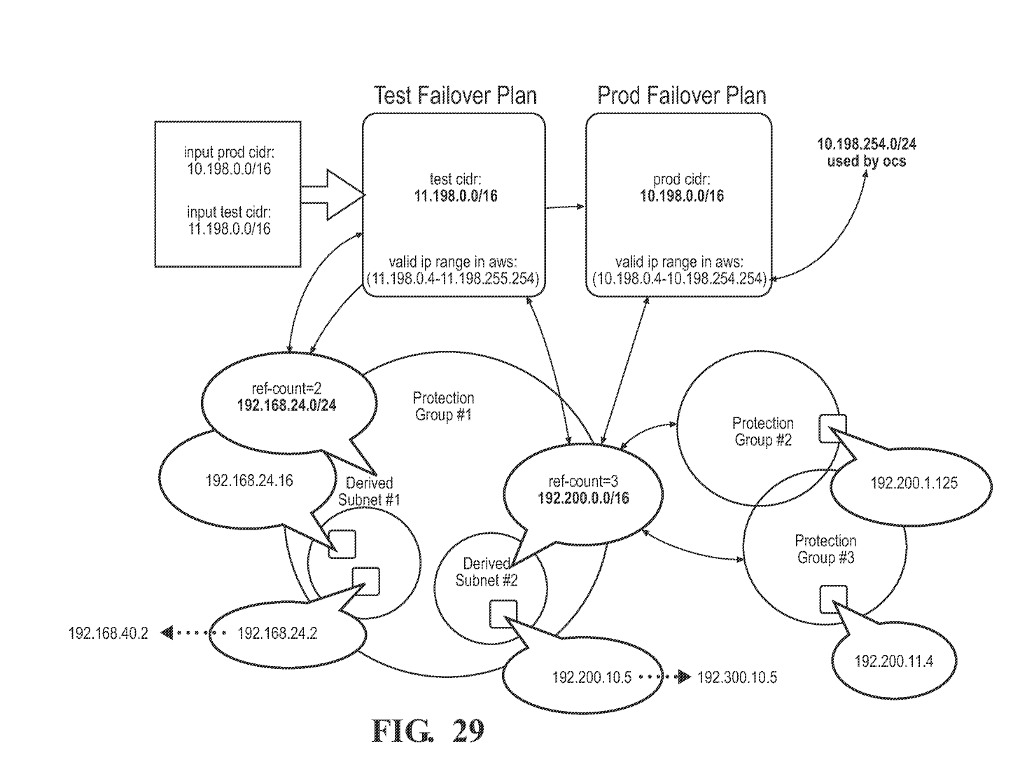

FIG. 29 depicts the way the management platform handles the IP addresses of the corresponding VMs being protected. When a VM is added to a protection group, a backend service may initially determine the source subnet based on the IP address of the host VMs being protected. When actual protections are executed (via the schedule) on these VMs, these derived subnets are validated/updated in the global failover plans (test vs. production). The failover plan may determine IP address mapping rules for the VMs in the event of a failover execution. The requirement for failover may be that IP addresses are distinct and separate for the test vs. production failed-over VMs from the on-premise production systems. This mitigates any network conflicts that may arise in the event of failover and the on-premise and cloud sites are connected.

Note that AWS limitations in address mapping may also be handled. Amazon AWS VPC's have a limitation of supporting only Class B range addresses. This means that any subnets created in the VPC must be with the Class B to Class C address of the VPC/Subnet. If on-premise protected VMs have an IP in a Class A (/8 CIDR) network, they will have to be mapped (flattened) into a Class B/C range of addresses.

Failover plans (test vs. production) are in an ‘incomplete’ state by default. With reference to FIG. 29, once VMs are added to protection groups, as noted above, the ‘source’ subnet may be derived by the system backend. In the above example, 2 VMs are added to protection group #1. The system derives the subnet 192.168.24.0/24 based on the IPs of the VMs. A second subnet (192.200.0.0/16) is derived based on other VMs being added to the same or different groups. The plans are still ‘incomplete’.

Two distinct Class B network addresses may be available for failover in the system, based on user input during a bootstrap process. The user may need to allocate ‘target’ subnets to map to the source subnets to complete the failover plan. As long as a derived source subnet has a mapping rule to a defined target subnet, the VMs w/ that source subnet may be eligible to be failed-over. VMs without target subnet mappings may not be eligible for failover.

Since IP addresses for source VMs can change between protections, the management platform validates the ‘derived’ subnets in the failover plan prior to each protection run. If new subnets are derived, the platform adds these new subnets to each plan awaiting completion by the user. The platform monitors the subnets, determines if the subnets in the plans are invalid based on changes of the underlying VMs, and appropriately adjusts the plans. The platform alerts the user when these changes occur.

Failback refers to the process of restoring a set of resources to its original state in its original location, and may be a user-initiated function of the platform. In general, this means bringing a set of protected resources, such as VMs with associated disks and NIC configurations, from its backed up copy at a remote site back to the primary site. Failback may also have three different modes: full, partial, and test failback. Full group failback refers to the orchestrated restore of all protected VM groups in an appropriate order back to the primary site. Individual group failback refers to the orchestrated restore of some protected VM groups in appropriate order back to the primary site. Test failback refers to the ability to achieve ‘real’ failback with test or real VMs.

The goal of failback is to get the on-premise environment back up to an operational state as soon as possible. The platform may enable selection of individual VM groups for failback to the on-premise environment. This gives the user control over the ordered restore of VMs back into their on-premise environment. Failback goes through discrete phases that are made available to the user so that constant feedback is available for this long-running job. It is expected that infrastructure resources could be different during failback and discovery will identify any conflicts to allow user feedback to select how failback will be accomplished.

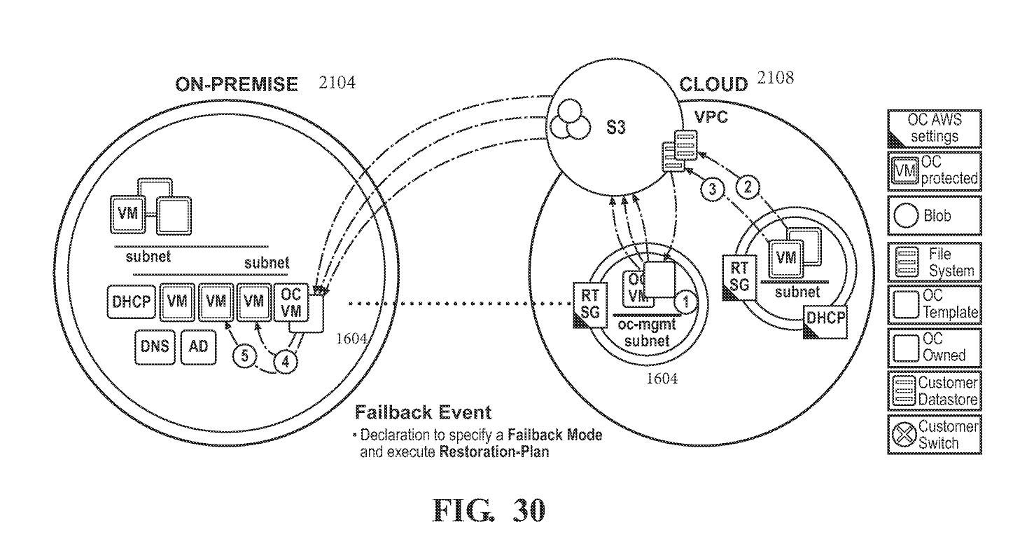

Referring to FIG. 30, a failback workflow may include the following: At 1, a discover-resync process occurs, which includes steps for getting the on-premise and cloud repositories back to a common sync point before re-transmitting new data deltas from the cloud. Once the on-premise environment is back up (re-bootstrap), the cloud OCVM 1604 discovers the sync point with the on-premise OCVM 1604. This tells the cloud OCVM which deltas to schedule to transfer to the on-premise OCVM. For example, if the on-premise site was restored from a full-site failure, the on-premise data store managed by the on-premise OCVM repository might be empty, and a full sync would be necessary to failback. If there was a partial failure, then the data store on-premise managed by the OCVM might have a sync point prior to the failure, and the cloud OCVA would only need to schedule transfer or new deltas.

At 2, a delta-resync process occurs, which includes steps of calculating and sending the deltas between the current running state of VMs in the cloud and the initial recovery point in the cloud back to the on-premise environment. For example, once a VM is failed-over in the cloud, and is in a running state, changes to the VM are available in EBS snapshots that represent point-in-time snapshots of the data being committed to the disks of the VM. A delta-resync takes these changes and transmits them back to the on-premise environment to re-synchronize the dataset between the two locations. The delta-resync phase may be on going, i.e., scheduled periodically to bring the on-premise dataset to a common-sync point with the cloud dataset.

At 3, a final-resync process or planned outage phase occurs, wherein control of VMs is moved back to the on-premise environment for the group, and a power-off/stop the group step occurs in the cloud. This is the final phase of calculating and sending deltas to the on-premise environment. The expectation of this resync phase is that, after successful completion, the on-premise dataset is ready to be rehydrated into the on-premise environment, and no new changes in the cloud will be saved/persisted, i.e. EBS snapshots on the failed-over machines will end, and the user is free to terminate these VMs in the cloud (which is recommended after the group-restore is complete).

At 4, a group rehydrate process (from a retention point) occurs, which refers to an on-premise phase of failback where the dataset from the OCVA managed repositories are copied into the VMs on-premise that need to be restored. The expectation is that the data on the source VMs on-premise will be overwritten. Once completed, this step cannot be reverted. In a test failback mode, a new set of disks/VMs are rehydrated on-premise. The user can pick a retention point to rehydrate the group (based on pulling all the retention points approximately five days from the cloud. Note that adequate on-premise storage resources would need to be present for successful test failback. Network resources are not connected.

At 5, a group restore process occurs, which refers to the on-premise phase of failback where the groups of VMs that have been rehydrated are powered back on. Once this phase is successfully completed, DR protections can continue on these VMs.

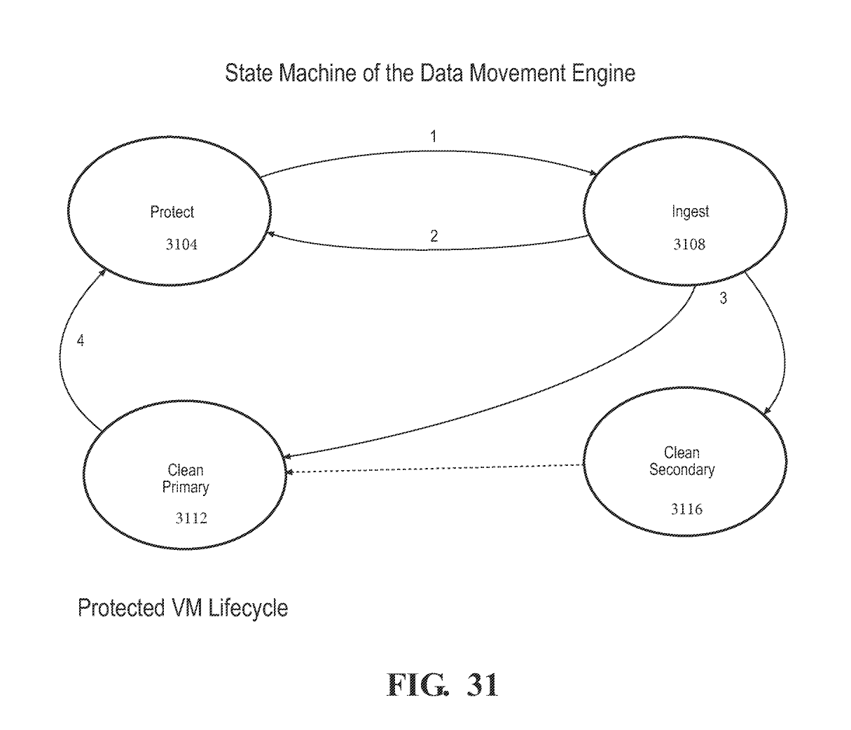

FIGS. 31-36 depict schematics of data movement.

FIG. 31 illustrates various states/elements of a data movement engine, which may include protect state 3104, ingest state 3108, clean secondary state 3116, and clean primary state 3112. In particular, a high level process for moving contents of a disk between data centers may include the following: At a protect state, the raw data may be pulled from a source disk (e.g., VMware via the VDDK—virtual disk development kit), and stored in an on-cloud repository. Each time a pull operation is performed from a source, a new version/snapshot of the data is created. Then at 1, after the pull operation, a push operation may occur to push the data to a remote datacenter, using for example, S3 as a buffer. At 2, an ingest state, the remote data may pull data from the S3 buffer and store it in its local repository, creating a mirror of the version/snapshot that was created on the peer data center. At 3 and 4, after the version/snapshot exists in both data centers, the S3 buffer may be cleaned, and any older data versions that are not longer required may also be cleaned.

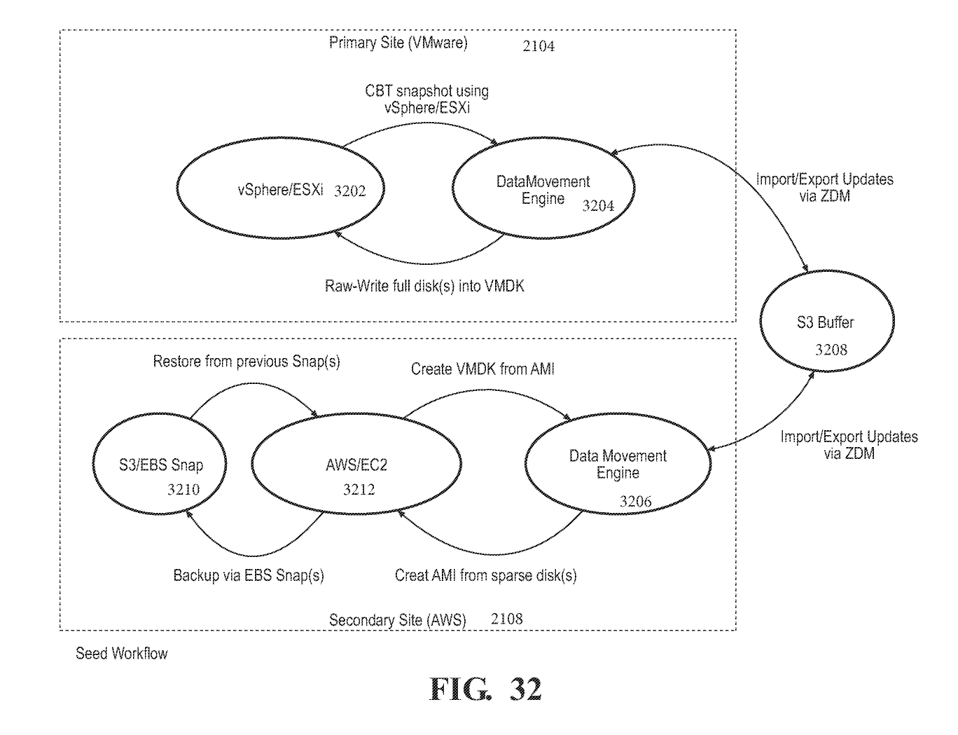

FIG. 32 illustrates high level steps that may be used to move data between a primary site 2104 running VMware (vSphere 3202) and a secondary site 2108 utilizing an AWS data center 3212. In embodiments, VMware's snapshot and change block tracking (CBT) technology may be utilized to efficiently pull data directly from ESXi (VMware hypervisor) using VMware's VDDK. A data movement engine 3204 may be composed of three components to accomplish this. The orchestration of the snapshot and CBTs may be performed within a control plane. The actual copying of bits from ESXi may be performed via VMWare's VDDK. The copied bits may be stored on a local repository, which may be constructed using ZFS. Using these components, a series of change points for a virtual machine may be maintained. A series of change points is a versioned copy of all the disks attached to a virtual machine. Change points may be moved from a local data center repository by way of S3.

Specifically, S3 may be used as a durable temporary store where the change points may be streamed. The data movement engine 3204 may be capable of concurrently pulling data from the source VM while streaming data to the S3 buffer 3208. In the same way that change points may be pushed to the S3 buffer 3208, the data movement engine may pull a change point from the S3 buffer 3208 and store it in the local repository. Additionally, a VM may be stored from a change point. In addition to the data within a VM's disk, a change point may track the relevant configuration of a virtual machine. The control plane may use the change point to reconfigure the VM so it looks as it did when the change point was created. The data mover may then use the VDDK to overwrite each disk with data from the repository.

At a high level, the AWS site may operate in a similar manner to the corresponding vSphere site, with a data movement engine 3206 which imports and exports updates via ZDM to the S3 buffer 3208. Two differences may exist: a first one relating to how the underlying disks are managed. In vSphere, the underlying disks (VMDKs) are assumed to be durable. AWS disks (EBS volumes 3210) are not explicitly non-durable. Further, the AWS copy may be the one relied upon if the vSphere site is lost. EBS snapshots may be used to address durability. Each time a repository is unmounted, a snapshot may be taken of the volume, which guarantees durability. As a cost saving measure, the EBS volume may be removed after the snapshot is successful. When the repository is again mounted, the EBS snapshot may be converted back into a volume.

A second difference relates to how a virtual machine is restored/created from the change point in the repository. In vSphere, disks are directly created using the VDDK. In AWS, a VMDK may be exported from the repository, which may then be converted into an Amazon machine instance (an AWS virtual machine). The intermedia VMDK form may be used because an Amazon tool may be used to perform the conversion, although it may be possible to perform the conversion directly from a change point.

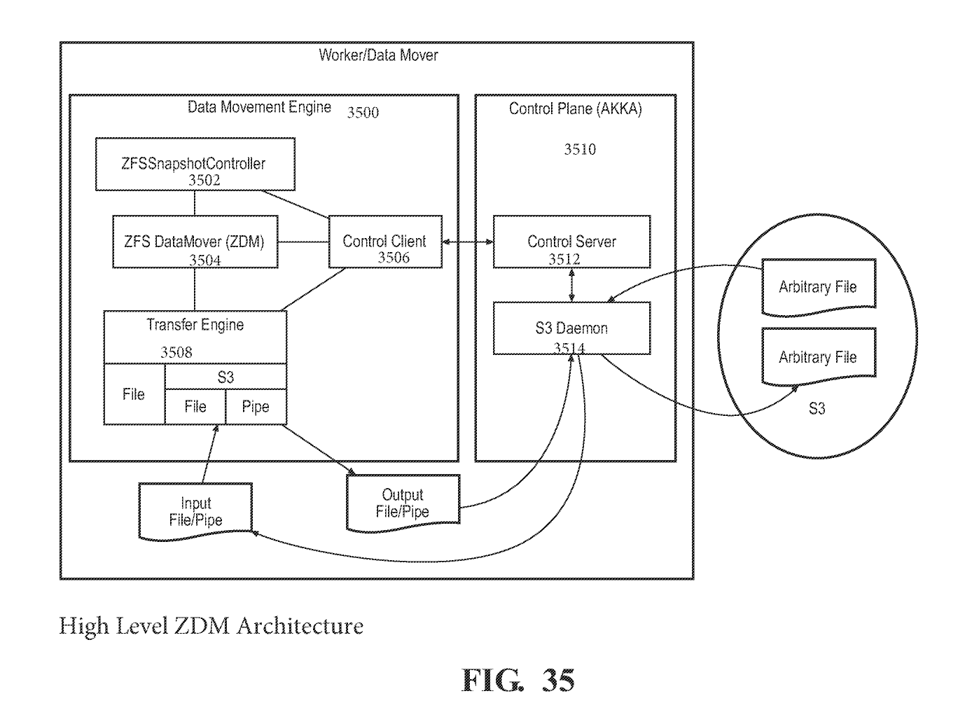

FIG. 35 illustrates a high level ZFS data mover (ZDM) architecture. A data movement engine (DME) 3500 may be composed of four main components: a ZFS snapshot controller 3502, a ZFS Data mover (ZDM) 3504, a transfer engine 3508, and a control client 3506. The DME 3500 may not directly communicate with S3. All S3 operations may be done via a S3 daemon 3514 that may be embedded in the control plane 3510 with control server 3512, as a separate Java process. A new DME may be spawned to backup each disk, but there may only be one single S3 daemon.

With respect to the ZFS snapshot controller 3502, as data is streamed from a source VM disk, the snapshot controller may issue incremental snapshots. These incremental snapshots, or chunks, may then be handed over to the ZDM, which may manage their transmission to S3. The snapshot controller may maintain metadata to know which chunks are persisted in S3. The controller 3502 may store this metadata in S3 after all chunks have been transferred, or if the controller receives a stop request. If all the chunks are move to S3, then the controller may mark the change point as complete. When data is moved from S3 to the repository (ingest), the snapshot controller may stitch all of the chunks together to form the original change point.

With respect to the ZFS data mover 3504, the ZDM may be responsible for compressing and check summing each data chunk before handing it over to be transferred to S3 via the transfer engine. In the reverse direction, the ZDM may verify checksums and decompress data that may be streamed from the transfer engine.

The transfer engine may be responsible for coordinating the transfer of chunks to and from S3 using the S3 daemon. The S3 daemon may be able to upload files that are on the file system or read from pipes, and may also be able to download files from S3 to regular files or to pipes. The transfer engine may use the control client to set up the transfer and specify where the daemon should read to send to S3 or write that data that is read from S3. The transfer engine may monitor the S3 daemon progress and notify the snapshot controller via the SDM when the chunk has been transferred.

The control client 3506 may manage all communication to the control plane. In addition to the S3 daemon, the control plan may contain a telemetry server and a lock manager.

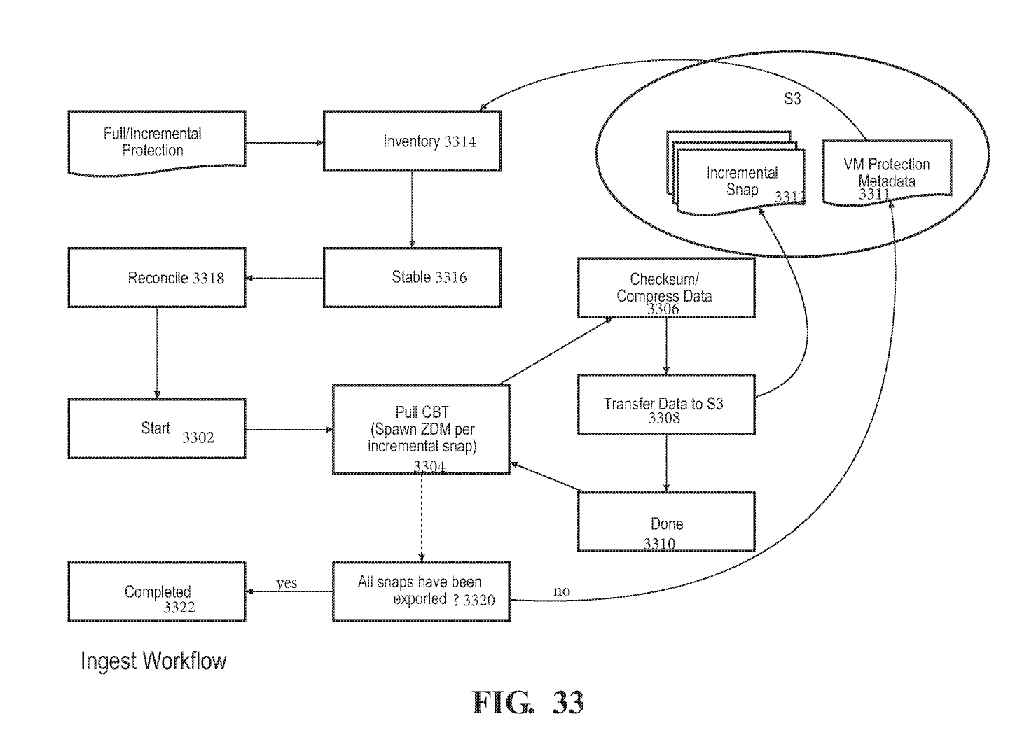

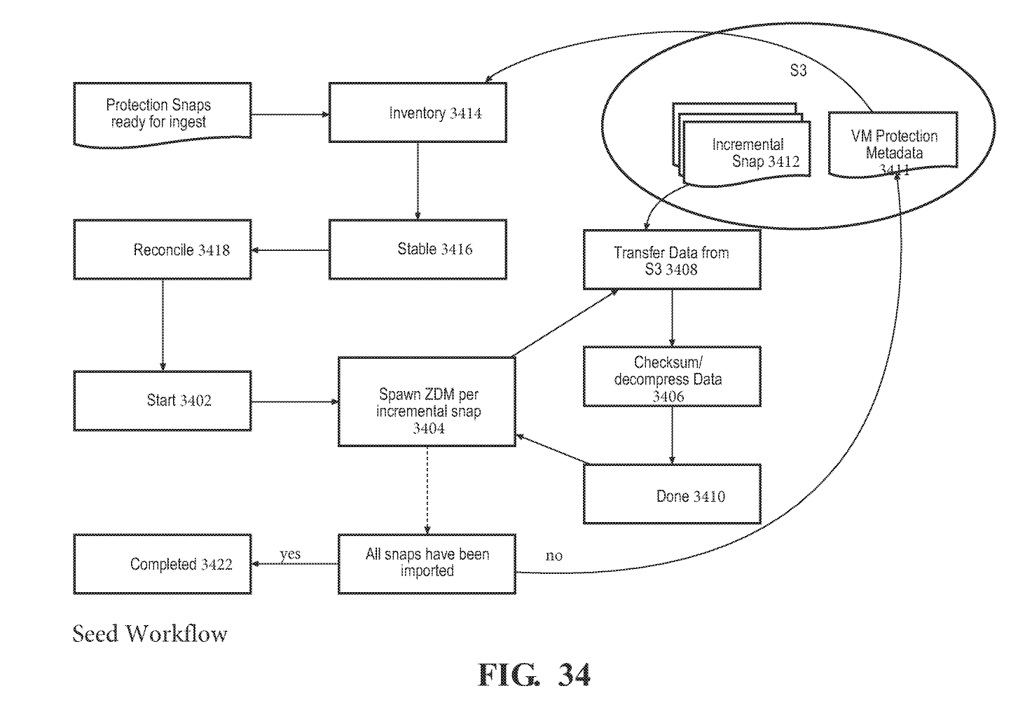

FIG. 33 depicts an ingest workflow and FIG. 34 depicts a seed workflow. An important feature of the DME is that a protection or ingest process may be stopped and resumed at a later time. For FIG. 33, the ingest workflow, the process starts at 3302. At 3304, CBTs are pulled and a ZDM per incremental snap is spawned. At 3306, checksum/compress operations are performed on the data. At 3308, data is transferred to S3, and at 3312 an incremental snap is obtained. The data transfer is complete at 3310. At 3320, a determination is made whether all snaps have been exported. If not, VM protection of metadata occurs in S3 at 3311, inventory is taken at 3314, stability is determined at 3316, and a reconciliation is performed at 3318. If all snaps have been exported, the workflow is complete at 3322. The seed workflow follows a similar process.

FIG. 34 depicts a seed workflow, where the process starts at 3402. At 3404, a ZDM per incremental snap is spawned. At 3408, data is received from S3. At 3406, checksum/compress operations are performed on the data. At 3412 an incremental snap is obtained. The data transfer is complete at 3410. At 3420, a determination is made whether all snaps have been imported. If not, VM protection of metadata occurs in S3 at 3311, inventory is obtained at 3414, stability is determined at 3416, and a reconciliation is performed at 3418. If all snaps have been exported, the workflow is complete at 3422.

In both the seed and ingest workflows, the DME fetches the metadata from S3 for the disk in question. Using the metadata, the DME may inventory the change point on disk and the associated chunks to create a new plan during the stable and reconciliation phases. If a valid plan cannot be constructed, the DME may abandon the metadata and restart the seed or ingest process. Once the seed or ingest process is complete, the DME may delete the manifest and clean off any chunk data S3.

The ZDM subsystem may be built modularly. The ZDM may be composed of a pipe of small steps that can be re-ordered to perform either an ingest or seed process. The same codes may be used to compress the data chunks during a seed that are used to decompress those chunks during an ingest process. There may be many ZDMs operating in parallel.

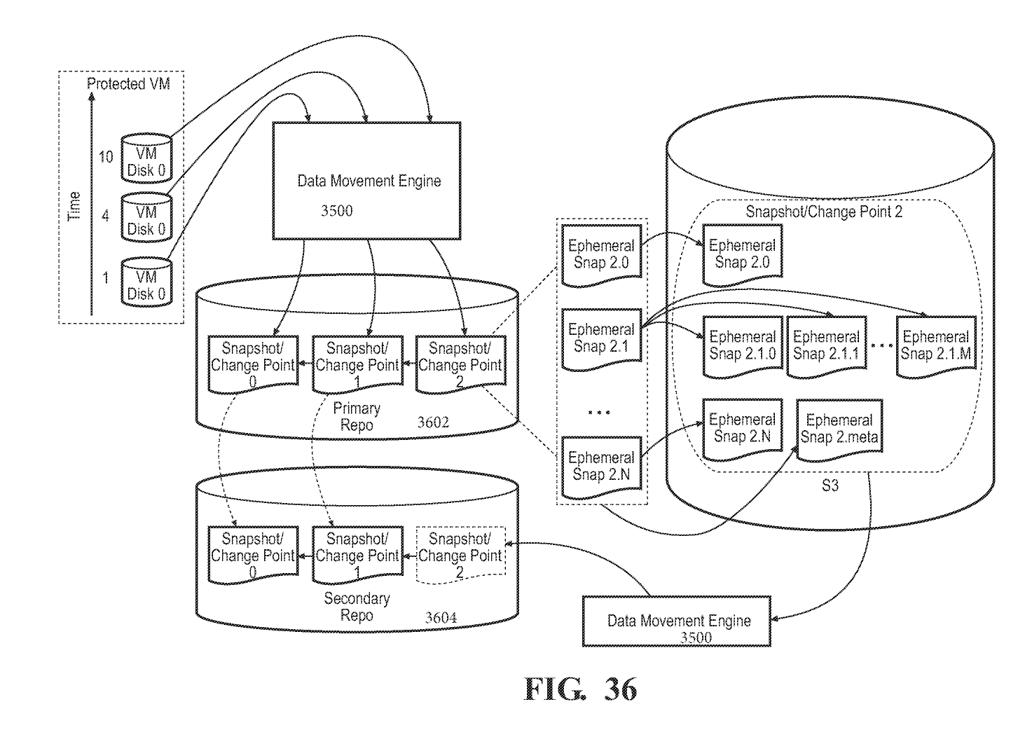

FIG. 36 relates to protection/recovery data flow, and a file name scheme. Each change point for a disk may be linked to the previous change point within a repository because change points may be stored as deltas. Change point 1 may only store differences in disk 0 that were made after change point 0 was taken. The goal of the data movement engine 3500 is to synchronize change points in the primary repository 3602 with change points in the secondary repository 3604. The first change point thus may contain the entire disk and be very large. Subsequent change points are usually much smaller, but that may not always be the case. In order to extract parallelism while transferring change points from one repository to another, the change points may be decomposed into small data chunks. As the original change point is read in, the repository may take ephemeral snapshots using a timed trigger. As such, these snapshots may be of differing sizes. These ephemeral snapshots may be managed by the data movement engine 3500 and their processing may be handled by the ZDM. The ZDM may then chunk each ephemeral snapshot into small data pieces which may then be processed and moved to S3 for ingestion.

Movement of data may occur via jobs, which are not necessarily stand-alone entities. As defined in an API for the management platform, the job class may share a relationship with the job execution class in that the job identifies the notion of work to be done, while the job execution tracks an attempt to complete that work. A job may be analogous to a chore, or some work that might have a regular cadence, and there may be a first job execution to acknowledge such a chore has previously been performed a first predetermined time ago, and a second job execution to acknowledge the chore has been performed a second predetermined time ago.

Job executions may relate to job management. In one embodiment, a messaging system, such as a Redis pub-sub messaging system, may be used to broadcast status messages. However, these messages are typically transitory and there may not be persistence to durably record information related to the success or failure of the execution. It is therefore natural that, in order to provide auditability, job executions are introduced. Their presence also simplifies the expectations of a job class by relieving it of the responsibility for providing history Akka actors may be leveraged to extend the workflow. An actor model-friendly approach to a job management framework that adopts common Akka conventions and patterns may be utilized in the management platform.

In embodiments, the concept of supervision in Akka may be employed. For example, there may be an actor, S, that has created any number of child actors (1-5). S may then be the acting supervisor of these children. Through its configuration, S will have “supervisor strategies” to guide how it handles a failure from any of its children, which allows the platform to localize, and customize, error handling. For example, the platform may handle the failure of a remote-copy operation differently from a null pointer exception. Actor supervision may also cascade, so if S does not know how to handle a given failure, or chooses not to handle the failure, it can pass that responsibility to its parent actor.

Common strategies include attempting a certain number of retries, ignore-and-continue, restarting the actor, or terminating the actor. Restarting or terminating an actor may cascade to impact all children of that actor.

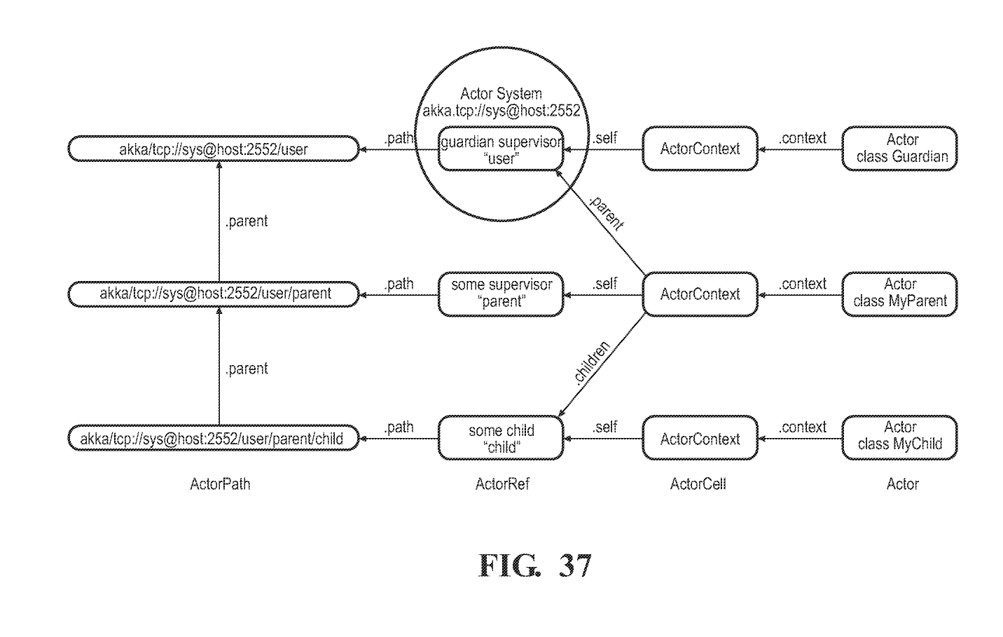

With reference to FIG. 37, the platform incorporates the concepts of actors, actor cells, actor references and paths. In short, actor paths are like a file system rooted at /user. Jobs exist as part of the data model. An Akka actor is part of the processing/Akka framework Akka is bound to the model via @JobActor annotations. When an Akka actor is decorated with @JobActor, it signifies that actor is the primary controller for jobs of that class.

With respect to a desired job management actor model, various models may be implemented. In one embodiment, a workflow for initiating a job may include:

1. Quartz invokes the (old) job.

2. A new actor, specific to and identified by that job, is created.

3. A message is sent to the new actor.

4. The actor creates and/or messages other actors, as necessary.

5. The actor provides regular updates via Redis pubsub.

6. The actor responds to the job with its own message (e.g., backup complete).

7. The actor is stopped.

In another embodiment, which is a variant of the above, the following changes may be implemented:

1. Quartz is replaced by Akka's Scheduler.

2. A job-specific actor is identified by the actor, instead of the job.

3. Redis is replaced by Cassandra.

4. Dependency injection is replaced by actor paths or child actors.

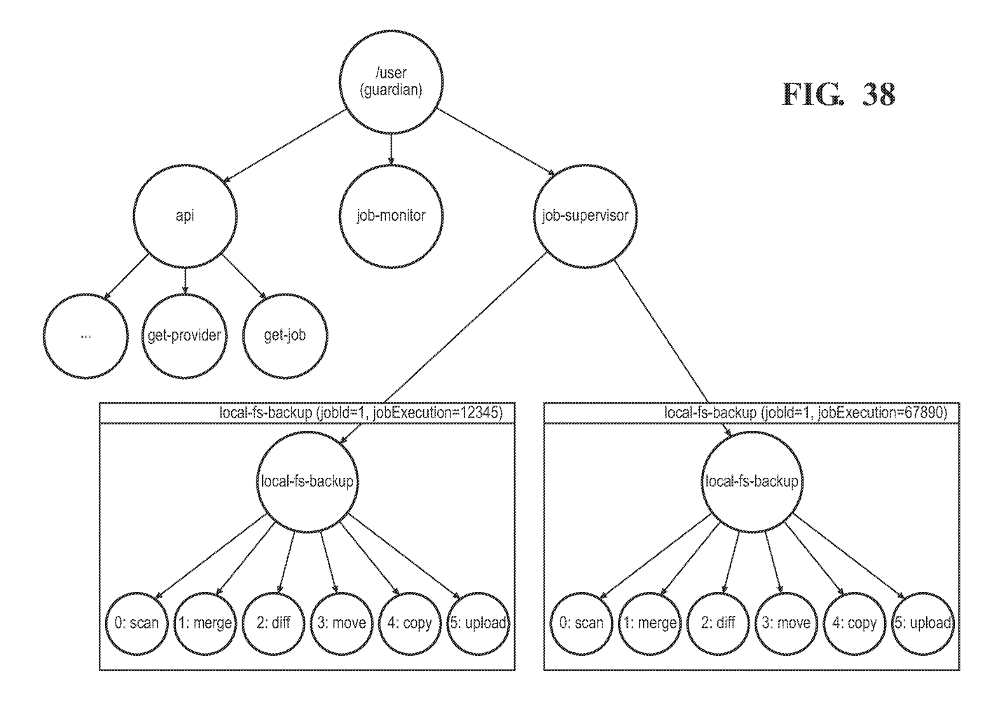

FIG. 38 illustrates an example workflow for job actors and execution. In this model, certain stateless actors, such as those expected to perform CRUD (create, read, update, delete) operations, will statically exist at known actor paths. This will simplify actor creation to require fewer arguments, thus increasing usability throughout the actor model.

Similar to the previous model, an execution of a job may spawn a responsible actor (and its children). This ephemeral actor group's state will reflect only that execution of the job, thus simplifying all operations related to acquiring, merging, and processing data related to that execution. The localization of processing eliminates the need to track different executions through a shared actor. After the execution completes, the actor group will be stopped. This actor group provides the additional benefit that, in response to an execution being disabled (e.g., cancelled), the entire actor group can be stopped without impacting other executions.

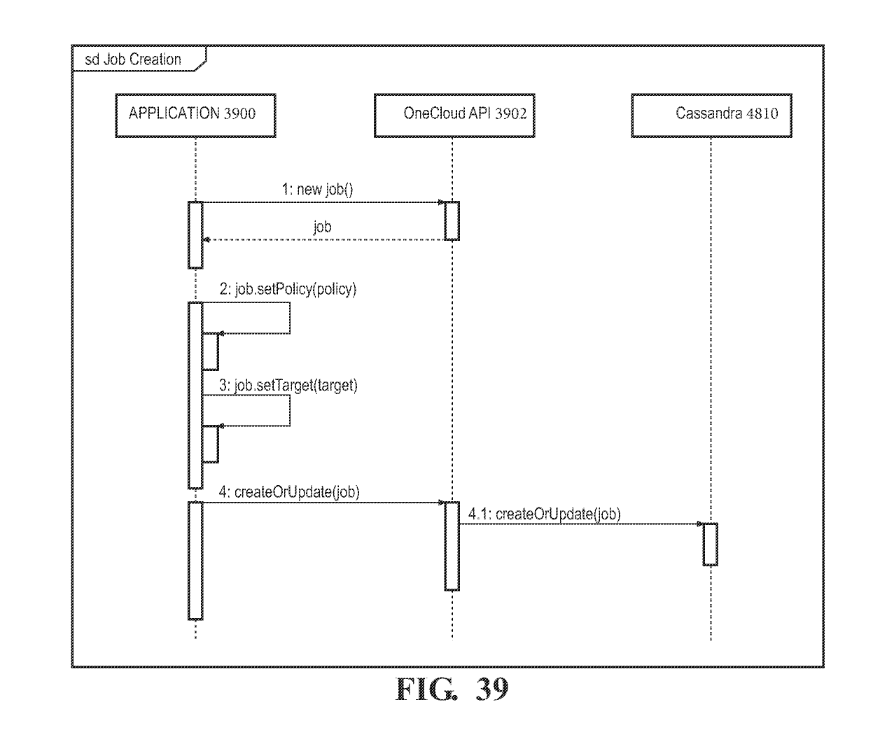

Referring to FIG. 39, with respect to job creation, before a job can be invoked, it must first be created. This is a process that may be independent of Akka An application 3900 may use the API 3902 to create or update, then persist the job instance. At 1, a new job is identified. At 2, policy is set for job, and at 3, a target is set for the job. At 4, the job is created or updated to a Cassandra 4810. This process may be possible via direct use of the API 3902, or indirectly via REST. In an embodiment, there may be no additional step to schedule the job, that responsibility may be purposefully decoupled to leverage the distributed, elastic nature of the clusters and the possibility that sites may not be online.

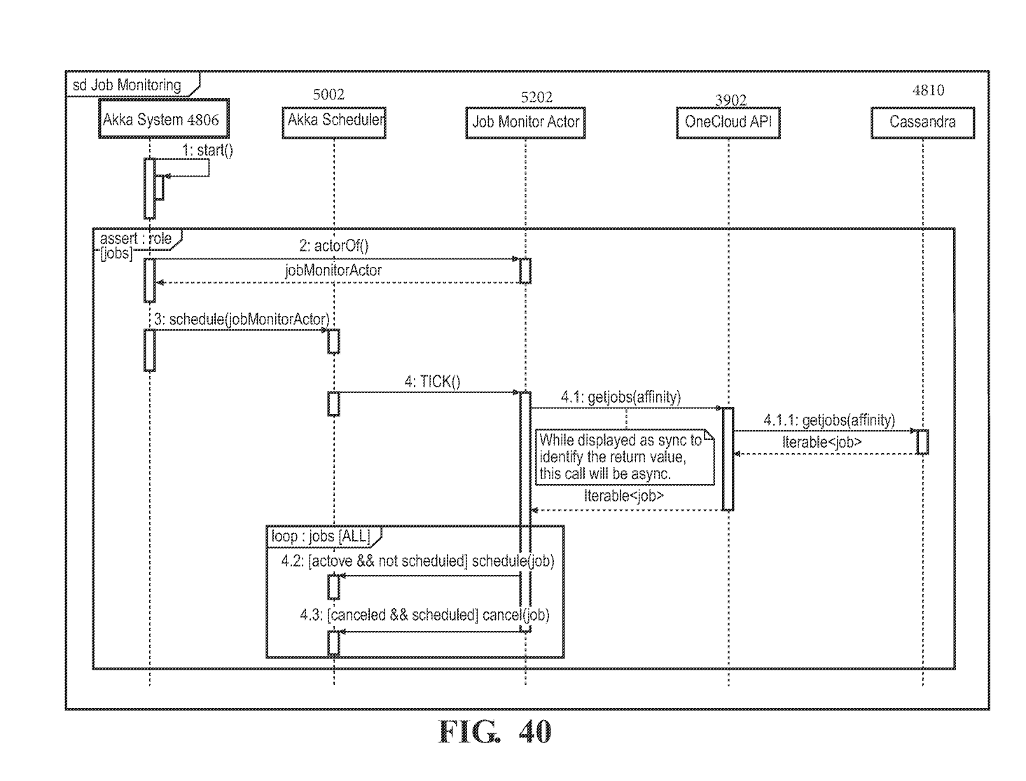

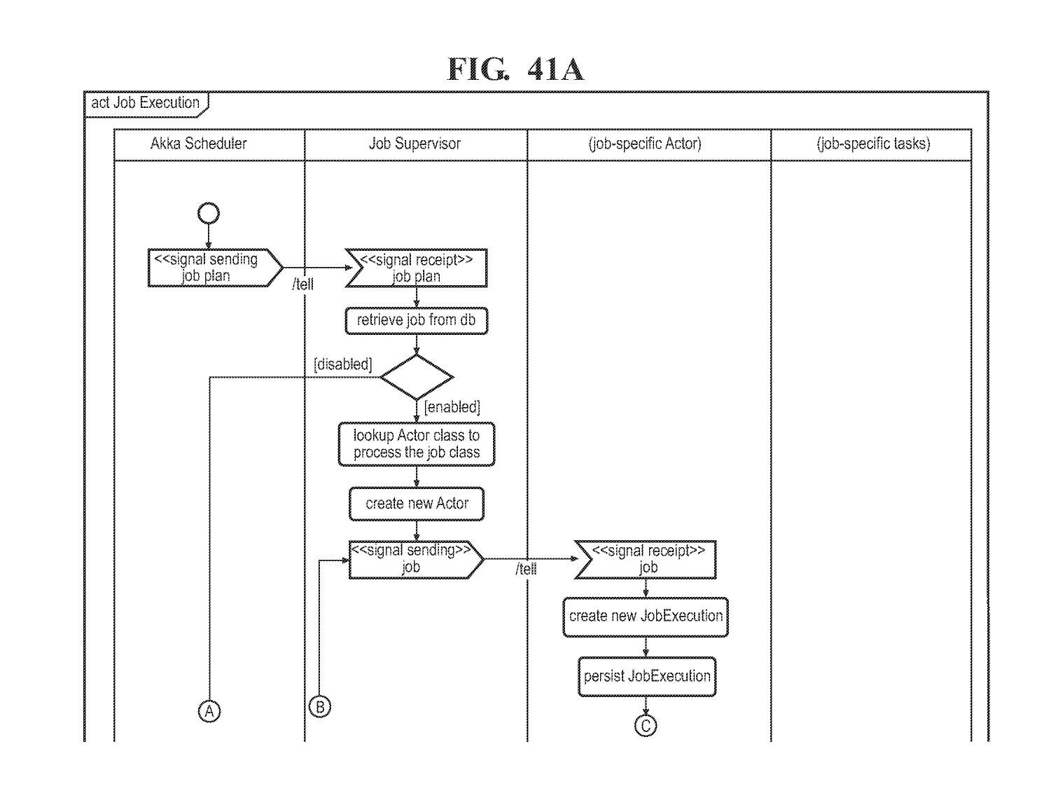

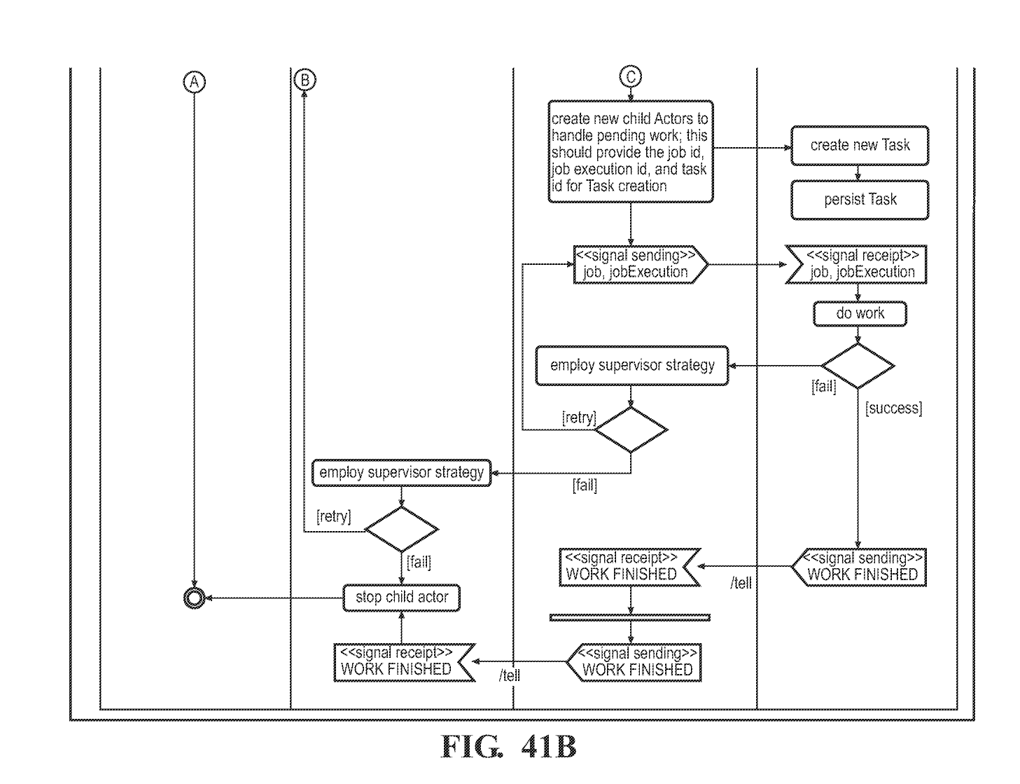

Referring to FIGS. 40, and 41A-B, once persisted, a job monitor actor 5202 may act to asynchronously identify the new job from the Akka system 4806 and schedule it via Akka scheduler 5002. The job monitor actor 5202 may comprise a site-aware process that uses affinity to filter and only process jobs relevant to its site. This actor may also identify when jobs are disabled (e.g., cancelled) and may unschedule them. Because a delay exists between a job being scheduled and a supervisor being invoked, there is no guarantee that a job will be enabled. To counter this, the supervisor may perform due diligence and retrieve the job itself. This may confer additional benefits that the inbound message be in an immutable jobID String, and also eliminate concurrency concerns by reducing the locality of the retrieved job object to just the actor group. The actor is responsible for creating the new job execution. This may provide the actor control over which subclass to create (e.g., a durable job execution). The actor may also be responsible for creating, and orchestrating the interaction with any child or stateless actors to perform its work.

Child actors should be as stateless, and reusable, as possible. Reuse is pivotal to support a growing ecosystem of jobs. This class may also be responsible for creating and persisting the appropriate task.

To best leverage a persistence layer, it helps to understand several aspects of the data to be persisted: what that data is, how it relates to other data elements, and the expected queries that will operate against that data. These factors can influence schema design—for example, relational tables and (de)normalization strategies that both simplify retrieval queries and make mutations (i.e., create, update) more idempotent. In a distributed, eventually-consistent system, idempotent operations are favorable because they can allow for non-blocking persistence that avoids last-write-wins conflict resolutions.

### TERMINOLOGY

Asset: an element that is interesting to work flows. For example, interesting elements that are targeted for backup and restore include VMs and shared directories (file system).

Job: conceptual work to be done that is governed by a policy. For example, one job might be to backup a virtual machine. Each time a job is invoked, a job execution is created.

Job execution: a single execution of a job. Regardless of whether jobs themselves are repeatable or one-time invocations, a job execution is the concrete record of a single invocation. A job execution shares a one-to-many relationship with its task children.

Policy: a policy contains the metadata that guides job behavior. For example, a policy might encapsulate RPO and RTO metrics that determine how frequently a job should be executed.

Provider: a provider defines a location where assets exist. Examples of providers include a file system, a VMWare ESX host, and an AWS S3 bucket.

A task is a single step from a job execution. Certain jobs (e.g., backup) are complex and require multiple steps (e.g., snapshot, validate, copy). A task provides granularity for a job execution.

In embodiments, policies may share a one-to-many relationship with jobs, though this may be extended to a many-to-many relationship with merged policies. Policies may provide a control group structure that customers may use to enable/disable all jobs associated with a given policy. For example, this may allow customers to disable jobs related to a nightly backup policy. Beneath the jobs are objects related to a concrete invocation of work, i.e, a job execution, which comprises a plurality of task or work details. While a job is being processed, the job execution and task capture the current state and are asynchronously updated. Once the job completes or enters a terminal state, the job execution and task objects act as historical artifacts to provide an audit for the results of the invocation.

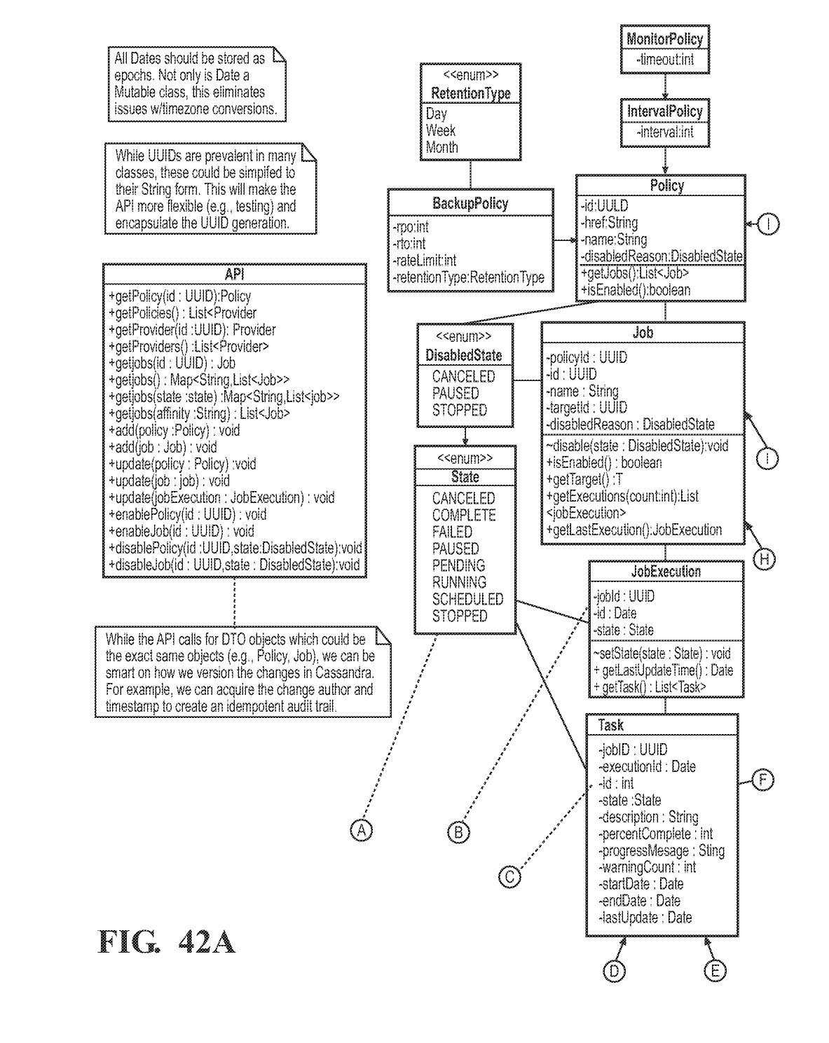

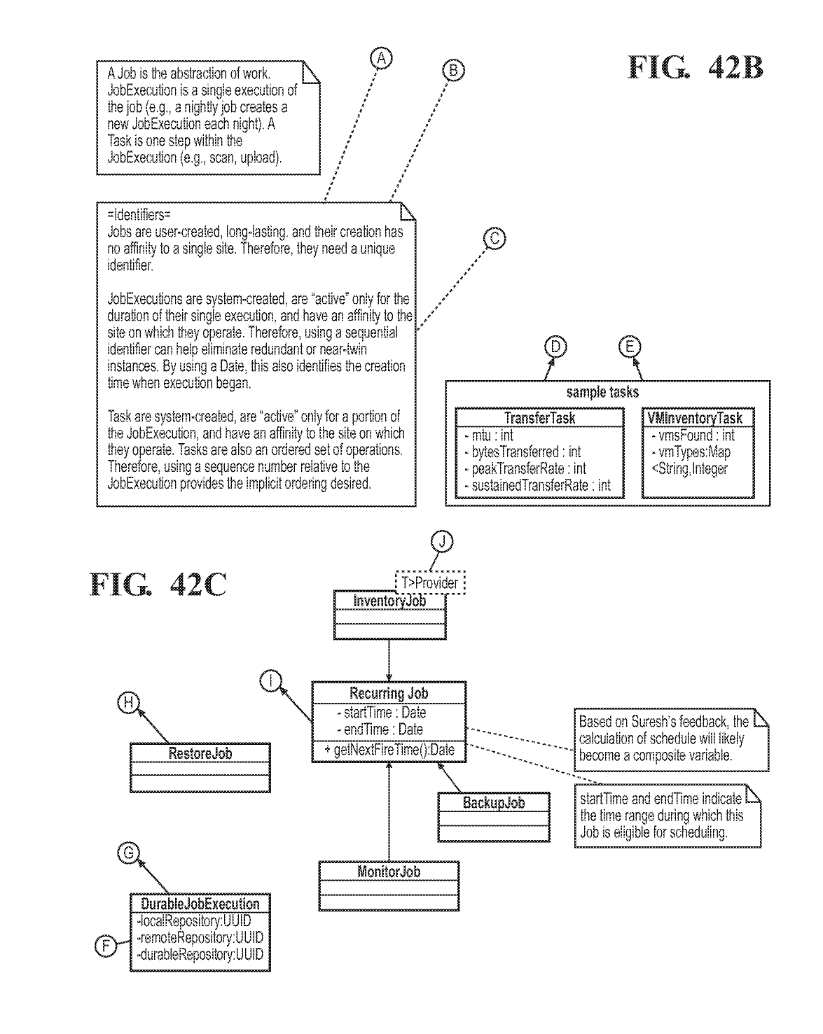

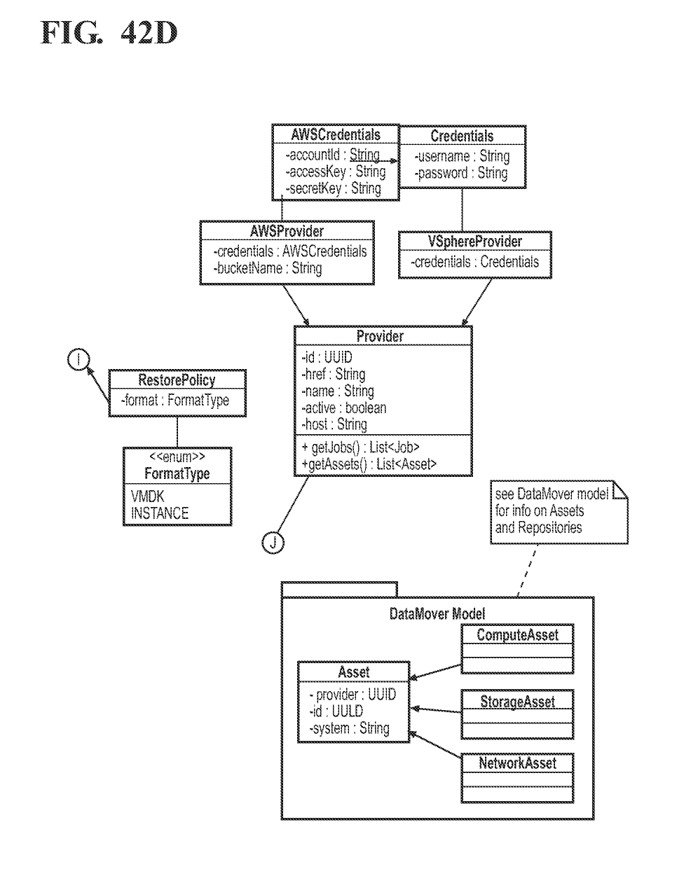

FIGS. 42A-D illustrate a UML class diagram, which outlines an exemplary structure for the involved policy, provider, and job classes. This information may be distributed across Protobuf files, Scala classes, and Java classes. One of the main goals of the API may be to refactor this information under one project so that it is readily accessible to the projects that need it, and also to create an authoritative source that defines these elements, and their relationships, which are central to the infrastructure. Where applicable, names reflect existing classes. Class names may change in the future to reflect their new responsibilities or improve consistency.

The API block of FIGS. 42A-D may be a class, or set of classes, that externalize all access to the objects defined by the API. Some items may be mutable via customer interaction (e.g., policy, job) through the API, whereas other objects may be mutable only by proprietary code (e.g., job execution, task).

The API may encapsulate the persistence layer. Consumers of the API may only be aware that they invoked a CRUD operation and may not know how, and where, that data is persisted (e.g., Cassandra). This encapsulation may be performed so most API calls do not return until the persistence layer has acknowledged its commit, or may throw an exception to inform the consumer that their operation has failed.

Several objects exposed by the API may be uniquely identified (e.g., policy, job). The current, and recommended, way to identify these objects is via Java's UUID. However, to simplify the API, the API method signatures may be relaxed to broadcast strings. In this manner, encapsulation of UUID generation may occur, which facilitates future architectural deviations, and simplifies the methods for testability.

While the diagram identifies timestamps as date objects, dates may be handled as epoch timestamps (also known as Unixtime). Epoch timestamps are not susceptible to time zone discrepancies and will reduce complexities given a distributed environment that may span several time zones.

Policies may have a clear hierarchy. For example, a backup policy and an interval policy serve separate concerns and may require different metrics to function; however, both these classes overlap in basic details like their ability to be named, disabled, and associated to jobs. An interval policy is for jobs that execute at fixed intervals (e.g., inventory). A monitor policy is a natural extension of an interval policy in that associated jobs may also execute at a fixed interval, and receipt of corresponding information may be required in a strict window of time. An example job that may be guided by a monitor policy is a system health heartbeat.

Logistically, providers may be associated to either policies or jobs. However, associating them with policies may create at least two complications. Policies may become more difficult to interweave. For example, if a customer wants to merge traits from N policies, then that has implications for how data should be backed up. Additionally, jobs are a selective combination of desired policies and providers. If providers are linked to policies, customers may need to maintain a cross-product of policies and providers in addition to the same number of jobs, which multiplies the number of existing policies without adding benefit.

Jobs may be either single-fire or recurring. If recurring, the frequency at which a job is invoked depends on its associated policy. Certain policies (e.g., an interval policy) may translate directly into a time based (CRON) expression whereas other policies (e.g., a backup policy) may need to dynamically calculate, and potentially adjust, its schedule based on additional metrics like RPO, RTO, rate limiting, and telemetry data.

Jobs do not carry an active state because they are a conceptual entity. Either they are disabled with an appropriate disabled state, or they are not disabled and eligible for execution by the job scheduler. A job that is cancelled mid-flight will have its disabled state changed to cancelled, and the state of its active job execution will also be changed to cancelled. If the job is later re-enabled, the prior job execution will remain as cancelled as it now represents a historic audit. The scheduler will create a new job execution. Additionally, jobs that are stopped or paused may behave differently.

Since user-initiated actions may be invoked from the user interface, there may be a transport layer between the user interface and the API. REST is a natural choice for this layer. However, the responsibilities of the API and a REST layer are tangential—that is, the API is concerned with CRUD operations on the core objects whereas REST is responsible for translating calls to and from the API. While REST could be “baked-in” to the API, the architecture will be more modular if they are independently developed. By keeping these responsibilities separate, flexibility to include more transport layers (e.g., XMPP) without incurring additional modifications to the API may be preserved.

Every job is decorated by a policy. It is this policy that determines when, and how often, the job is to be executed. A policy may have a one-time execution, a chronological execution (e.g., daily at 4 AM), an RPO/RTO-driven cadence, among others. However, these job-policy pairs do not operate in a vacuum: they are competing with other job-policy pairs for constrained resources (e.g., disks, CPU) or cost-incurring resources (e.g., AWS EC2 pricing). Therefore, these job-policy pairs are scheduled to be as efficient and “cheap” as possible. Scheduling infrastructure for all job-policy pairs is described below.

In an environment where N sites are moving data to a shared site (e.g., an AWS installation), various ways to orchestrate these sites may exist:

1. Each site may have an independent scheduler with global awareness of the remote resources. By definition, an independent scheduler would not coordinate with other schedulers. Because there is no coordination, remote resource availability is contentious as each scheduler greedily tries to optimize locally.

2. Each site may have an independent scheduler with only local awareness of resources. By definition, an independent scheduler would not coordinate with other schedulers. With all schedulers exercising local awareness, they may optimize for their respective workloads and local restrictions; this includes the shared site, which may optimize per its own restrictions (e.g., AWS hourly compute boundaries).

3. Each site may have a distributed scheduler with global awareness of the remote resources. Grid scheduling is non-trivial. By design, jobs would have local affinity and resources would be only locally accessible, i.e., the platform would not support remotely mounting a VMDK to another site, or mounting an EBS share outside an AWS environment. If jobs are cross-site and depend directly depend on remote resources, problems with remote outages and remote contention (e.g., ad hoc or longer-than-planned executions) may occur. These problems, among others, may incite a Domino effect as other jobs become backlogged.

4. Each site may have a distributed scheduler with only local awareness of resources. If schedulers are only aware of their local resources, there is nothing to distribute as the world outside their purview appears barren. This configuration introduces complexity without providing real value.

5. A single scheduler may operate for all sites. In some ways, a single global scheduler resolves the problems with distributed coordination: everything is planned by one omnipotent process and the resultant plans are then executed in their target environments. However, this approach is not without its own drawbacks:

1. This pattern introduces a single point of failure.

2. With a passive/HA scheduler backup strategy then either: manual intervention is required to “flip the switch”, which makes the platform more complex by requiring an administrative step during an already-stressful customer disaster recovery event, introduces human-in-the-loop latency that may have compounding implications (e.g., weekend outage vs. data decay; incremental backups lose value), and as a result, all workflows that require scheduling (e.g., inventory discovery jobs, health/system monitoring jobs) will not be rescheduled and may stop running; or the outage is automatically detected with automatic failover, which may be more complex. This complexity is because the scheduler would need to be aware of all Jobs, resources, and restrictions/optimizations for all sites, and the configuration would need to be synchronized between sites to allow fail-over. Further, the platform would have to tolerate and/or remediate outages (e.g., unavailable remote resources).

Additionally, this may be problematic because almost all jobs in a given site would operate on resources in that site, and the availability of those resources would be predominately independent of jobs executing in another site.

Schedulers therefore may be site-local and concerned only with their local resources. This alleviates the complexity of distributed coordination, eliminates remote resource contention, does not necessitate human-in-the-loop intervention, and avoids both single-point-of-failure and split-brain complications.

As necessary, schedulers may broadcast information about completed, current, and/or pending work that may be consumed by other site-local schedulers in planning their known work while being aware of future responsibilities.

A scheduling workflow may basically include two behaviors: planning, which is the act of planning a series of events for execution by a scheduler; and scheduling, which is the act of scheduling a series of events for immediate, or delayed, invocation by a process (e.g., an Akka scheduler).

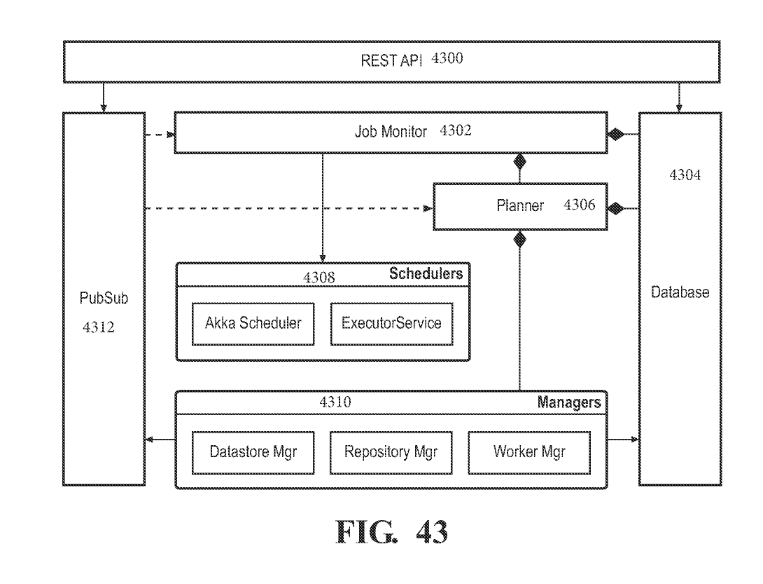

FIG. 43 illustrates a high level view of the scheduling framework for jobs, which includes a job monitor 4302, a planner 4306, schedulers 4308, and managers 4310. The planner 4306 is the component responsible for creating the plan given inputs from the database 4304, the job monitor 4302, and various managers 4310. This component has a dependency on a publish/subscribe mechanism 4312 to receive asynchronous updates (e.g., when a user has changed time-of-day bandwidth restrictions), so it remains reactive without unnecessary polling of myriad sources.

The schedulers 4308 may be any number of adapters that translate plans into their target environment. For example, an Akka Scheduler (or an Akka scheduler adapter) may perform the eponymous routine of translating plans into Akka scheduled events.

Note that the planner 4308 may be unaware of the scheduler 4308. This is a simplification of responsibilities, in that the planner only creates plans yet does not act upon them. This may reduce coupling, improve testability, and increase modularity.

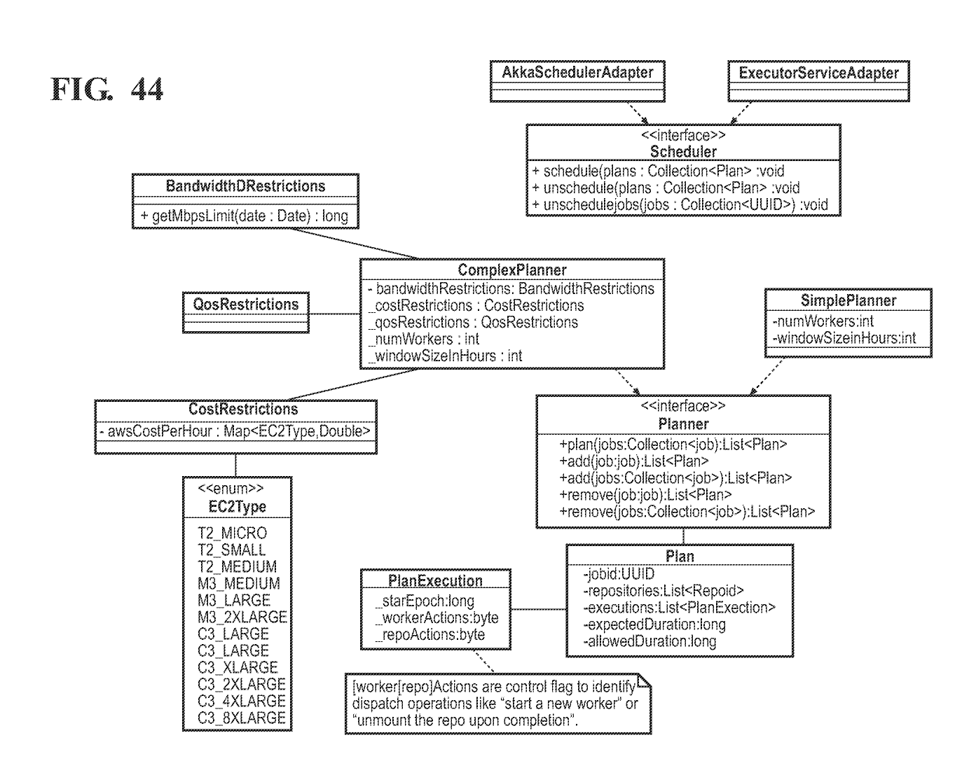

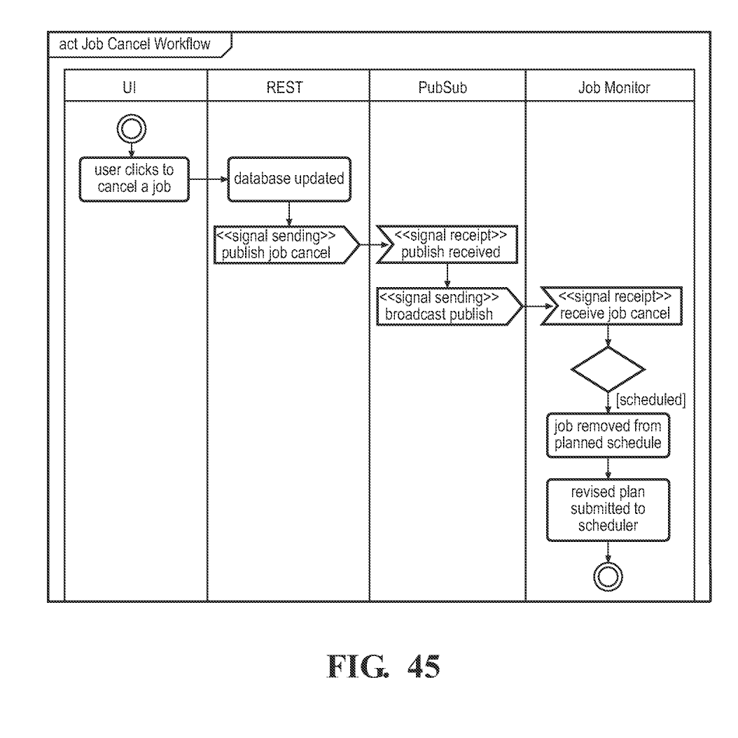

FIG. 44 is an example class diagram for the planner 4306 and schedulers 4308. One embodiment may feature a simple planner, and another may provide a drop-in replacement that considers additional restrictions and does not require any external interface changes. Additionally, if scheduling is on a site-local basis, different planners may be provided for different environments. For example, this would allow the flexibility of having an AWS-focused planner that considers EC2 costs, while a VMWare-focused planner may ignore AWS factors and focus more on QoS (quality of service) metrics.

To decrease the number and overhead of active polls, and increase overall system responsiveness to user events (e.g., cancellation, tuning), a publish-subscribe module 4312 may be utilized. Since the job framework depends on Akka, an Akka distributed publish-subscribe module may be used instead of Redis.

A job monitor actor may perform active polling to retrieve the list of all jobs from the database. A boot sequence for the job monitor actor may include the following:

1. Register self for publish-subscribe notifications.

2. Query the database to seed self with existing jobs.

3. Submit active jobs to the planner.

4. Submit plan to the scheduler.

5. Passively wait a) upon receiving a publish-subscribe notification (e.g., new/cancel job), go to step 3; b) at predetermined time intervals, self-heal against system drift by going to step 2.

FIG. 45 illustrates a job cancel workflow. A user may utilize the user interface to cancel a job, the REST API 4300 updates database 4304, and sends a publish job cancel message to the PubSub module 4312, which broadcasts the job cancel message. The job monitor 4302 receives the job cancel, removes the job from the planned schedule, and a revised plan is received from the planner 4306 and submitted to schedulers 4308. This may allow the planner 4306 full control, once a job is removed or added, to alter any other plan as it sees fit. Further, the scheduler may clean up stale plans and align itself with the new submission.

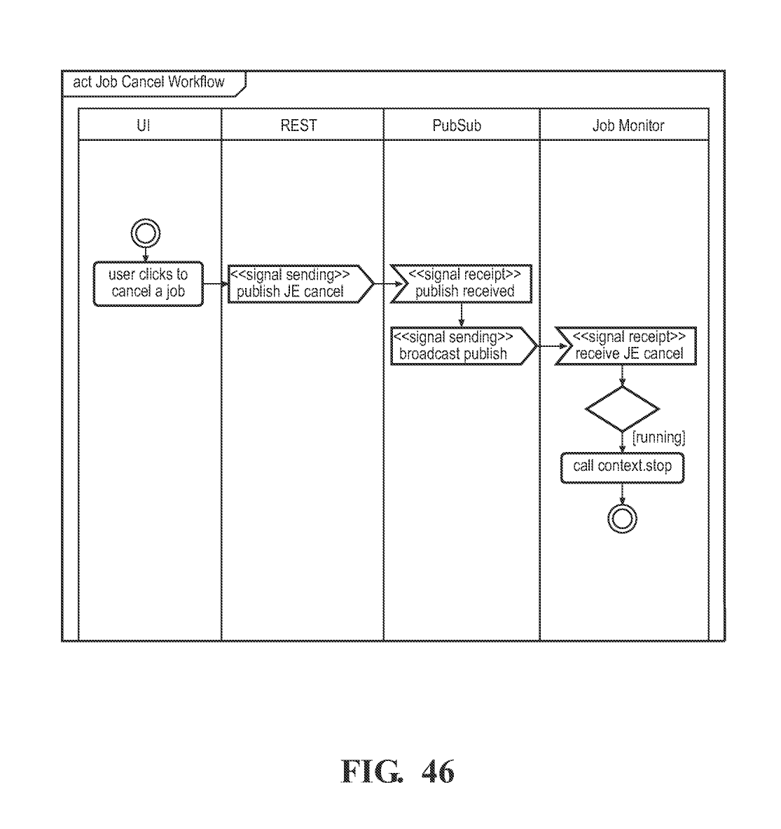

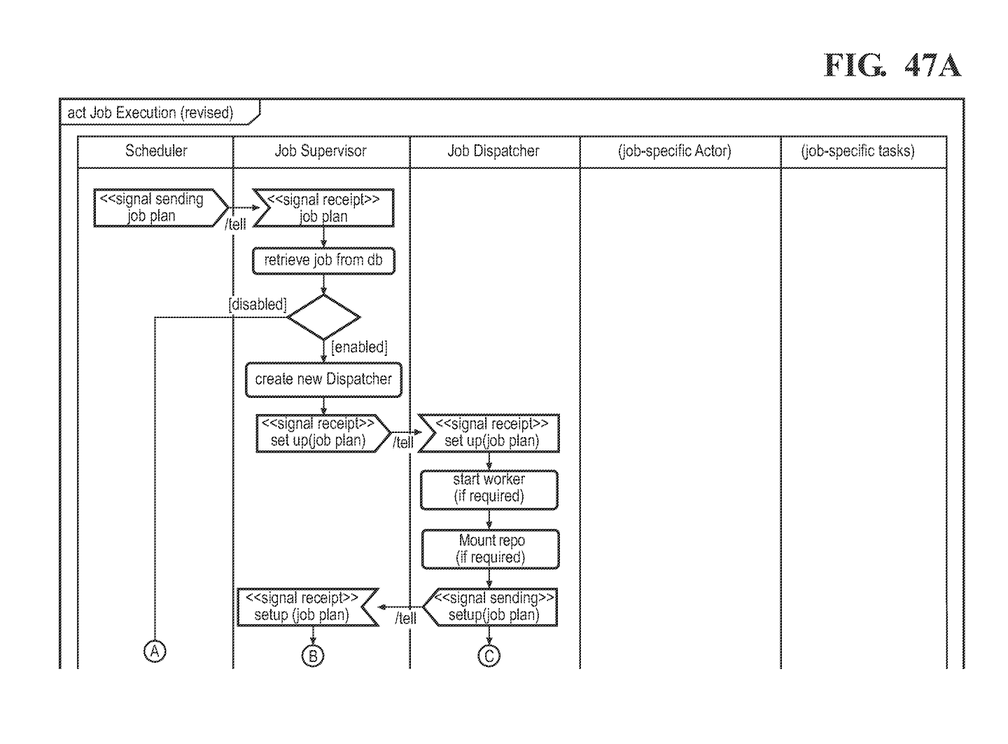

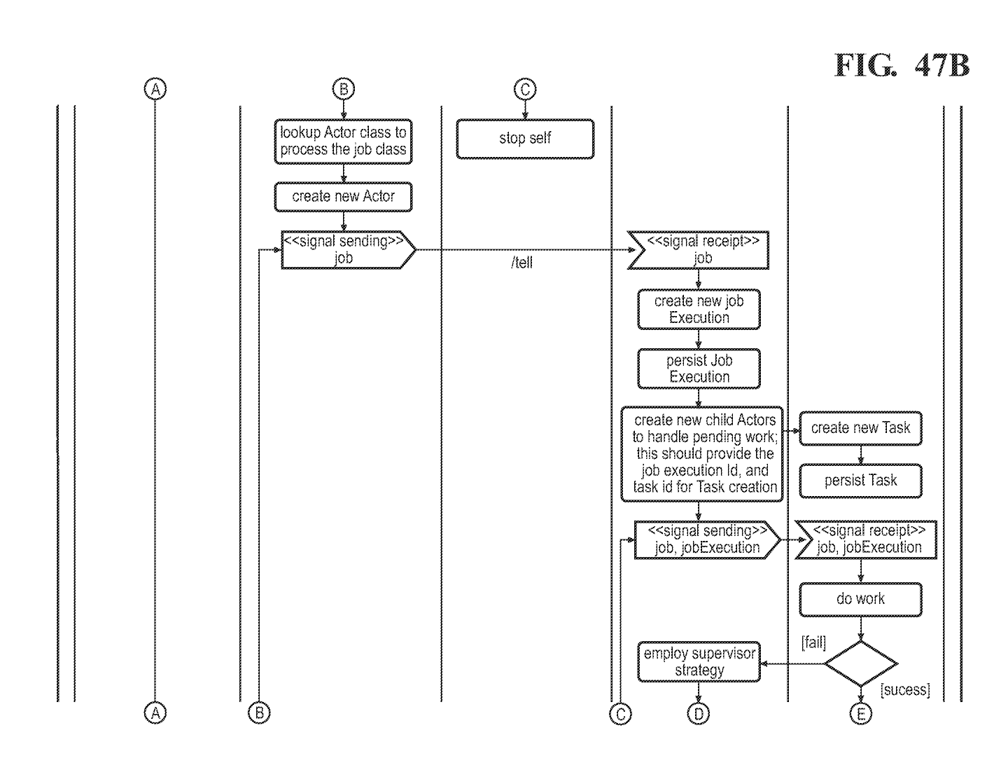

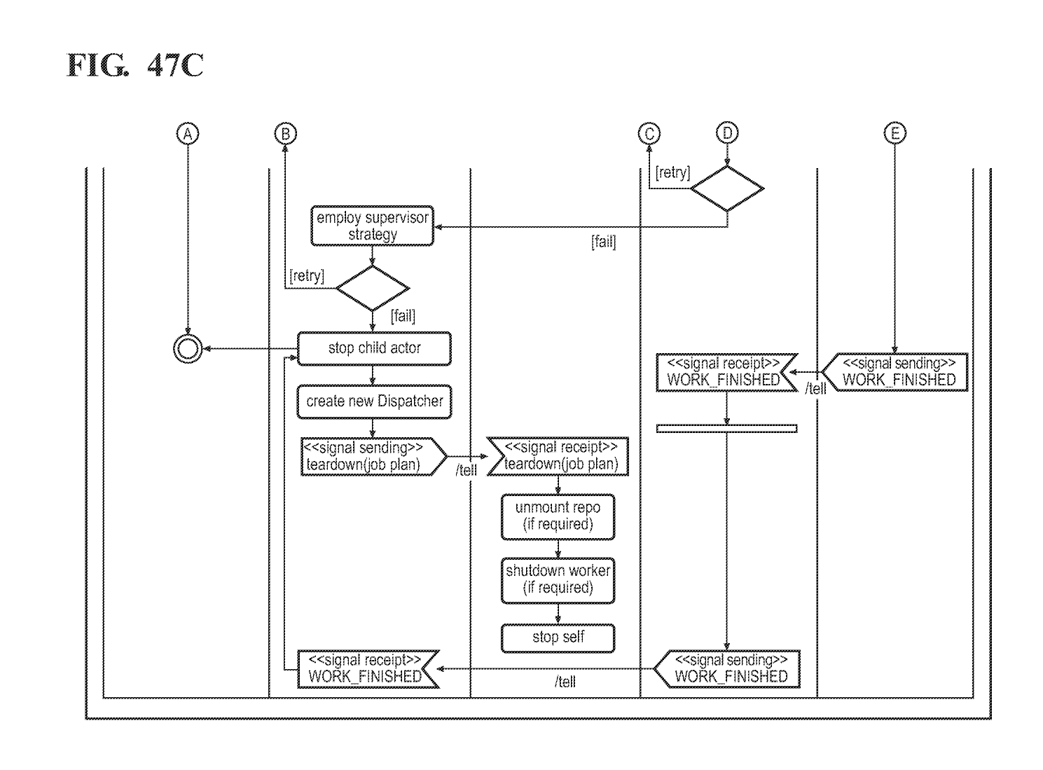

FIG. 46 illustrates a job execution cancel workflow. Similar to the cancellation of a job, a publish-subscribe notification may trigger the update. However, because job executions are the result of an executing job (and an executing plan), their supervision may be owned by a job supervisor actor. Cancelling a job execution may or may not alter the current plan.

A job supervision may include a dispatcher. These actors will be responsible for configuring the environment for the job to function.

Repositories are mounted on to workers (or in rare cases controllers) for use by jobs that require them. When they are no longer needed for any jobs they can be “parked.” Parking a repository may involve flushing its state, marking it clean, and then unmounting it. Furthermore, if jobs no longer need a particular worker, that worker may be powered off to save resources (and in the case of AWS utilization, money). Controllers may not be automatically powered off. Workers may be powered off when not used. The management platform may automatically park unused repositories and power off unused workers. For each worker VM, a timeline may be maintained that starts the moment the worker VM is powered on. Both auto park and auto power features may use this same timeline, although independently of each other. Each feature may be configured with an offset and an interval. The offset may determine when the first park/power check occurs and the interval may determine when successive checks occur. If the controller is unable to determine when the worker powered on, it may begin the timeline when it first discovers the worker.

When a park check occurs, if the repository is not in use at that moment, a park sequence may be initiated to unmount the repository. Similarly, for power checks, if no jobs are running at that moment, the check may initiate a power off event. In other words, no forecasting abilities are used to determine if the repository or worker will be needed in the very near future.

For a simple example, if the offset is 10 minutes and the interval is 30 minutes, after the worker is powered on, a check will be performed after 10, 40, 70, 100, etc. minutes. Once the worker is powered off, the checks may stop and a new timeline may be established once the worker is again powered on.

The offset and interval values may be configurable. Park and power checks may have different offsets but may share the same interval. Cloud workers may be configured separately from on-premise workers.

Every job that runs on a worker consumes some of that worker's resources. Because of this, the scheduler may limit the number of jobs that are allowed to run on any given worker at once. And since not all jobs are created equal, the number of allowed jobs may depend on each job's size as well as the total resource limit of the worker. To accommodate this pairing and attempt to utilize resources appropriately, each job may be assigned a “load factor” and each worker may be assigned a “load capacity.”

Workers may have many resources, including RAM, disks, network bandwidth, etc. The job and worker values may be a single number that represents an abstract relative quantity, and may not correlate to any particular physical resource on the worker. In essence, each value may represent a number of “slots”, such that each worker may have a corresponding number of available slots and each job may consume some number of those slots.

A job load factor may represent a relative amount of load that a job will place on a system. This value may change based on the amount of work a job has to do. In other words, this value may be calculated to determine an actual load value based on parameters of the job. For example, a protection job may compute a load based on how much data it had to protect. This value may also be fixed by a configured setting, with no computations being performed.

A worker's load capacity setting may be based on the amount of RAM detected on the worker. For example, a configured load capacity value may be multiplied by a number equal to 1 plus the number of GB of RAM detected. For example if the load capacity is 6 and the worker has 4 GB of RAM, the final capacity value would equal “6×(4+1)=30”. The platform may detect the observed RAM on a worker using an inventory or discovery process, so there may be a period during startup when the worker RAM load capacity is unknown and reported as zero.

An inventory process is a job itself. Configuring an inventory job to have a load factor greater than the load capacity may prevent that job from running at all.

The discover, discovery or inventory collection process may be a routine job that is executed by the platform. The intent of discovery is to create a synchronous point in time view of the assets in their corresponding environments (both on-premise and in the cloud). Assets are inventory objects like virtual machines, infrastructure elements like data stores, virtual switches, etc., that are discoverable via a vsphere API and AWS APIs for example. Discovery is important because it is the mechanism with which the platform determines the state of the assets under the purview of a workflow. For example, if a group of VMs are being protected with a policy, and one of the VMs in the group changes over the lifecycle of the policy execution, i.e., infrastructure elements such as disks, NICs, memory, compute, etc. change, this directly affects the protection job; each job execution now has a view of the VM at the point-in-time of protection. The metadata (information about the asset/resource) and data can change between protection execution and workflow has to track and accommodate changes or alert the user if the platform cannot handle the changes introduced if they are in conflict with the assigned policy. For example, if a VM in a group that is being protected has a physical RDM (raw device mapped) disk added that cannot be protected, this may be flagged. Discovery may also allow the platform to self-monitor and alert elements such as disks, workers, datastores and port groups used by the VAs.

Discovery functions may include management of lifecycle for non-ephemeral assets, with alerts for missing and unavailable assets, and management of inventory for multiple providers (multiple VCenters, AWS accounts).

While only a few embodiments of the present invention have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like. A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical articles, including, without limitation, electronic data structures, from one state to another. The methods and systems described herein may also transform data structures that represent physical articles or structures from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A management platform for handling disaster recovery relating to computing resources of an enterprise, the management platform comprising:
a plurality of virtual machines, wherein at least one virtual machine utilizes a first hypervisor and is linked to resources in a first virtual environment of an enterprise data center, and at least one virtual machine uses a second hypervisor and is linked to resources in a second virtual environment of a cloud computing infrastructure, wherein the first and the second virtual environments are heterogeneous and do not share a common programming language; and
a control component that abstracts infrastructure of the enterprise data center using a virtual file system abstraction layer, monitors the resources of the enterprise data center, and replicates at least some of the infrastructure of the enterprise data center to the second virtual environment of the cloud computing infrastructure based at least in part on the abstraction.

2. A management platform for handling disaster recovery relating to computing resources of an enterprise, the management platform comprising:
a plurality of virtual machines, wherein at least one virtual machine utilizes a first hypervisor and is linked to resources in a first virtual environment of an enterprise data center, and at least one virtual machine uses a second hypervisor and is linked to resources in a second virtual environment of a cloud computing infrastructure, wherein the first and the second virtual environments are heterogeneous and do not share a common programming language;
a user interface for allowing a user to set a policy with respect to disaster recovery of the computing resources of the enterprise data center; and
a control component that abstracts infrastructure of the enterprise data center using a virtual file system abstraction layer, monitors the resources of the enterprise data center, replicates at least some of the infrastructure of the enterprise data center to the second virtual environment of the cloud computing infrastructure based at least in part on the abstraction, controls the plurality of virtual machines to provide failover to the cloud computing infrastructure when triggered based at least in part on the user-set policy, and controls the plurality of virtual machines to provide recovery back to the enterprise data center based at least in part on the user-set policy after failover to the cloud computing infrastructure.

3. The management platform of claim 2, wherein at least some of the replicated infrastructure of the enterprise data center has an associated user-set policy and the at least some of the replicated infrastructure of the enterprise data center is stored in a storage tier of a plurality of different available storage tiers in the cloud computing infrastructure based at least in part on the associated user-set policy.

4. The management platform of claim 2, wherein the user-set policy is based on at least one of a recovery time objective and a recovery point objective of the enterprise for disaster recovery.

5. The management platform of claim 2, wherein the replicated infrastructure include CPU resources, networking resources, and data storage resources.

6. The management platform of claim 2, wherein additional virtual machines are automatically created based at least in part on monitoring a data volume of the enterprise data center.

7. The management platform of claim 2, wherein the control component monitors data sources, storage, and file systems of the enterprise data center and determines bi-directional data replication needs based on the user-set policy and the results of monitoring.

8. The management platform of claim 2, wherein failover occurs when triggered automatically by detection of a disaster event or when triggered on demand by a user.

9. A management platform for managing computing resources of an enterprise, the management platform comprising:
a plurality of federated virtual machines, wherein at least one virtual machine is linked to a resource of a data center of the enterprise, and at least one virtual machine is linked to a resource of a cloud computing infrastructure of a cloud services provider;
a user interface for allowing a user to set policy with respect to management of at least one of the enterprise data center resources and the resources of the cloud computing infrastructure; and
a control component that monitors data storage availability of the enterprise data center resources, and controls the plurality of federated virtual machines to utilize data storage resources of the enterprise data center and the cloud computing infrastructure based at least in part on the user-set policy, wherein at least one utilized resource of the cloud computing infrastructure includes a plurality of different storage tiers.

10. The management platform of claim 9, wherein each of the plurality of federated virtual machines performs a corresponding role and the federated virtual machines are grouped according to corresponding roles.

11. The management platform of claim 9, wherein the user-set policy is based on at least one of: a recovery time objective and a recovery point objective of the enterprise for disaster recovery; a data tiering policy for storage tiering; and a load based policy for bursting into the cloud.

12. The management platform of claim 9, wherein the control component comprises at least one of a policy engine, a REST API, a set of control services and data services, and a file system.

13. The management platform of claim 9, wherein the plurality of federated virtual machines are automatically created based at least in part on monitoring data volume of the enterprise data center.

14. The management platform of claim 9, wherein the plurality of federated virtual machines are automatically created based at least in part on monitoring velocity of data of the enterprise data center.

15. The management platform of claim 9, wherein the control component further monitors at least one of data sources, storage, and file systems of the enterprise data center, and determines data replication needs based on user set policy and results of monitoring.

16. The management platform of claim 9, further comprising a hash component for generating hash identifiers to specify the service capabilities associated with each of the plurality of federated virtual machines.

17. The management platform of claim 16, wherein the hash identifiers are globally unique.

18. The management platform of claim 9, wherein the control component is enabled to detect and associate services of the plurality of federated virtual machines based on associated hash identifiers.

19. The management platform of claim 9, wherein the control component is enabled to monitor the performance of each virtual machine and generate a location map of each virtual machine of the plurality of federated virtual machines based on the monitored performance.

20. A management platform of claim 9, further wherein the control component comprises an enterprise data center control component and a cloud computing infrastructure control component,
wherein each system component comprises a gateway virtual machine, a plurality of data movers, a deployment node for deployment of concurrent, distributed applications, and a database node;
wherein a plurality of database nodes form a database cluster, and
wherein each gateway virtual machine has a persistent mailbox that contains a queue with a plurality of queued tasks for the plurality of data movers, and each deployment node includes a scheduler that monitors enterprise policies and manages the queue by scheduling tasks relating to movement of data between the enterprise data center database node and the cloud computing infrastructure database node.

21. A management platform of claim 20, wherein the deployment nodes are Akka nodes, the database nodes are Cassandra nodes, and the database cluster is a Cassandra cluster.

22. A management platform for managing computing resources of an enterprise, the management platform comprising:
a plurality of federated virtual machines, wherein at least one virtual machine is linked to a resource of a data center of the enterprise, and at least one virtual machine is linked to a resource of a cloud computing infrastructure of a cloud services provider;
a user interface for allowing a user to set policy with respect to management of the enterprise data center resources; and
a control component that monitors data volume of the enterprise data center resources and controls the plurality of federated virtual machines and automatically adjusts the number of federated virtual machines of the enterprise data center and the cloud computing infrastructure based at least in part on the user-set policy and the monitored data volume of the enterprise data center.
